(19) United States
(12) Patent Application Publication
(10) Pub. No.: US 2017/0214909 A1
(43) Pub. Date: Jul. 27, 2017

(54) Method and Apparatus for Displaying a Still or Moving Scene in Three Dimensions

(71) Applicant: DESARAJU SAI SATYA SUBRAHMANYAM, VIRGINIA BEACH, VA (US)

(72) Inventor: DESARAJU SAI SATYA SUBRAHMANYAM, VIRGINIA BEACH, VA (US)

(21) Appl. No.: 15/418,016

(22) Filed: Jan. 27, 2017

(51) Int. Cl. H04N 13/04; G02B 27/22

(52) U.S. Cl. CPC H04N 13/0488; G02B 27/2271; H04N 13/0497; H04N 13/0422; H04N 2213/001; G21K 1/14

(57) ABSTRACT

A method and apparatus for displaying still or moving objects or surfaces in three dimensions is disclosed. The method consists of creating ad-hoc three dimensional surfaces inside a display chamber by methodically assembling a plurality of unit particles which are inducted from outside the chamber. When the assembly is complete, the plurality of assembled unit particles is suspended in the chamber and presented for exhibition. Further, to provide the color, brightness and contrast details of the scene, the assembled three dimensional surfaces are illuminated by various methods of light reflection and/or self-luminescence. Further, to exhibit moving objects, the sequence of 3-d surface formation, suspension and illumination is repeated with sufficient rapidity that, by persistence of vision, three dimensional action scenes appear in the display chamber to viewers.

### BACKGROUND OF THE INVENTION

I. Field of the Invention

It is often desirable and advantageous to view images of the three dimensional objects and surfaces of the real world, and also computer generated three dimensional objects and surfaces, in a three-dimensional display format.

The present invention relates to a method and apparatus for displaying a scene i.e. set of objects and surfaces, in three dimensions.

II. Prior Art

Many different approaches are known or have been disclosed for achieving three-dimensional displays. The known approaches may be classified into two top level categories—(i) binocular stereo display technologies that rely upon special eyeglasses worn by viewers for obtaining 3D sensation, and (ii) auto-stereoscopic 3D display technologies that are glasses free and in which viewers can gain a 3D sensation with the unaided eye. Auto-stereoscopic 3D display technologies may again be classified into three broad categories: (1) multi-view 3D display, (2) volumetric 3D display, and (3) digital hologram display. See [1].

The present invention may be considered to fall in the category of “volumetric 3D displays”, which can display volumetric 3D images in true 3D space. Every active “voxel” in the 3-d scene is set by placing a particle at the designated point in the display chamber, from where it reflects or emits light omni-directionally, and the plurality of particles forms a real image for the viewer.

Some prior known approaches in the “volumetric 3D display” category are—

Stacking transparent 2D screens: a plurality of transparent 2D displays with transparent light emitting elements are arranged one behind the other, such that the plurality of displays defines three dimensions; each display exhibits a particular 2D slice of a 3D image, so that when the plurality of displays is viewed through either the front or rear display, a three-dimensional image of the object appears. [2]

Multilayer LCD 3D volume visualization: consists of a stack of transparent electronically switch-able polymer dispersed liquid crystal (PDLC) layers; each PDLC screen momentarily produces a 2D slice of the 3D image as an opaque pattern onto which an image projector projects the corresponding sections of the 3D image; by sequentially exhibiting 2D slices on successive PDLC layers, a volumetric 3D image is formed. [3]

Stimulation of fluorescence in the display medium: a 3D pattern is formed by exciting the medium with a plurality of intersecting laser beams at different points; the physics of the fluorescence varies with the display medium used; solid state, vapor and air have been used successfully [4].

Scattering light within a block of glass material: a crystal cube having a large number of tiny physical cracks at precisely designated locations is created and illuminated by a specially designed light source; the cracks scatter light in all directions and form visible voxels within the glass volume, thereby forming a volumetric 3D display. [5]

3D arrays of individual elements acting as voxels: light emitting or reflecting elements are arranged in a cubical volume and designated voxels are switched on and off to form a 3D image inside the volume. The elements may be discrete LEDs switched on and off through thin wires [6], or liquid crystals that are switched by light transmitted through fiber optic cables embedded in the display [7];

Volumetric 3D Display Using a Sweeping Screen: rotating or reciprocating flat screens [8], or rotating mirrors [9], or a rotating double helix screen [10] are used to ‘sweep’ a volume that is cylindrical, spherical or cubical in shape, within which a 3D image is formed by projecting 2D images of high intensity. The screen's motion is synchronized with the projection timing such that the moving screen intercepts high-speed 2D image projections from the projector at different spatial positions.

In a variation of the sweeping screen approach, a rotating electro-luminescent panel with an embedded array of switch-able light emitting elements (LEDs) is used [11]. By switching the light emitters on and off in time with the rotation of the panel, and as required for the active voxels, 3D images are formed within the swept volume. No external image projection is required.

References to literature about these inventions and/or patent citations are provided in the Patent Citations and References Section below.

In contrast to all these approaches, the present invention relies on constructing essentially ad-hoc physical surfaces whose contours follow the contours of the objects to be displayed. This is achieved by the time-controlled ejection of particles from an array of sources into the display chamber, according to sequences determined by the contours to be displayed. When all the requisite particles are ejected into the chamber, and form all the three dimensional surfaces of the objects to be represented, they are suspended at their positions and given for display. These constructed surfaces are ‘soft’, or easily and quickly removable and replaceable by other surfaces in their place.

### III. Prior Art Pertaining to the Present Invention

### A.

2-dimensional displays using charged particles suspended in oil, dyed oil, or clear oil, have been disclosed [12] [13] The Gyricon display of Xerox Corporation uses bi-chromatic charged particles that are switched on and off by electrostatic fields to form 2-dimensional patterns in the display. The Dual Particle display of Cabot Corporation uses particles of two different colors that are positively and negatively charged according to their color, and switched by electrostatic fields to form 2-dimensional patterns in the display. Multi-color 2-dimensional particle-based displays are also known, wherein nanocrystals are used to produce distinctive colors determined by the size of the particles (a.k.a. “quantum dots”) [14].

### B.

High speed ejection of particles (ink droplets) from an array of micro-nozzles is a mature art employed in inkjet printers. A vibrating piezo-electric crystal is used to break a constant supply of pressurized liquid (ink) into a stream of droplets, which are ejected through micro-nozzle as a continuous stream. The ink droplets are imparted an electrostatic charge by means of a charging electrode as they form; the electrostatic charge on each droplet is variable and controlled according to the degree of deflection required for the droplet.

Electrostatic deflection plates are used to deflect the charged droplets to the target sheet to form the printed patterns. The more highly charged droplets are deflected to a greater degree. Unused droplets are collected for re-use. [15]

Droplet ejection frequency is of the order of 10-100 kHz, and droplet velocity is of the order of 20 m/s [16]. Large arrays of micro-nozzles have been developed for high speed printing. For example, Kyocera Corporation announced the KJ4 Series print-head in which each nozzle ejects ink at up to 60,000 dots per second (at 60 kHz drive frequency); with 2,656 nozzles per head, the device is capable of printing approximately 150 million dots per second [17].

### C.

Inkjet printers use electrostatic deflection of charged ink droplets to position the ink droplets on the substrate. The problem arises of electrostatic repulsion between neighboring droplets due to mutual interaction of their electric charge, which may disturb their trajectory and/or position. Established methods exist to mitigate this problem [18] [19].

### D.

Mid-air suspension of polystyrene particles ranging from 0.6 to 3.1 mm diameter using ultrasonic standing waves has been reported by researchers at the University of Sussex and Bristol [20].

Further, a display which is made of a large collection of small objects that are levitating in mid-air has been reported, the so-called JOLED technology. Ultrasonic waves are used to levitate tiny, multi-colored spheres and turn them into physical voxels. The spheres carry an electrostatic charge, enabling them to be manipulated in mid-air by changes to an electric force field, created by tiny electrodes. Thereby each voxel in the display can be rotated on the spot to show different colors and images.

### E. (Phosphors)

Phosphors are luminescent materials that emit light when exposed to radiation such as ultraviolet light or electron beams, and are widely used in 2-dimensional video display screens, indicators and light emitting devices.

Phosphor technology is a mature technology and many different phosphors have been synthesized, each one having its own characteristic color of emission and period of time during which light is emitted after excitation ceases. Phosphors are generally supplied as micron-size powders by the gram. For an indicative list of commercially available phosphors, see [21] [22]

### F. (Quantum Dots)

Quantum dots (QD) are small semiconductor particles, measuring several nanometers in size. They emit light when excited or stimulated by laser or ultra-violet light. The color of the emitted light can be tuned by changing the dots' size, shape and material. They can be used in lighting devices and as pixels in 2-d displays, and may have other applications such as printing and coating surfaces (as pigments or dyes), and in solar cells [23]. For an indicative list of commercially available quantum dots see [24].

The disclosures of the patents referred to in Section III of the Description are herein incorporated by reference.

The disclosed invention is intended for use in all areas where 2-d displays are currently used—television, computer displays, gaming systems, cinema, advertising displays, mobile/fixed phone displays, device displays e.g., GPS, home appliances, automotive indicators etc. It can also be used in defense, medical, space, industrial and scientific high-dimensional data visualization applications.

3D imaging involves cross-disciplinary technology and draws upon optical design, structural design, electronics, hardware and software etc., and in the case of the disclosed invention, inkjet printing technology.

It is important that a 3D display provide sufficiently high contrast and resolution, a wide viewing angle, and the capability to view the three-dimensional scene from different sides. It is also important that the system be energy efficient and implemented at relatively low cost.

The present invention provides such an apparatus and method. It presents the best possible 3D view as it constructs material 3D surfaces. The audience can view the 3D scene in the display in exactly the same way as real-world objects. Other benefits and advantages of the present invention will be apparent to one of ordinary skill in the art from the following description of it.

### SUMMARY OF THE INVENTION

The present invention constitutes a display system that produces a constructed three-dimensional scene out of a plurality of particles that are ejected into the display chamber from multiple sources in a controlled time sequence, and suspended when all the requisite particles are in the chamber and are occupying their designated voxel positions to form 3-dimensional surfaces.

In one embodiment of the invention, the particles are ejected into the display chamber from a 2-dimensional array of micro-nozzles mounted on one side of the display chamber (preferably top). All the ejected particles travel towards the opposite side of the display chamber (i.e. towards the bottom). Each particle from a given micro-nozzle is ejected in such a sequence, and with such a velocity and timing, that the particle meant for the bottom-most plane of the display reaches the bottom when the particle meant for the top-most plane of the display arrives at the top, and all the in-between particles are at their designated planes.

Separation between different objects in the scene, or gaps in or between the 3-d surfaces of the scene, are attained in the display as follows: to attain horizontal gaps between particles, the micro-nozzles at corresponding points in the array do not eject any particles at the corresponding point in the time sequence; to achieve vertical gaps between particles, a given micro-nozzle does not eject any particles at the corresponding points in the time sequence. By not ejecting any particles at given locations and at given time instants, in a controlled fashion, horizontal and vertical gaps between the objects and surfaces of the original scene are reproduced in the display chamber.

It may be noted that thereby the ejection of particles from the micro-nozzles is controlled by the requirements of the 3-dimensional surfaces to be exhibited, and is intermittent in both space and time rather than regular.

At the point of ejection, the particles are imparted with a small electric charge by electrodes provided at the micro-nozzles for this purpose. When the particles are at, near, or approaching their designated positions, an electric field is applied within the chamber from the bottom face, having a direction that opposes the movement of the particles that are carrying electric charge. This slows down (or brakes) the particles at or near their voxel positions.

In one embodiment of the invention, the positioning of all the particles at their designated positions in the same instant is attained by setting the electric charge and velocity of each particle at ejection to values that, in conjunction with an electric field applied in the chamber, ensure the arrival of all the particles at their designated planes simultaneously. The applied electric field may be constant over the time the particles move through the chamber, or varied as an additional means to control the arrival of all the particles at their designated planes simultaneously.

As the ejected particles can be close together as they travel down the chamber, there may be electrostatic repulsion between neighboring droplets that disturbs their trajectory and/or position. (This problem arises in inkjet printers as well, which use electrostatic deflection of charged ink droplets to position the ink droplets on the substrate.) To counter this, a partial standing wave of ultrasonic frequency is established at every micro-nozzle, extending longitudinally down the chamber to the opposite side. The particle is ejected from the micro-nozzle into this partial standing wave.

The partial standing wave is created by the constructive interference of two ultrasound sources placed towards the top and bottom of the chamber respectively, and aligned with the micro-nozzle. The two sources have equal frequency, unequal amplitude and same phase. Owing to the unequal amplitude of the two sources, the standing wave created by the constructive interference has partially formed pressure nodes, giving rise to a “peapod” pattern of sound pressure. Thereby there is a chute made of sound pressure extending from the micro-nozzle to the bottom of the chamber. By careful design, the chute may be made suitable to guide the particle that is ejected from the micro-nozzle into this chute, towards the bottom in a straight path, with the wall of sound pressure counter-acting the repulsion between the charged particles in the two horizontal directions.

Repulsion between neighboring particles in the vertical direction is less deleterious and is offset by controlling the ejection timing, velocity and electric charge of the particles, and also the electric field applied in the chamber, as required.

When the particles are at, near, or approaching their designated positions, an electric field is applied within the chamber, having a direction that opposes the electric charge carried by the particles. This slows down (or brakes) the particles at or near their voxel positions.

In one embodiment, to suspend the particles when they are moving slowly at or near their voxel positions, the amplitudes of the ultrasonic sources at the top and bottom faces are equalized to establish a proper standing wave with fully formed pressure nodes and antinodes. The plurality of standing waves in the chamber forms a grid of interlocking pressure zones, such that the particles are captured between the high pressure and low pressure zones. Thereby the particles hold in their positions to a high degree of accuracy.

In another embodiment, to suspend the particles when they are moving slowly at or near their voxel positions, a second electric field is applied within the chamber, from the top and having a direction that opposes the electric charge carried by the particles. With this, the particles exist between an opposing electric field originating from the bottom face (i.e. the braking field), and an opposing field originating from the top face, and they are then suspended using standing waves as above.

By careful design of the two opposing electric fields and the charges on the particles, the particles hold in their positions to a high degree of accuracy. The partial standing waves, which exist at all times, assist by providing horizontal restriction.

With this, the formation of the basic 3-dimensional surfaces in the chamber is complete, and the particles may be held in position for as long as dictated by the needs of the application. Illumination of the standing 3-d surfaces may also be performed at this stage, as dictated by the needs of the application, either by external light sources or stimulation of self-luminescence in the particles.

The 3-d scene in the chamber can be viewed from a 360-degree angle in the planes orthogonal to the motion of the ejected particles (i.e. from all sides except from the top and bottom).

When it is required to stop exhibiting the 3-dimensional surfaces formed in the chamber, the illumination is stopped and the particles are removed from the chamber by a process of purging.

In one embodiment, the purging is done by withdrawing the ultrasonic standing waves that suspend the particles, and applying an electric field within the chamber, having a direction that attracts the particles that are carrying electric charge. This accelerates all the particles in the chamber towards the bottom, where they are collected and recirculated to the micro-nozzle array.

In another embodiment, where two opposing electric fields are used at the top and bottom face, the purging is done by withdrawing the ultrasonic standing waves that suspend the particles, and reversing the polarity of the field emanating from the bottom face of the display chamber, to attract the charged particles in the chamber. With this, the charged particles exist between an attracting electric field originating from the bottom face (i.e. the purging field), and an opposing electric field originating from the top face, and as a result are accelerated towards the bottom face of the display chamber.

Purging of the particles in the chamber can be achieved rapidly using a sufficiently strong electrostatic field. Once purging is complete, the display may either be left blank, or populated with a new set of surfaces by commencing the micro-nozzle ejection to introduce particles into the chamber, as required by the application.

Although the field of the invention is given here as “three dimensional display” for classification purposes, some of the methods and approaches disclosed here can have diverse or more general applications, and are therefore claimed without reference to “display devices” as such.

### DRAWINGS AND ILLUSTRATIONS

### I. List of the Drawings (50)

The drawings are provided for illustration purposes only, and to pictorially describe the concepts of the method and arrangement of the apparatus disclosed here. They are not drawn to scale and are not intended to convey any technically precise information. The invention may best be understood, both as to organization and method of operation, by reference to the detailed description which follows, taken in conjunction with the drawings.

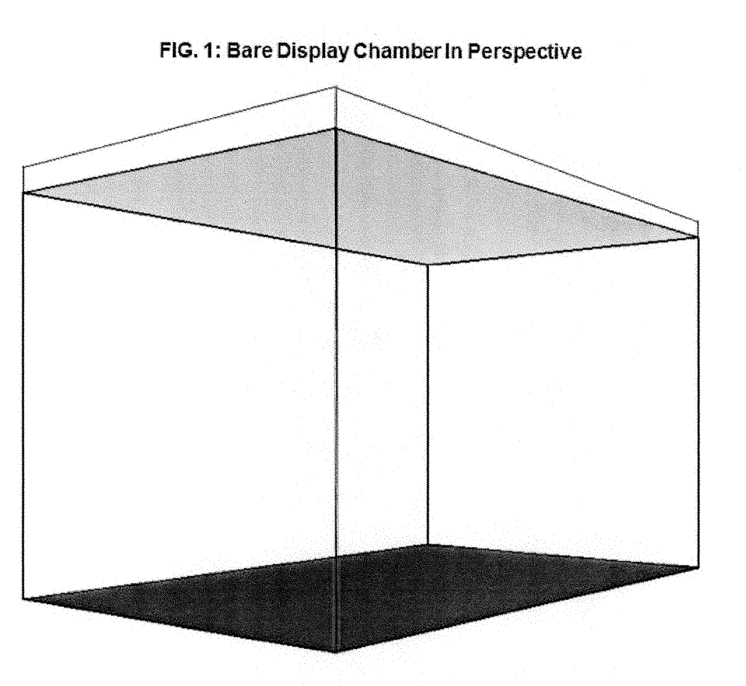

FIG. 1: bare display chamber in perspective.

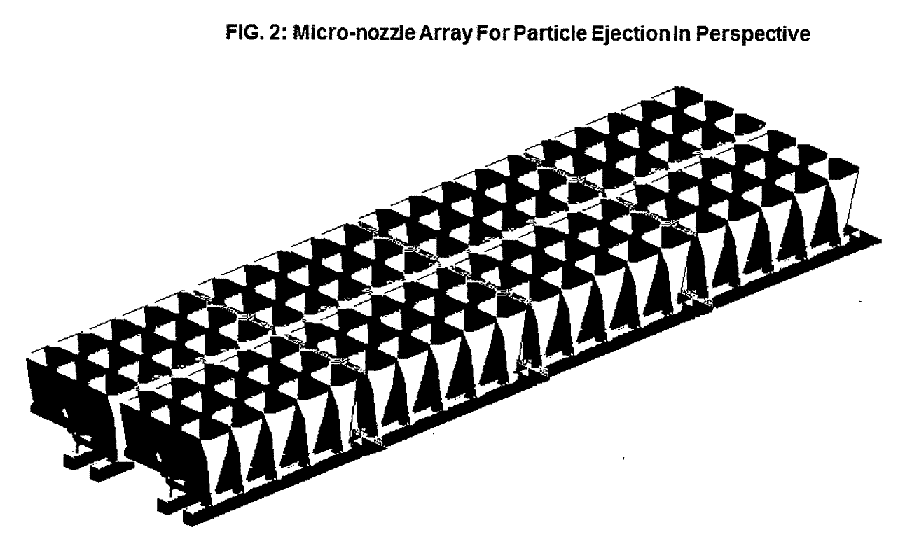

FIG. 2: micro-nozzle array for particle ejection in perspective.

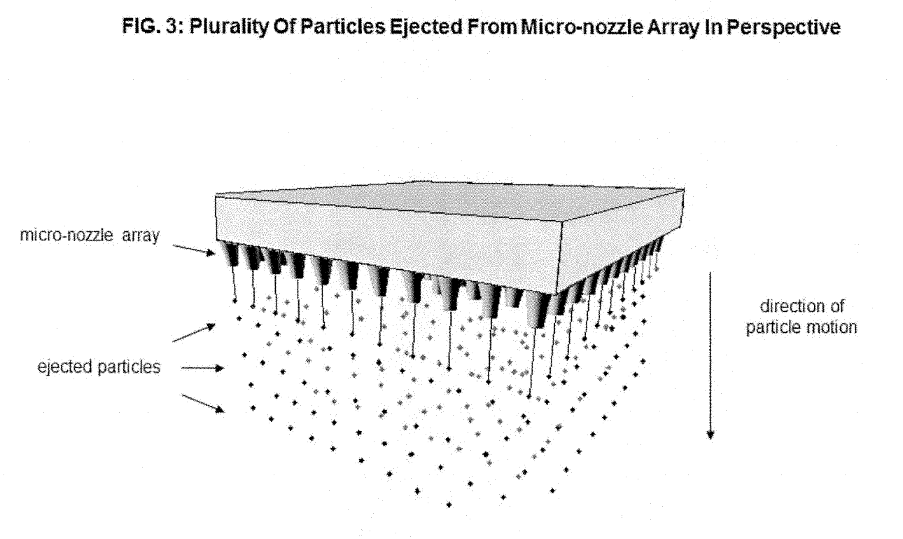

FIG. 3: plurality of particles ejected from micro-nozzle array in perspective.

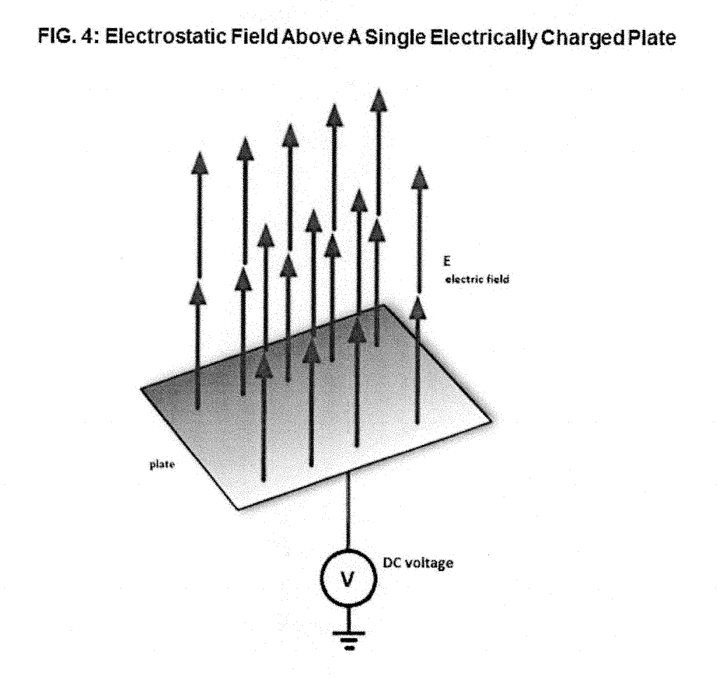

FIG. 4: electrostatic field above a single electrically charged plate

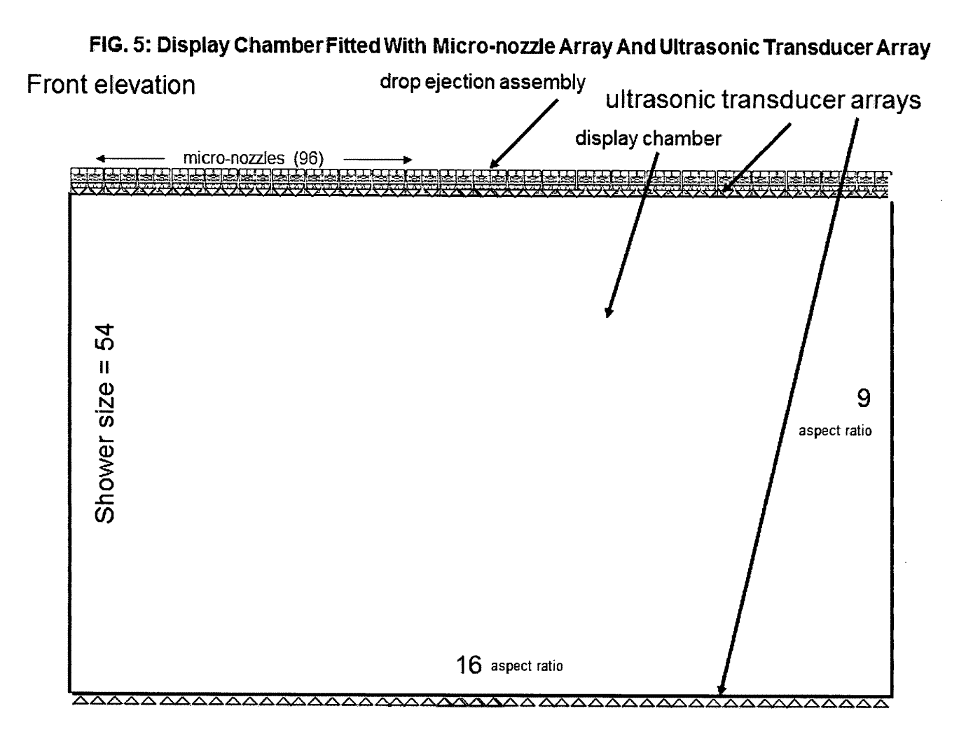

FIG. 5: display chamber fitted with micro-nozzle array and ultrasonic transducer array

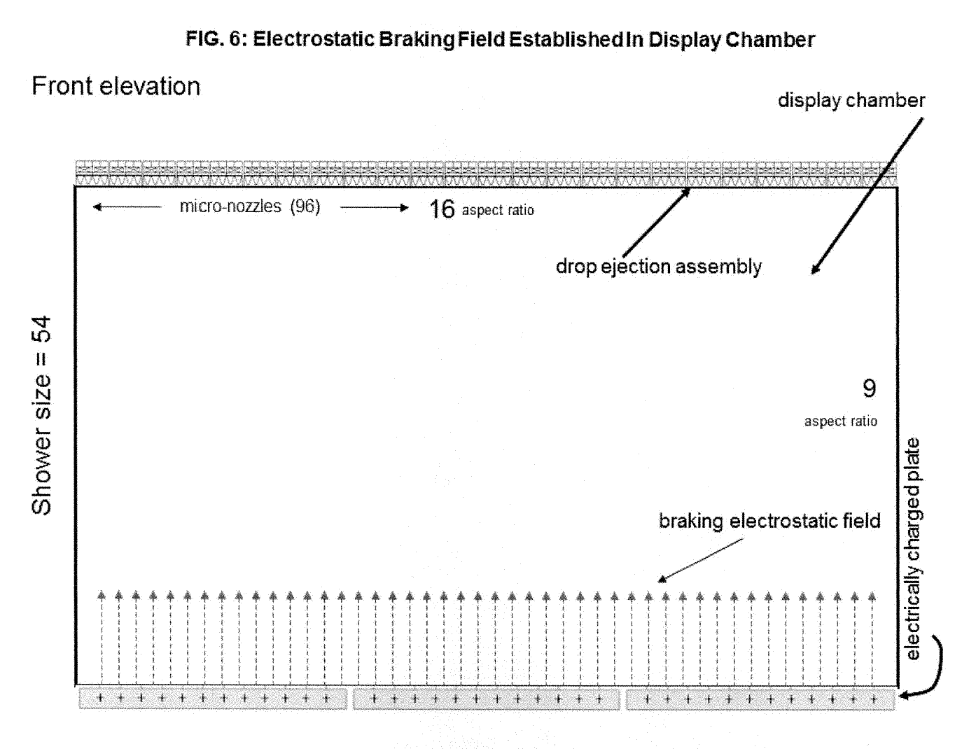

FIG. 6: electrostatic braking field established in display chamber

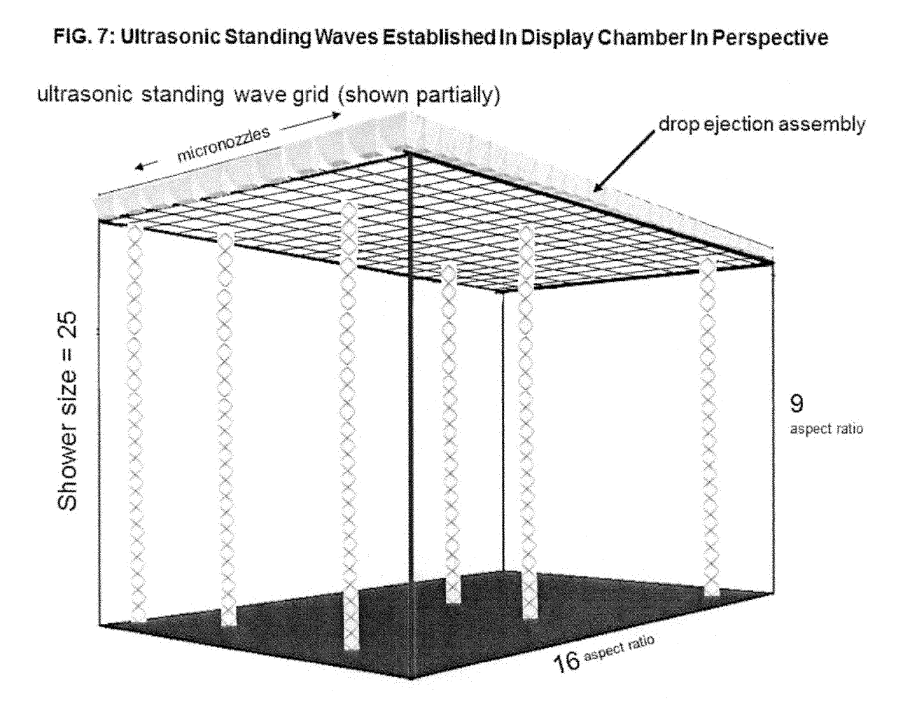

FIG. 7: ultrasonic standing waves established in display chamber in perspective.

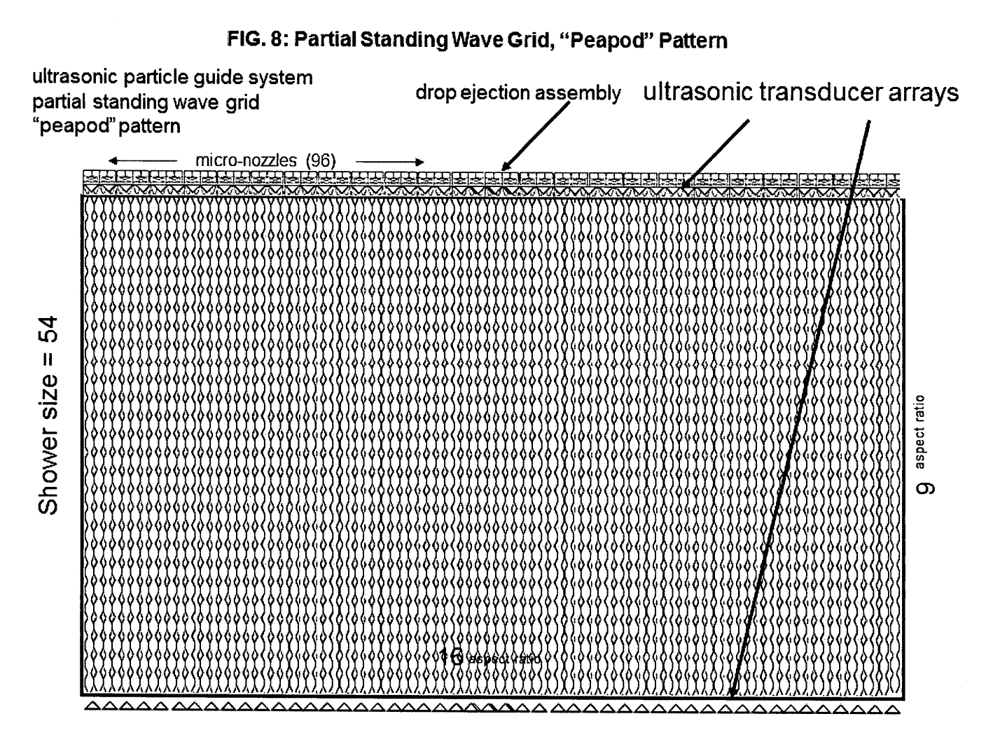

FIG. 8: partial standing wave grid, “peapod” pattern

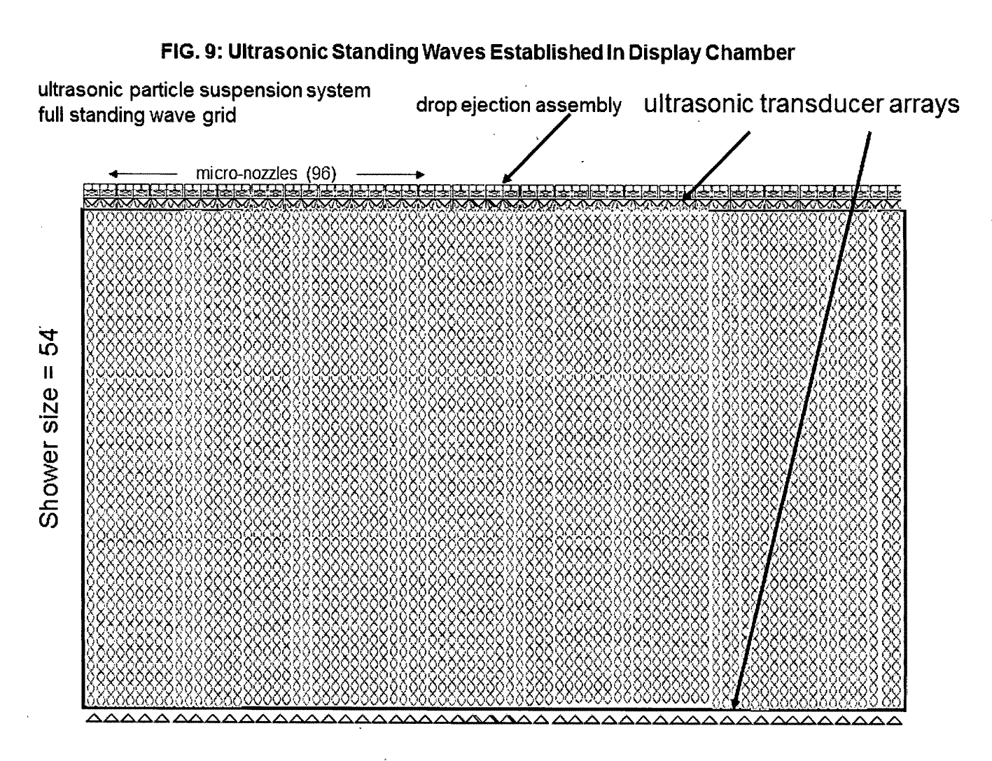

FIG. 9: ultrasonic standing waves established in display chamber

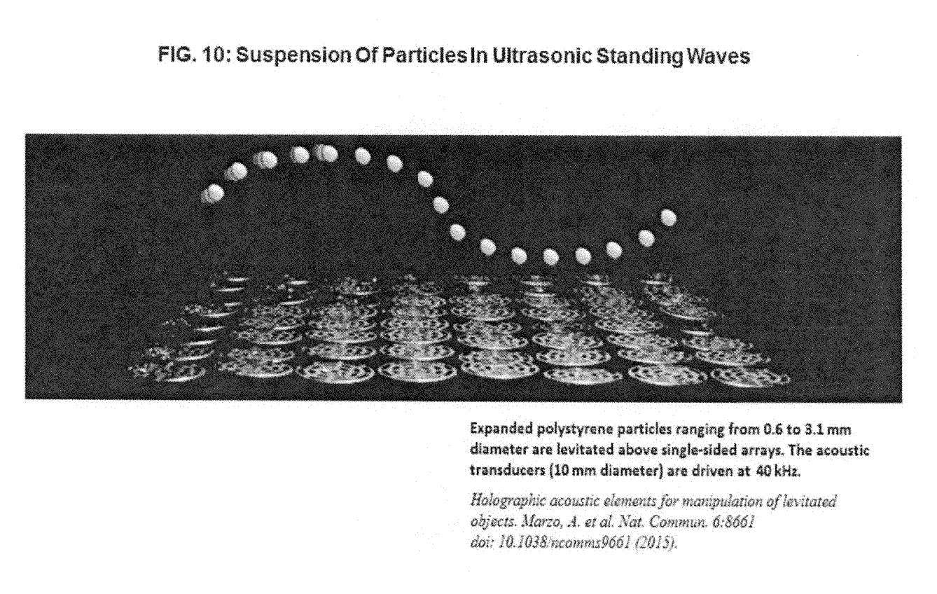

FIG. 10: suspension of particles in ultrasonic standing waves

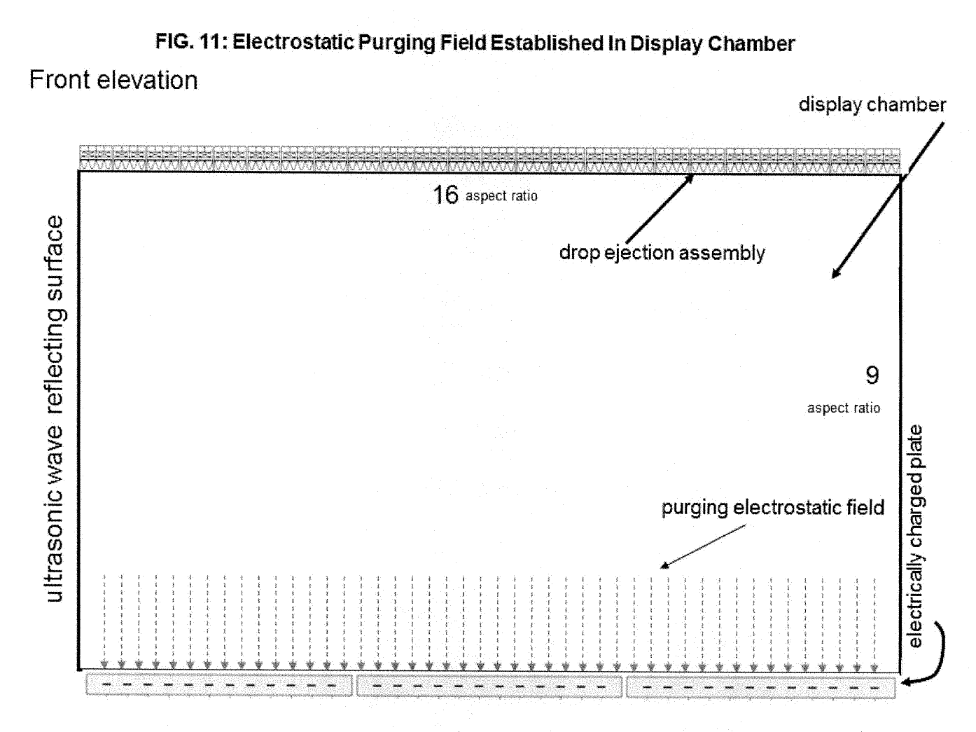

FIG. 11: electrostatic purging field established in display chamber

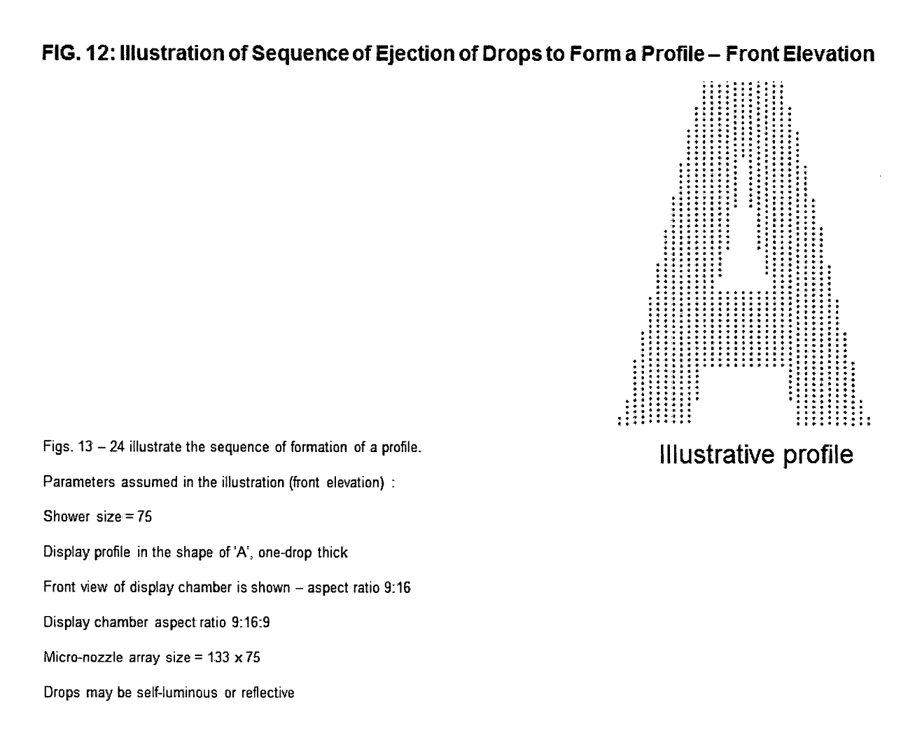

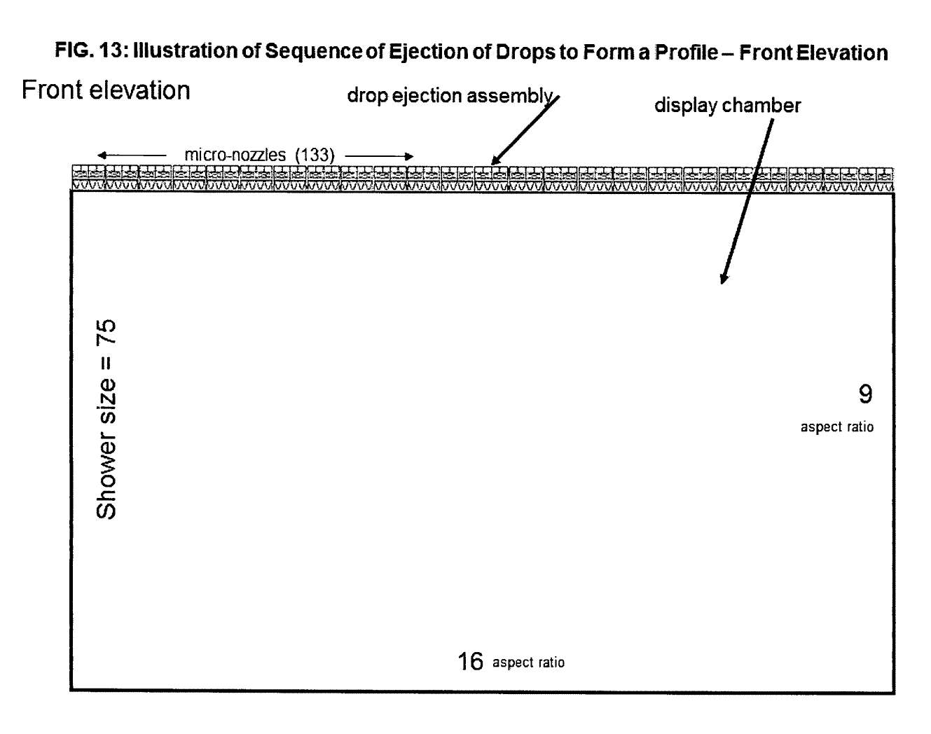

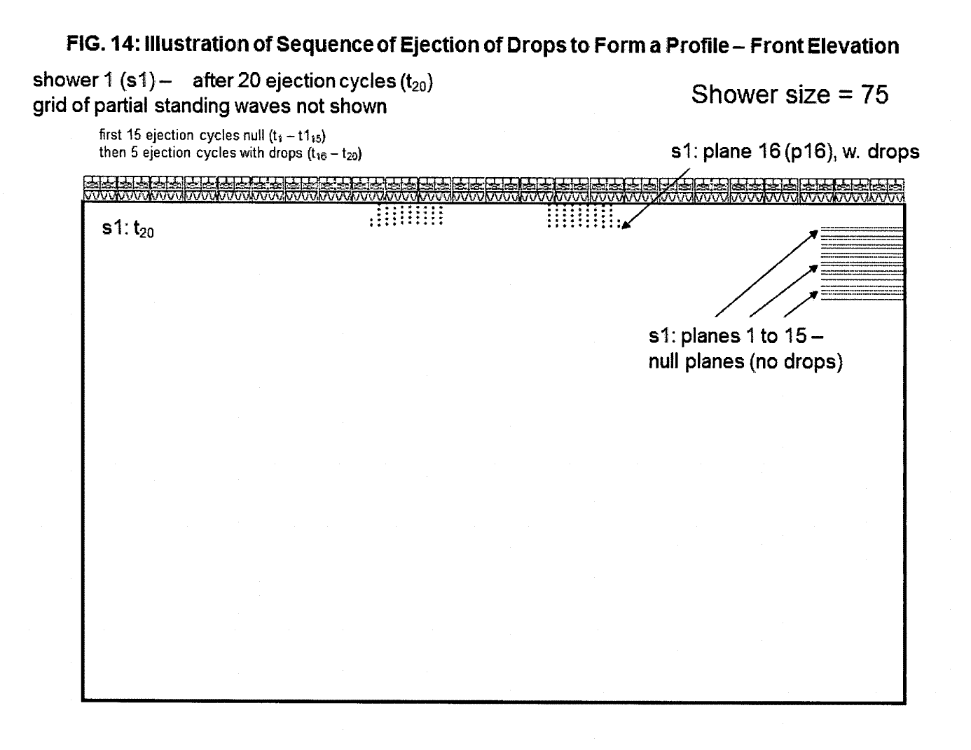

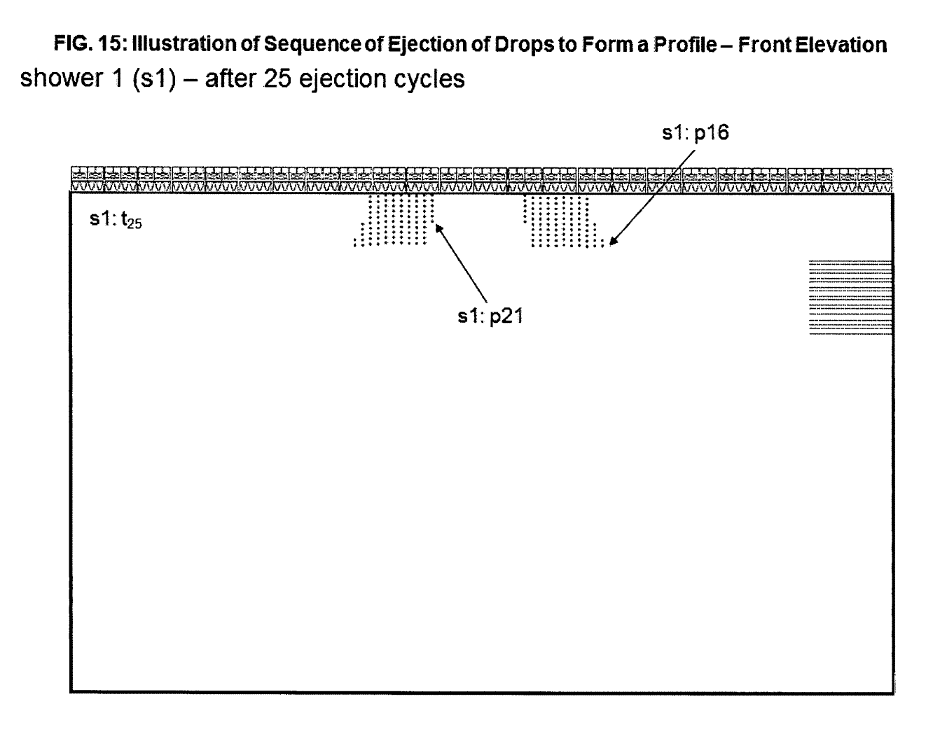

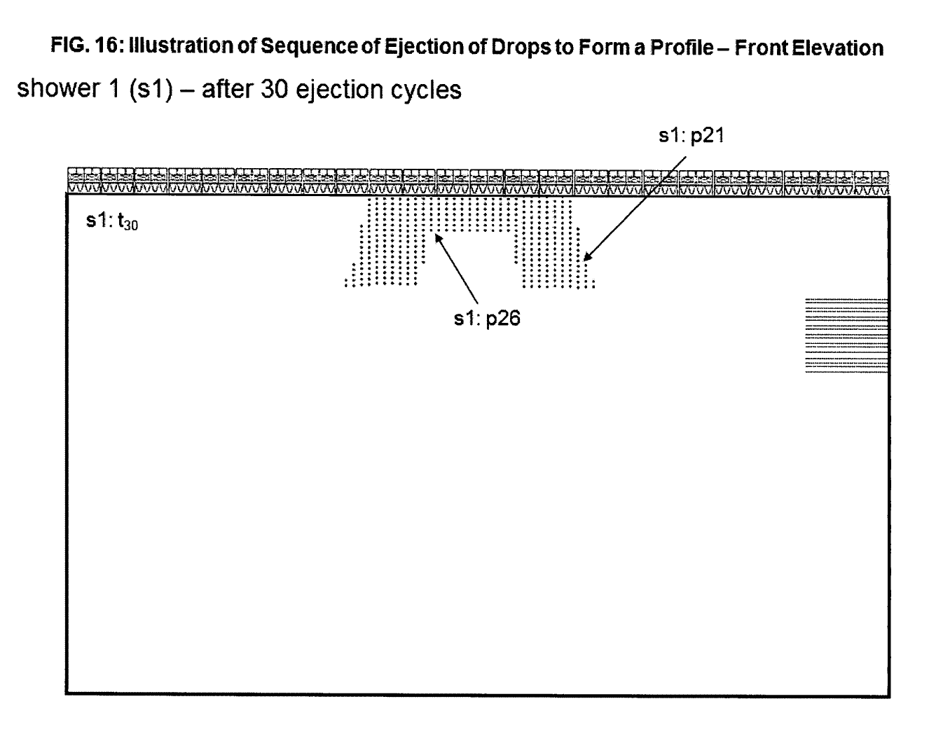

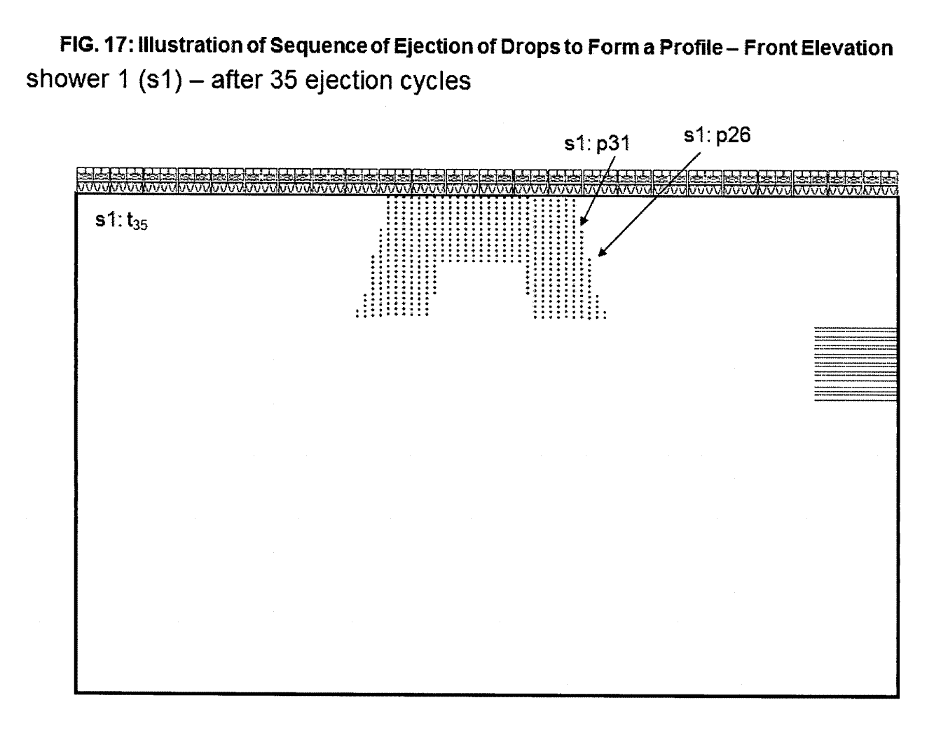

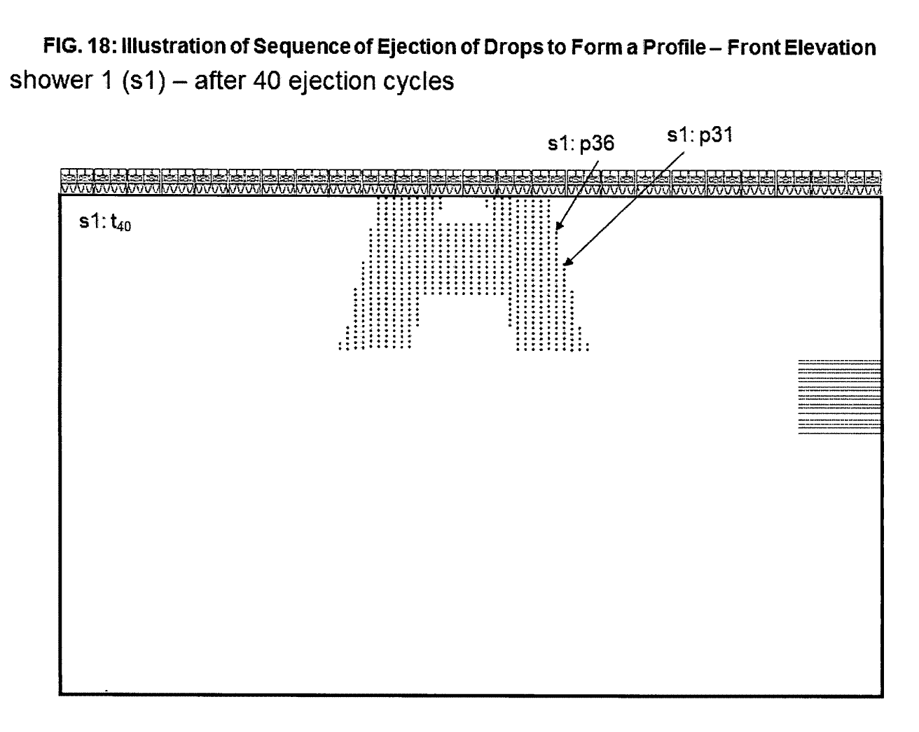

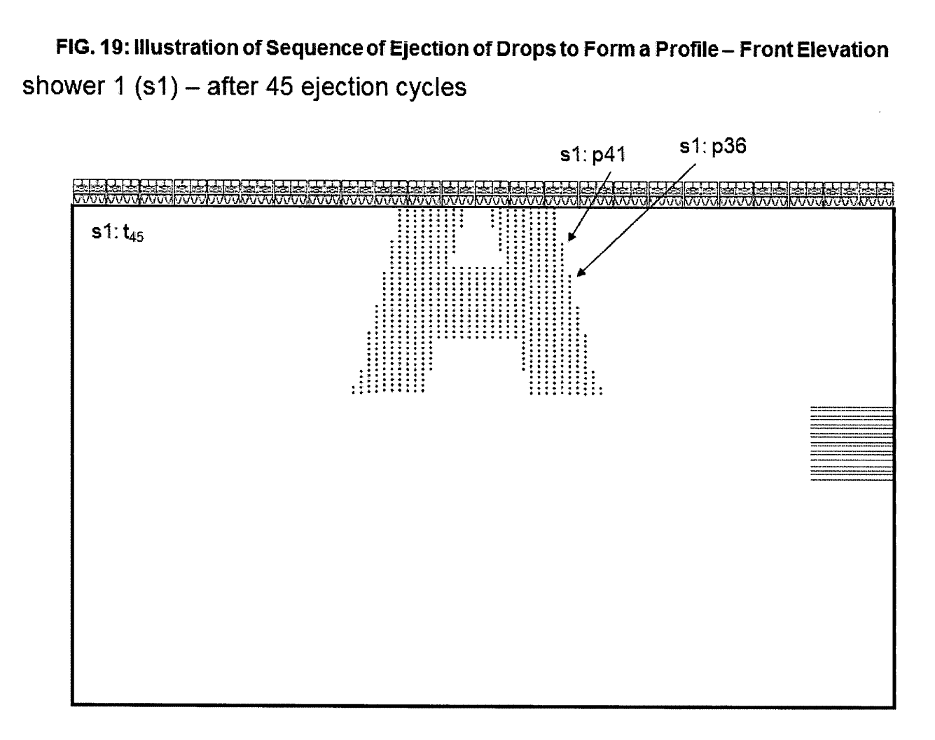

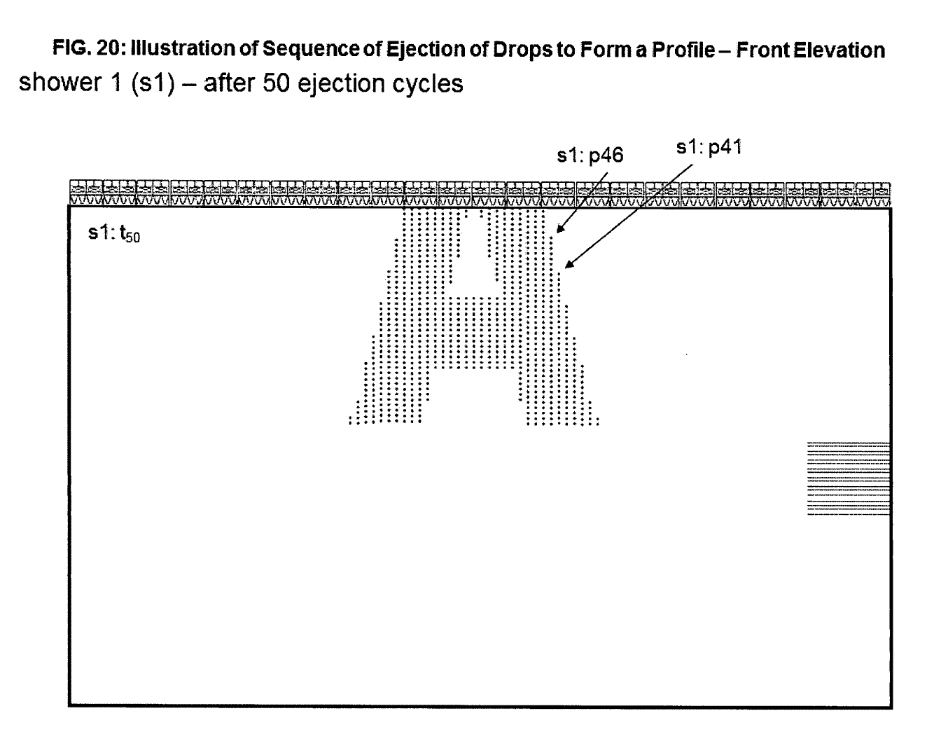

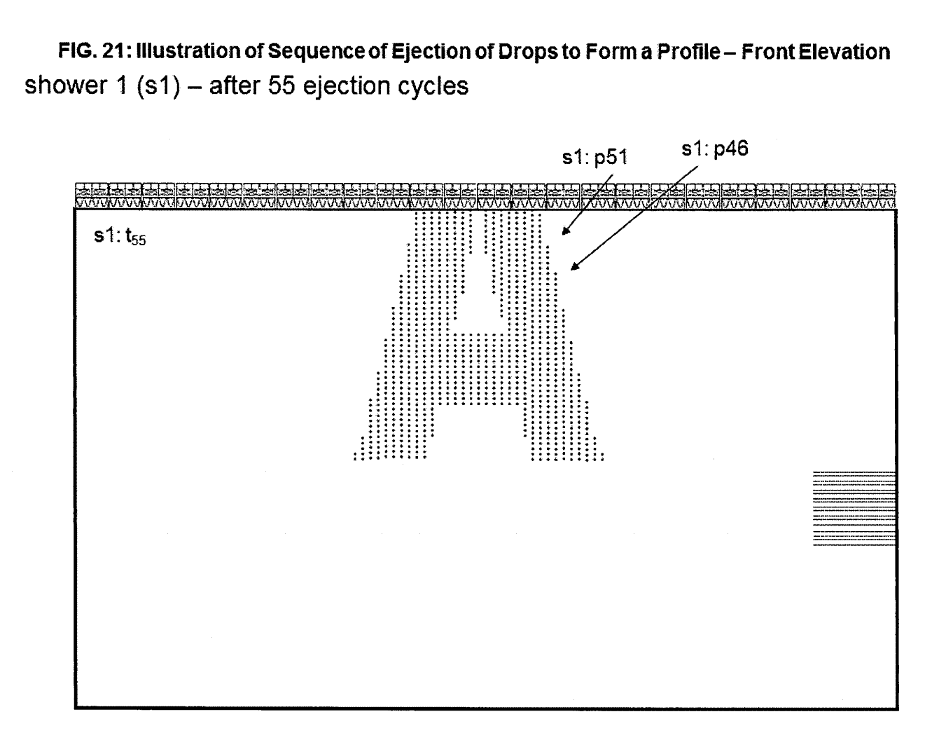

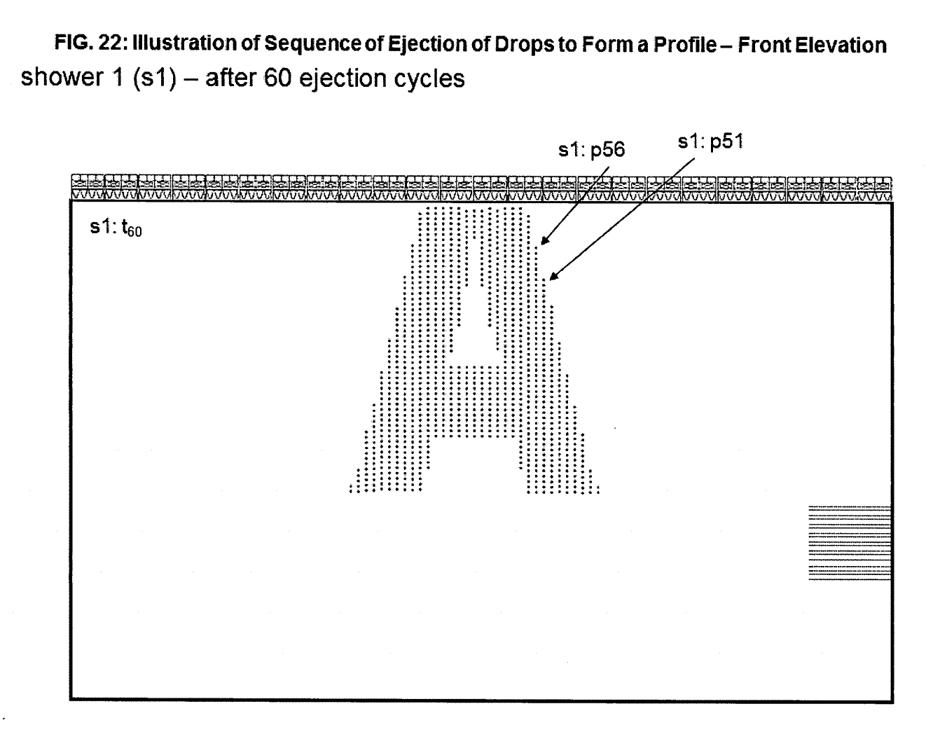

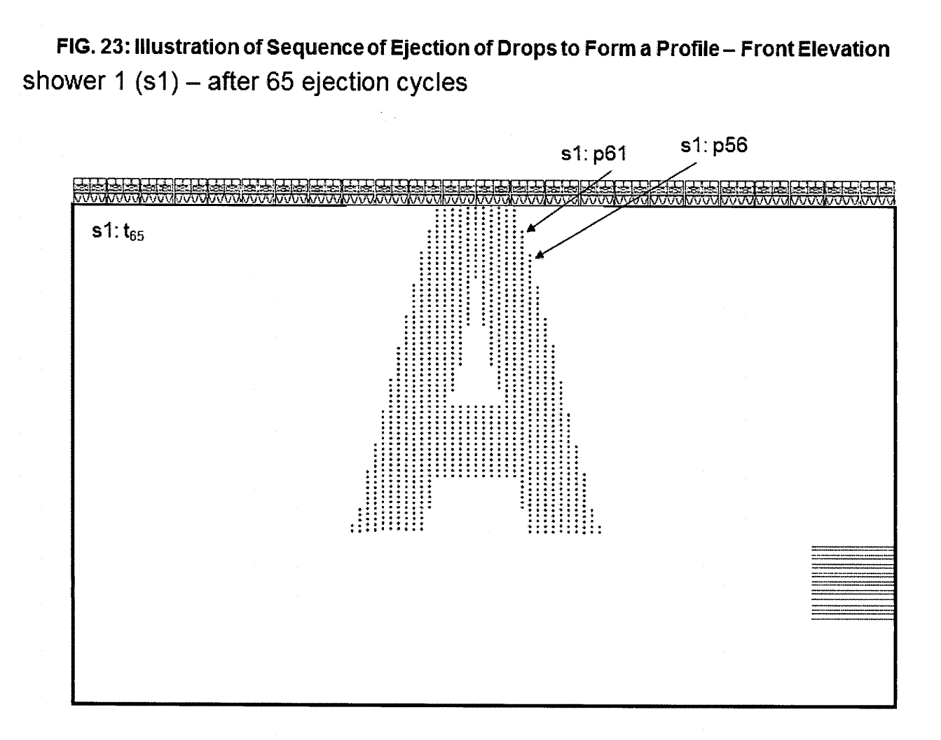

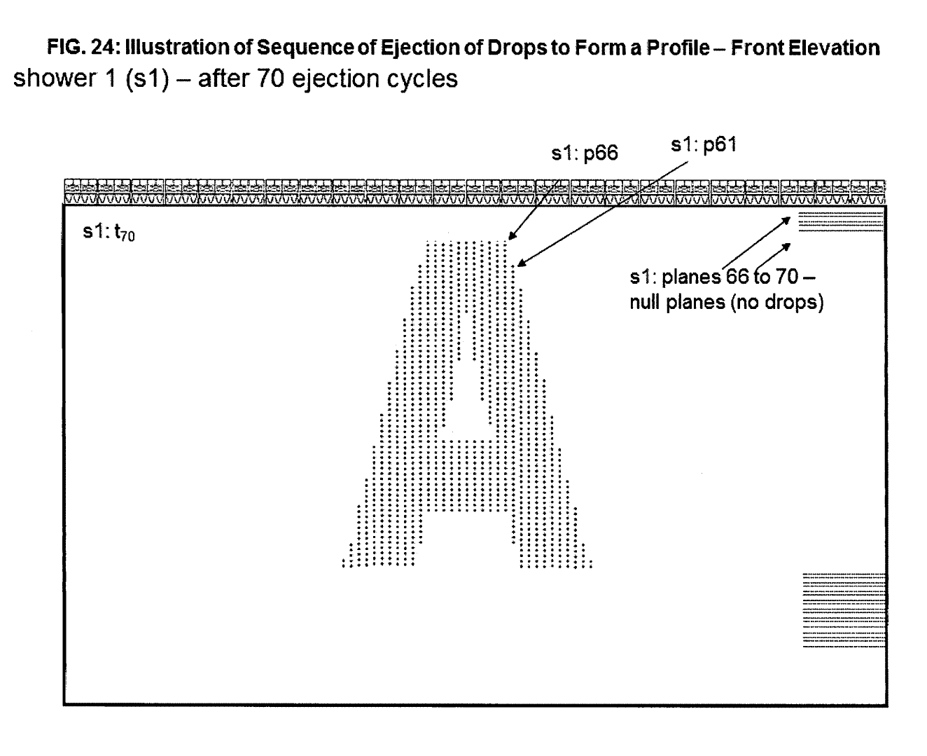

FIG. 12 to FIG. 24: sequence of ejection of particles (or drops) into the display chamber to form the pattern ‘A’.

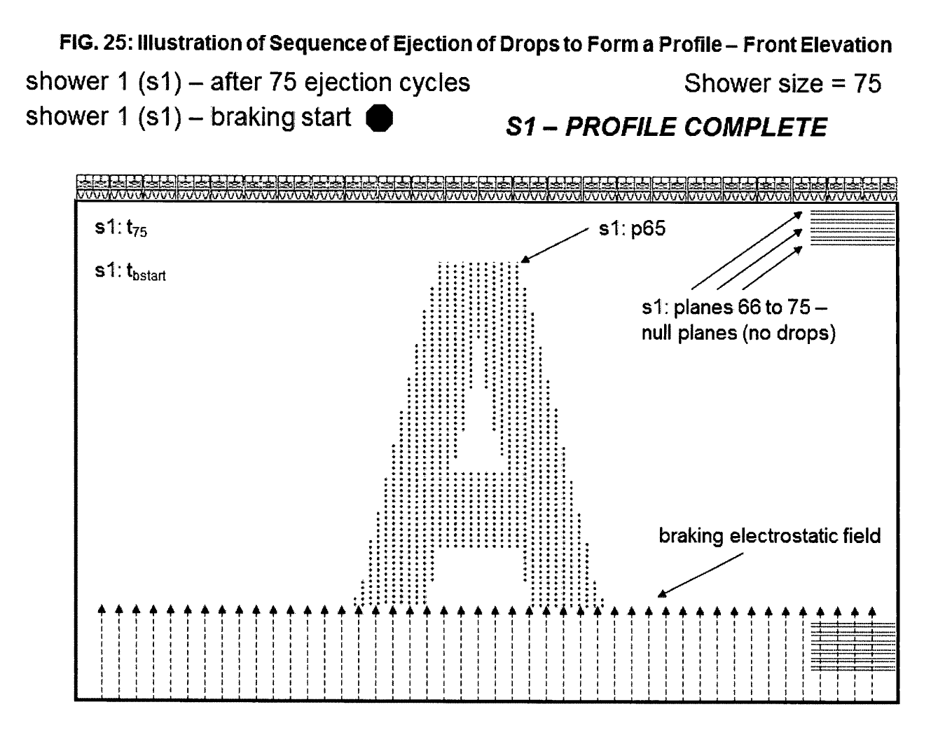

FIG. 25: braking of particles in display chamber

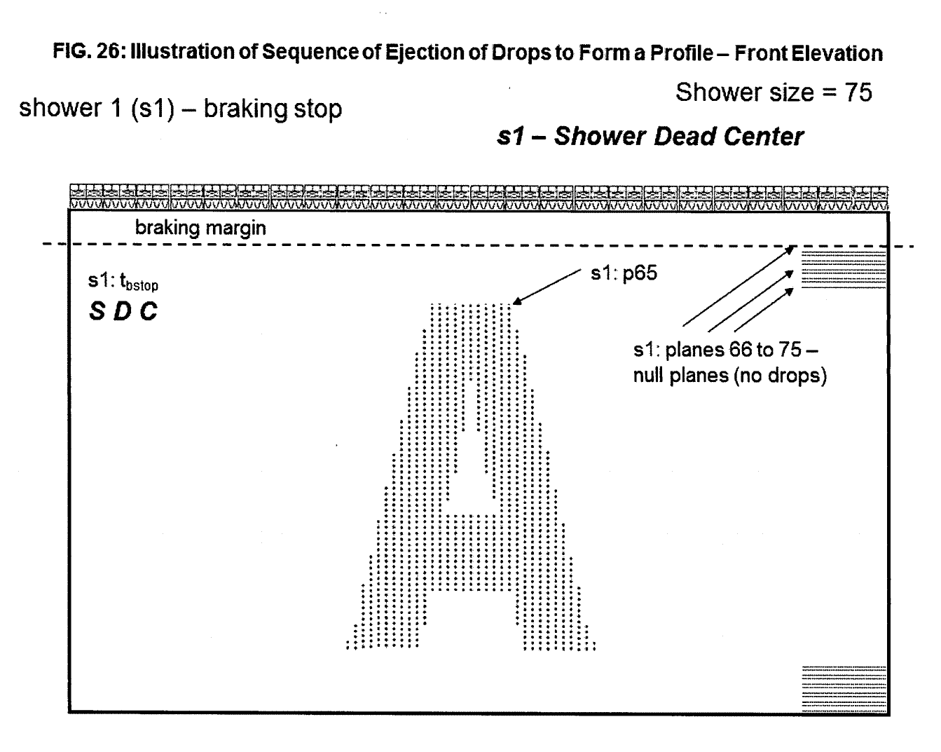

FIG. 26: particles form requisite pattern ‘A’ in display chamber

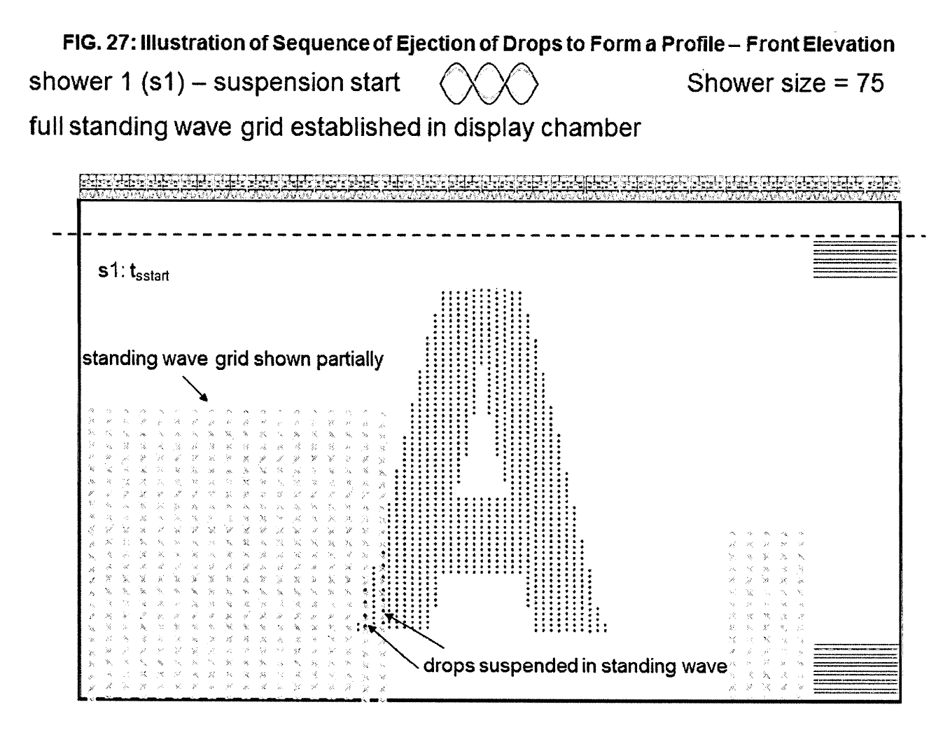

FIG. 27: particles suspended by ultrasonic standing waves in display chamber

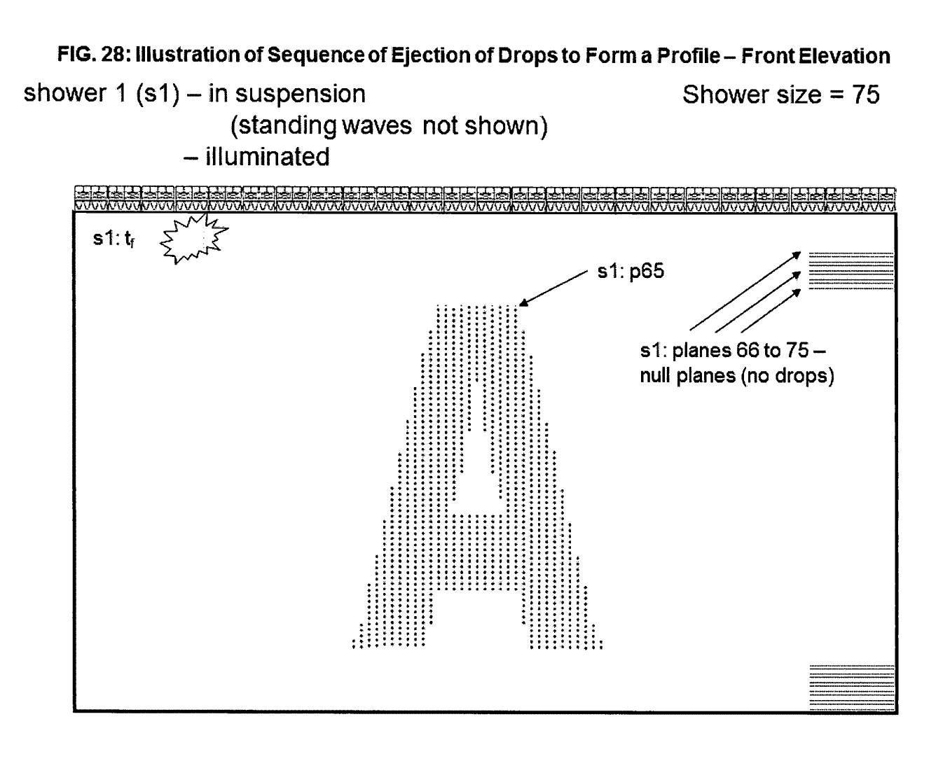

FIG. 28: display chamber illumination stage

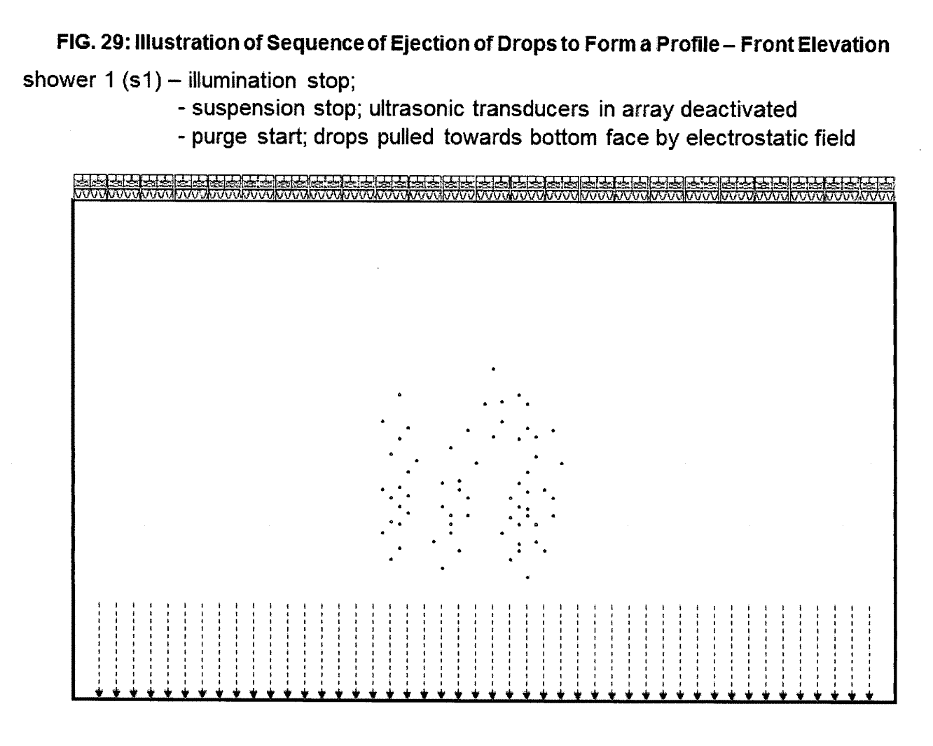

FIG. 29: purging of particles in display chamber

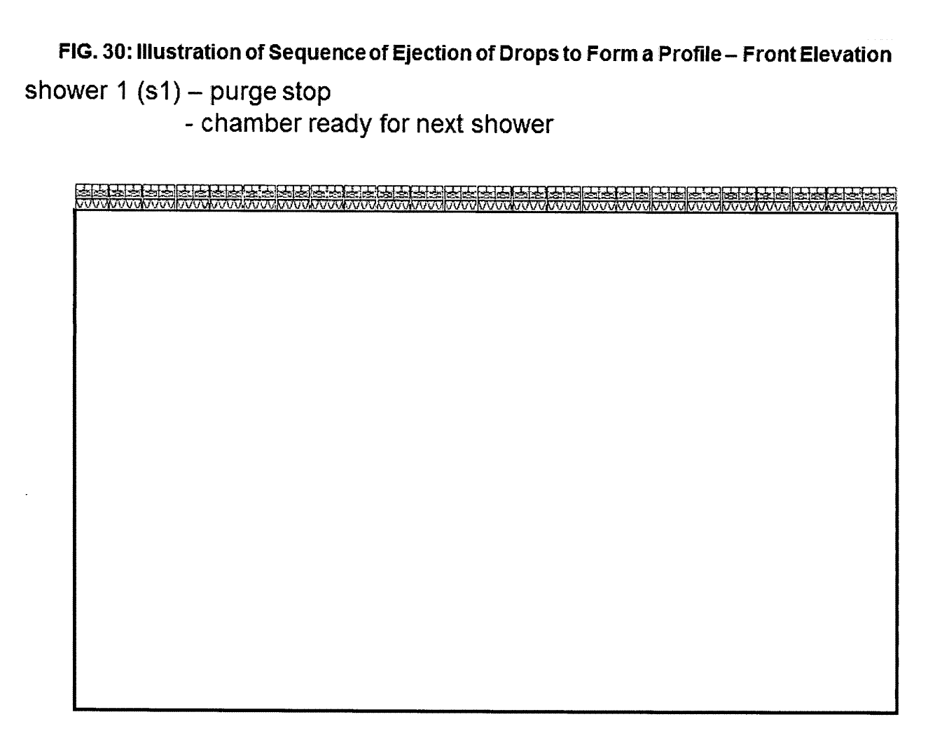

FIG. 30: empty display chamber after purging

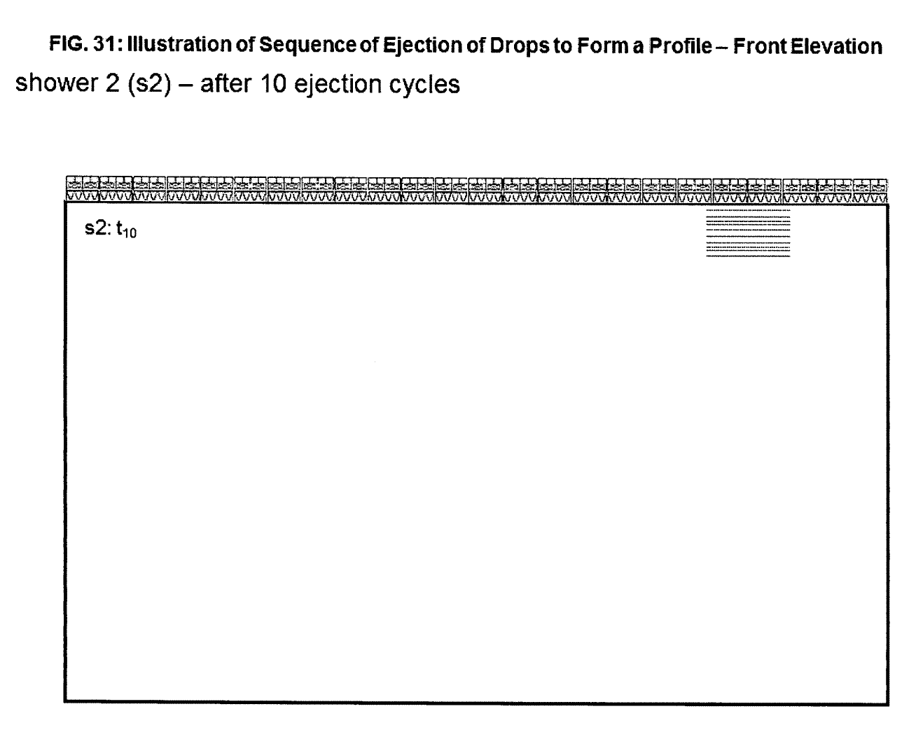

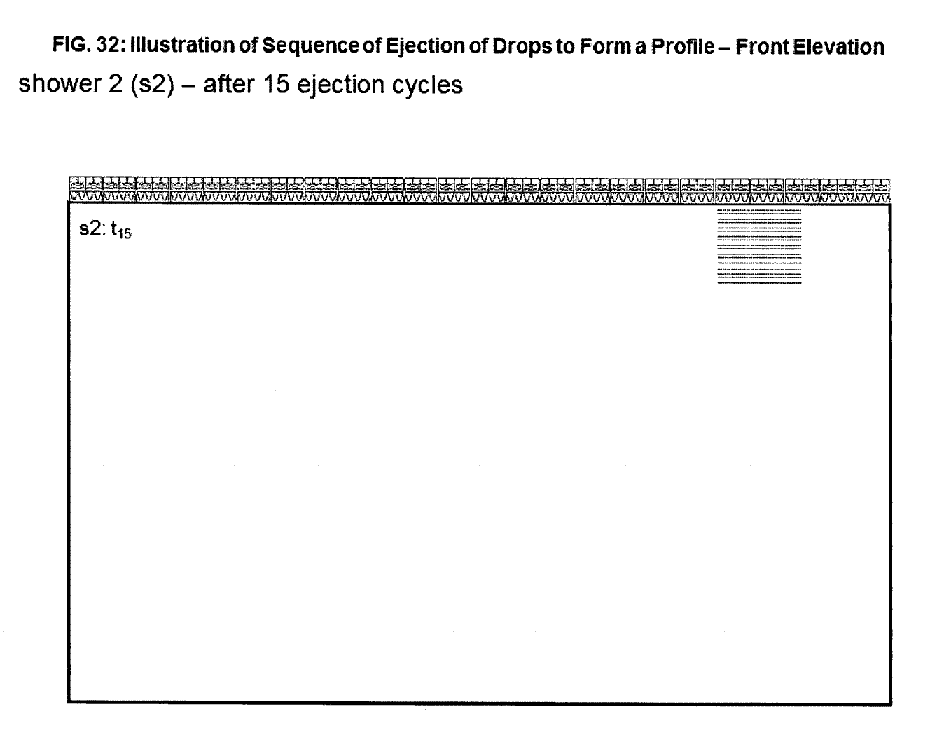

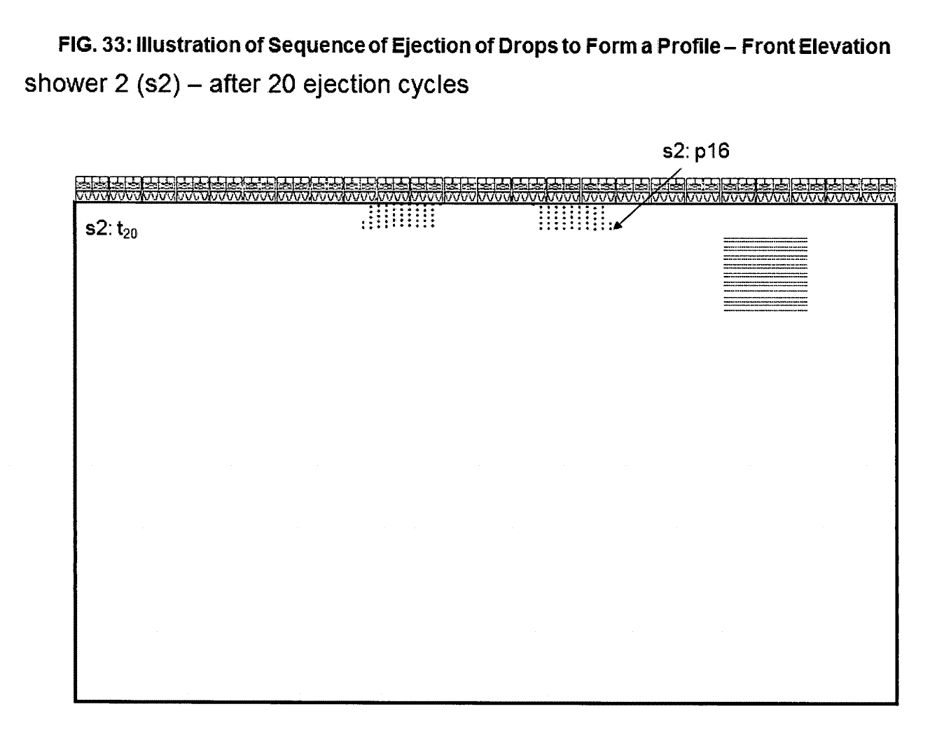

FIG. 31 to FIG. 33: sequence of particles (or drops) of the next shower ejected into the display chamber

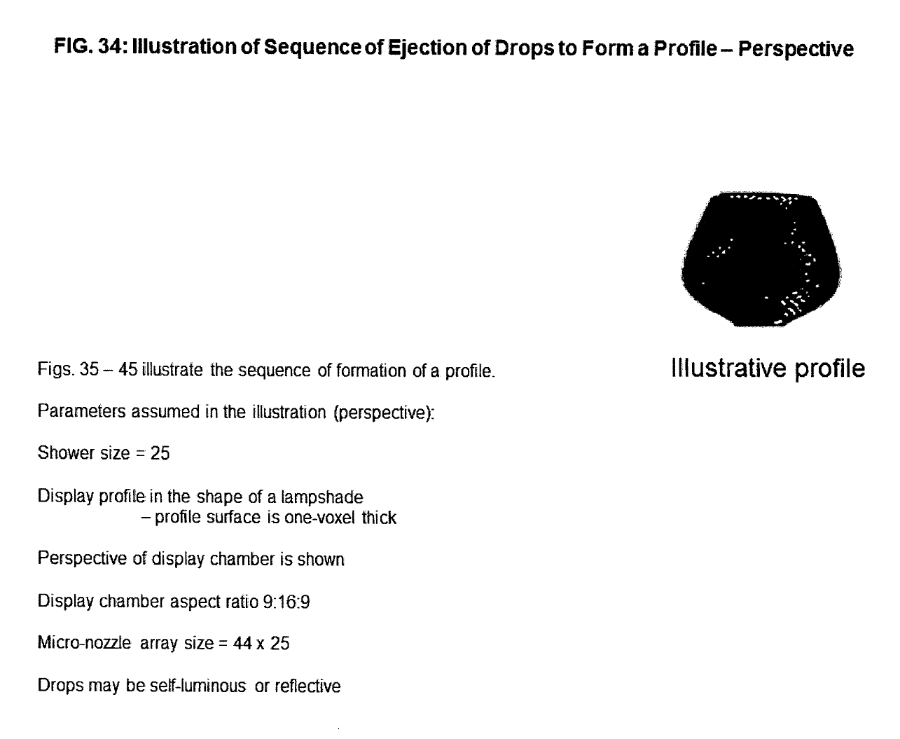

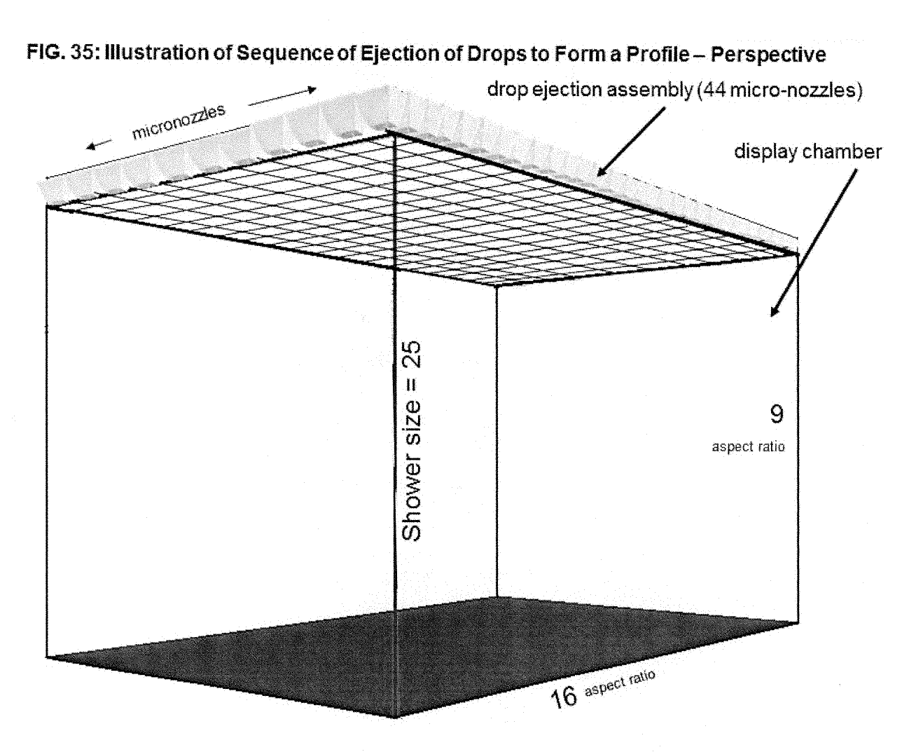

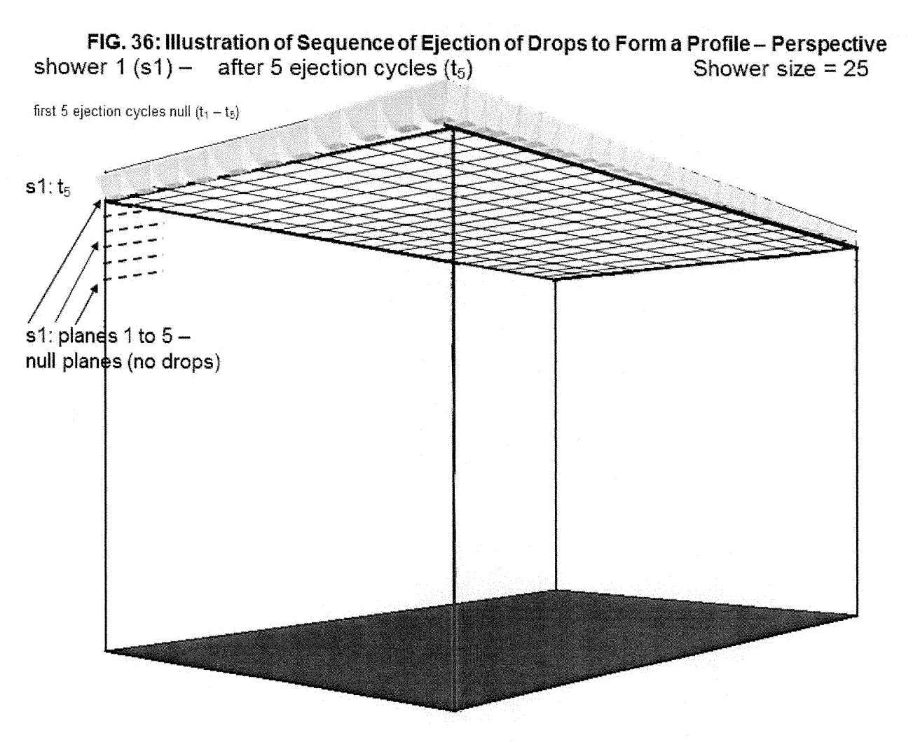

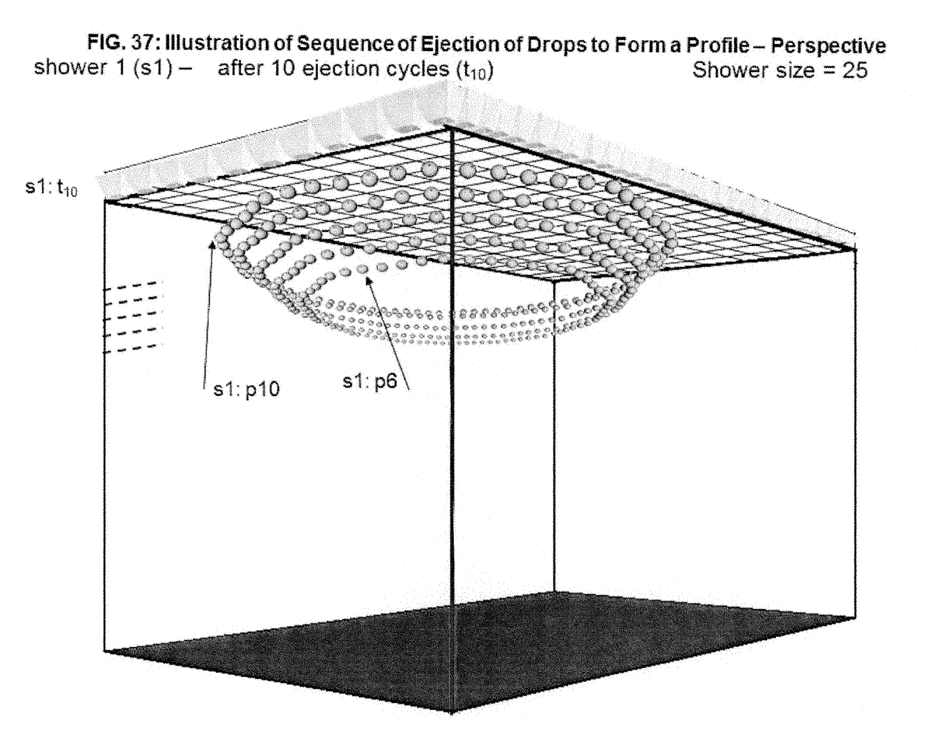

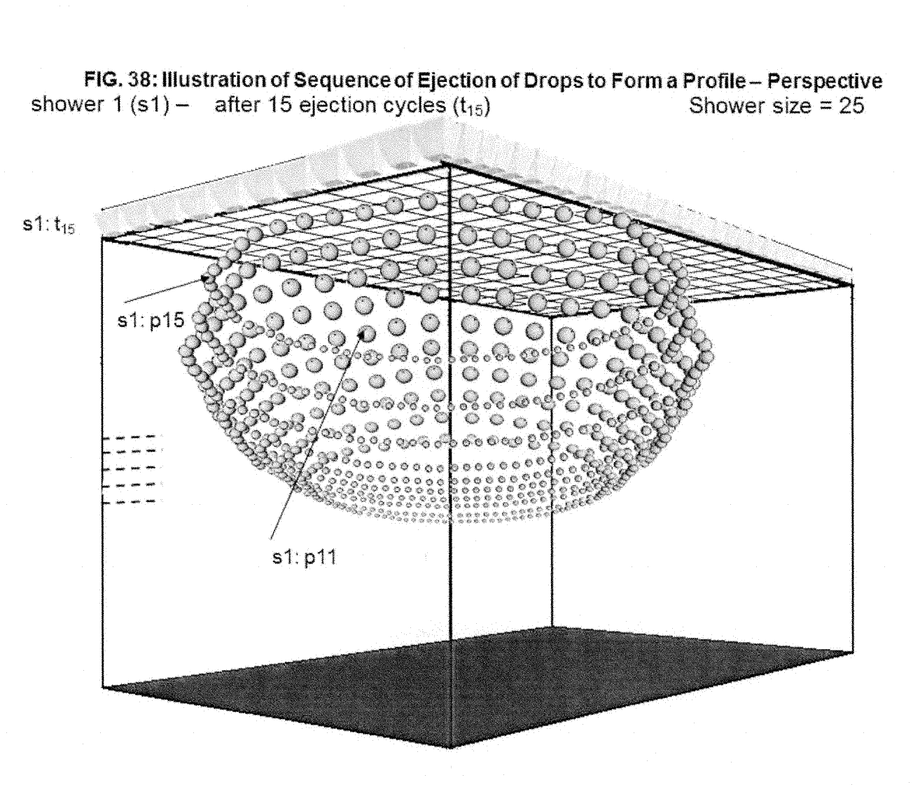

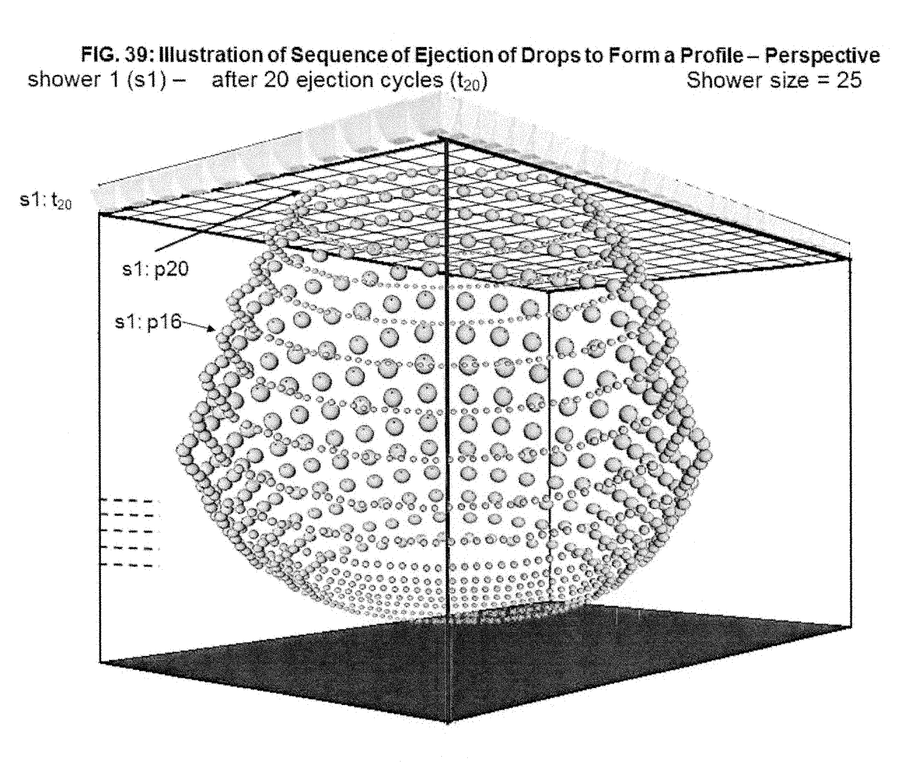

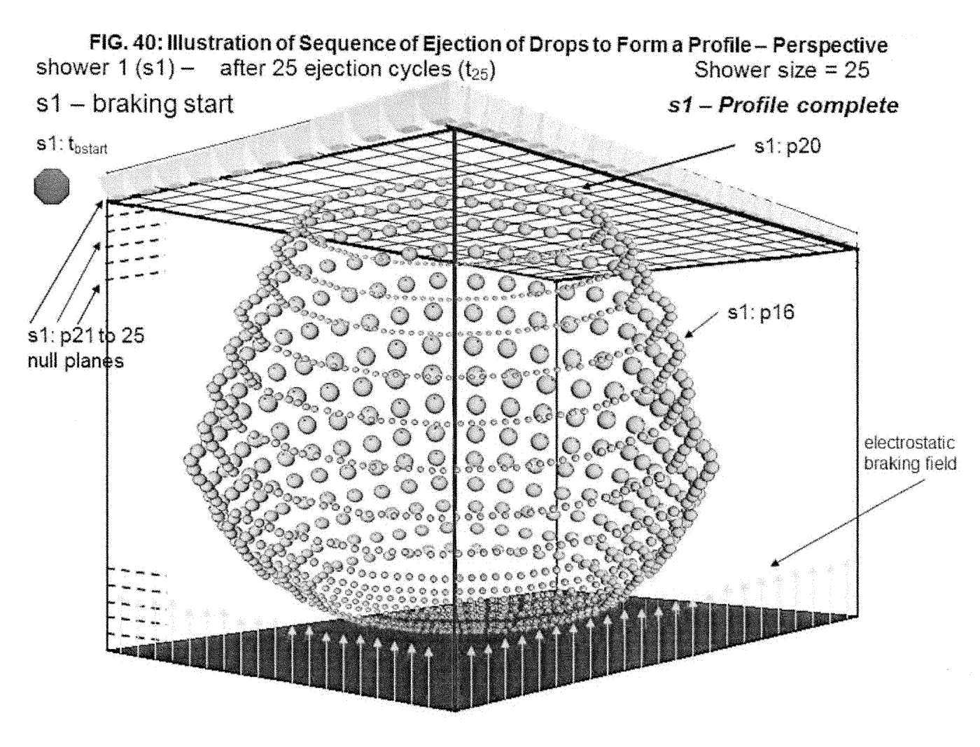

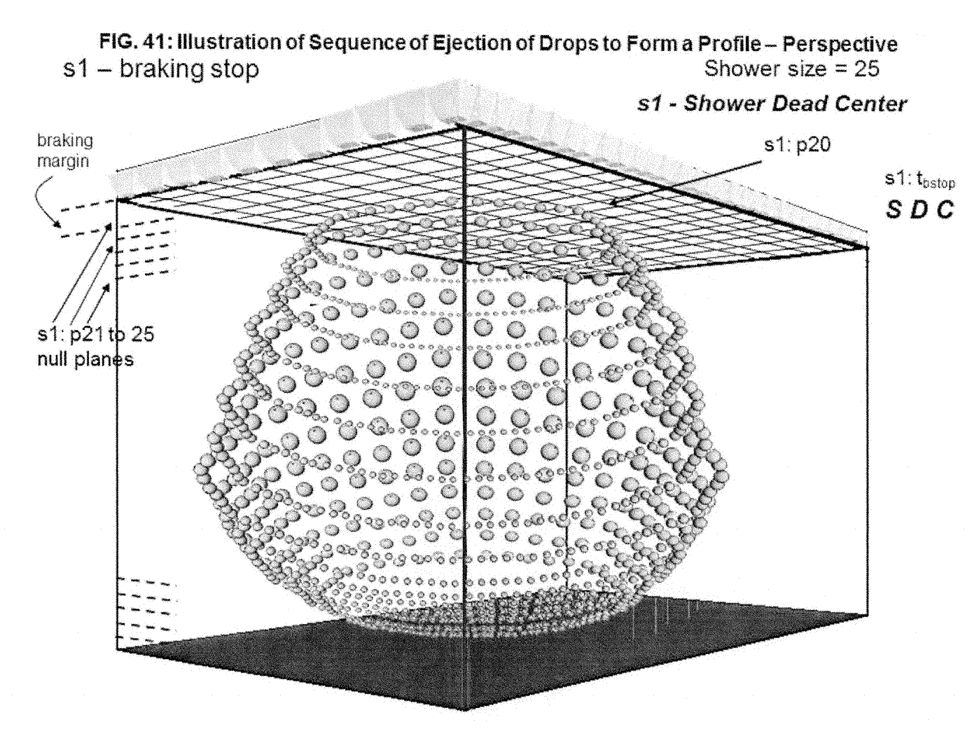

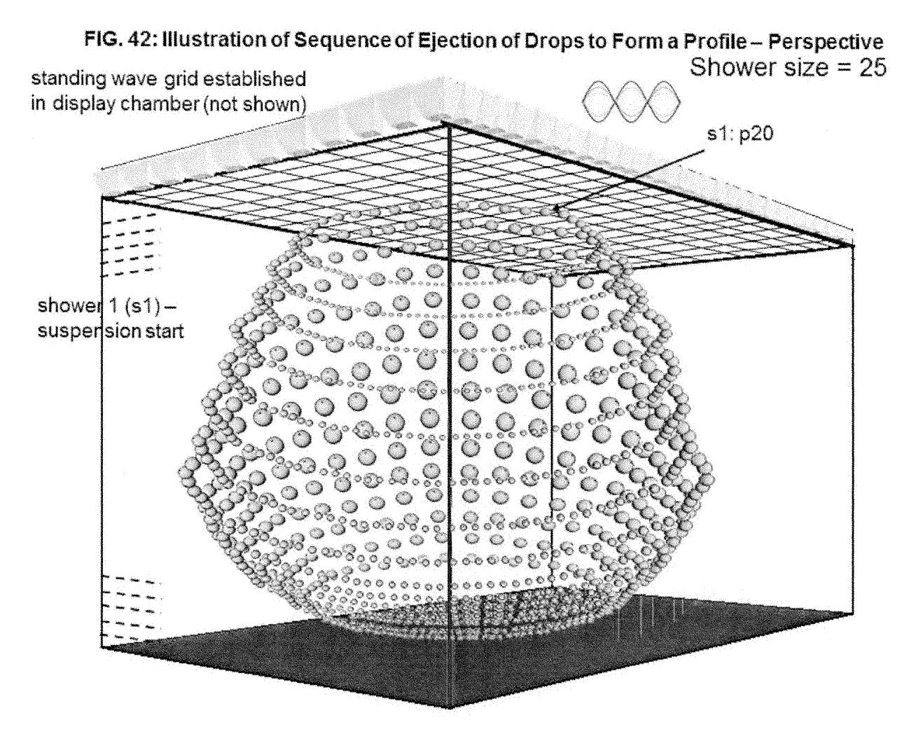

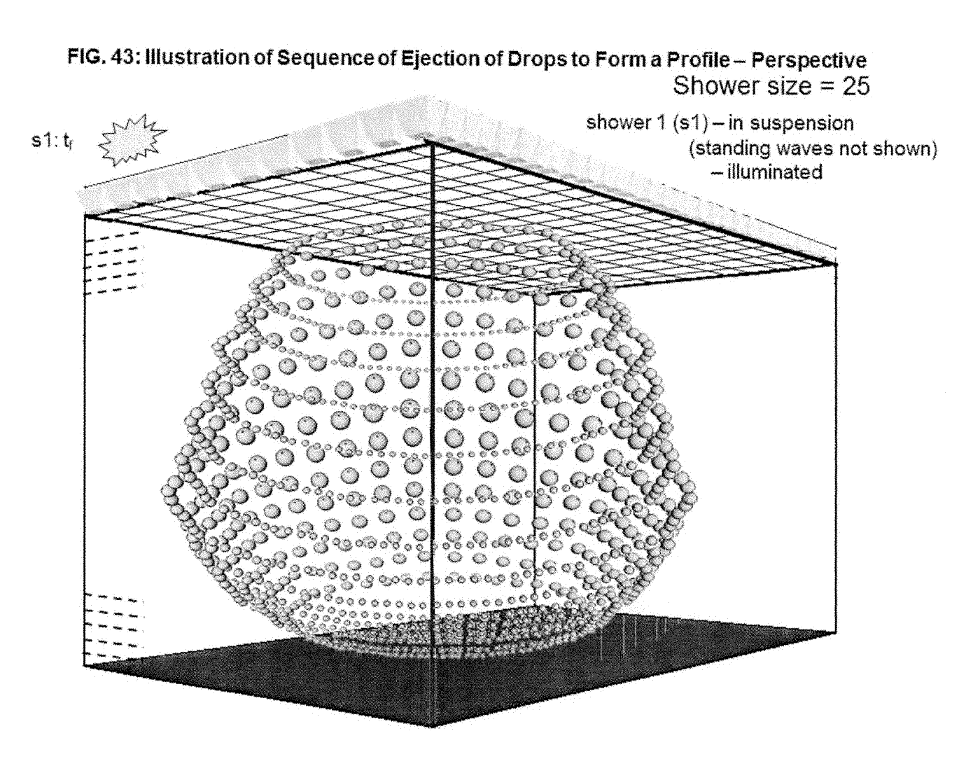

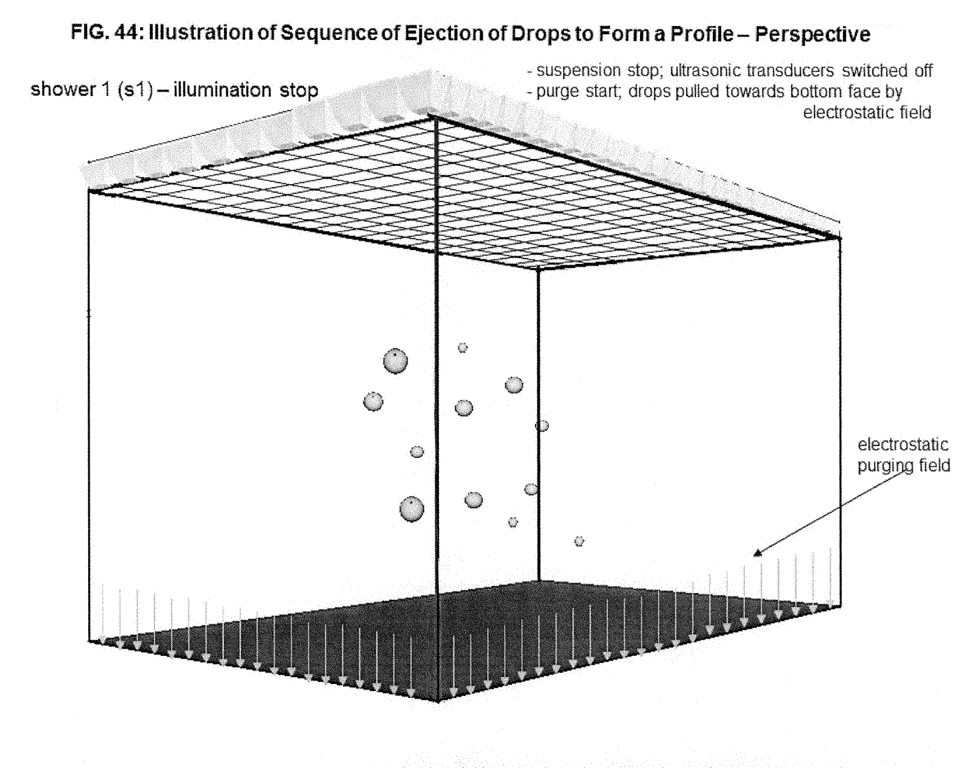

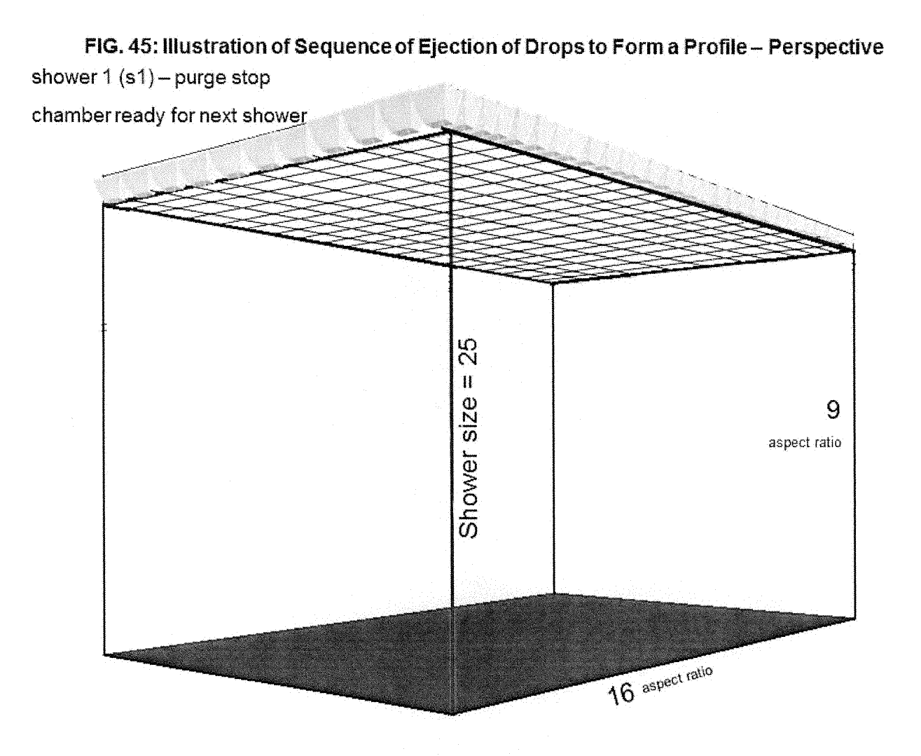

FIG. 34 to FIG. 45: sequence of ejection of particles (or drops) into the display chamber to form ‘lampshade’ pattern, in perspective

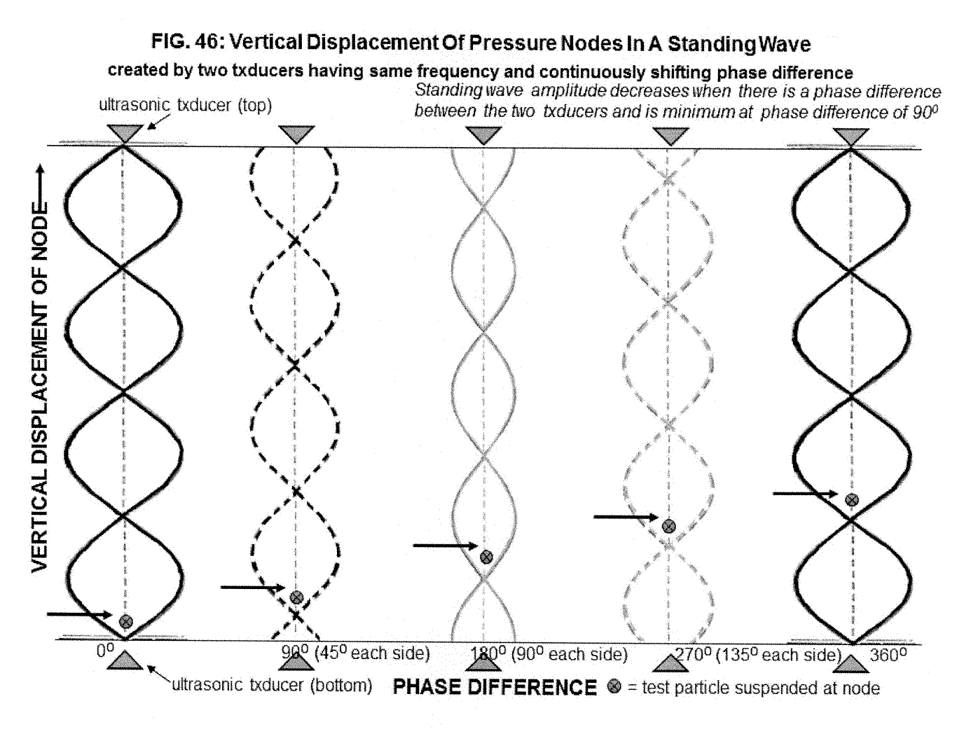

FIG. 46: moving nodes in standing wave

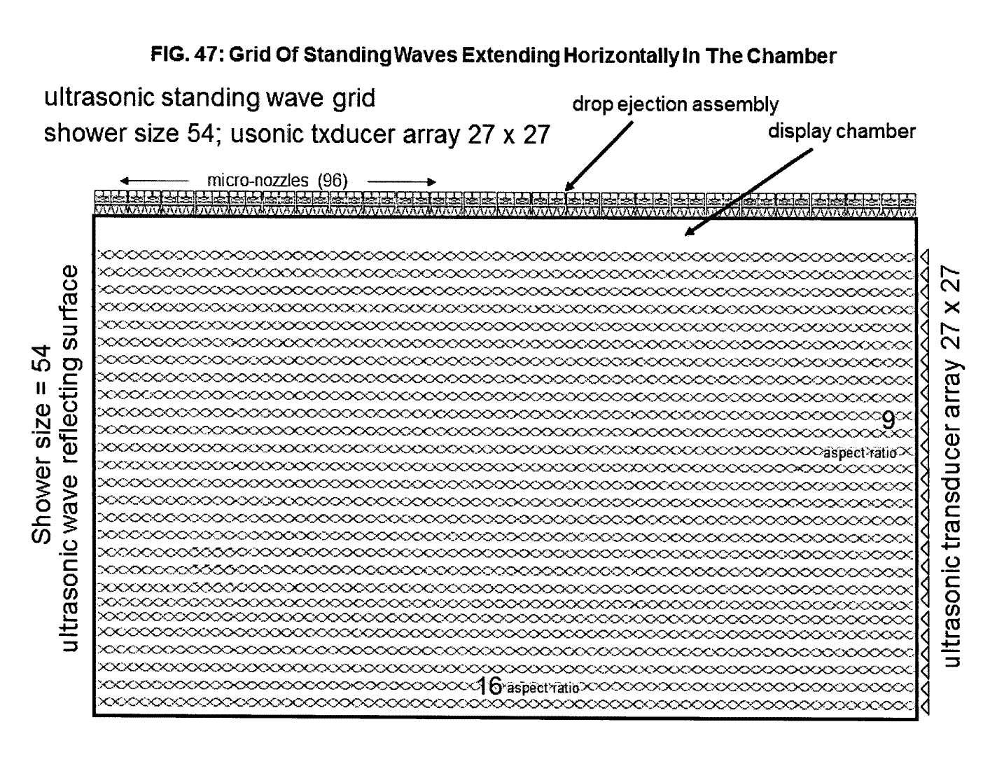

FIG. 47: grid of standing waves extending horizontally in the chamber

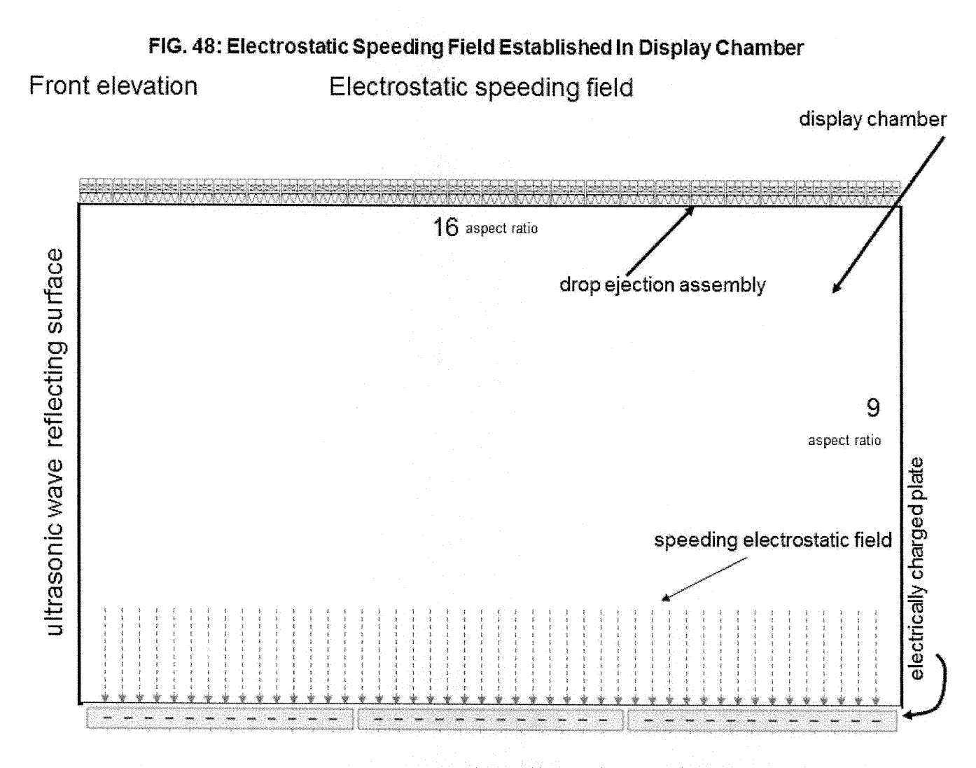

FIG. 48: electrostatic speeding field established in display chamber

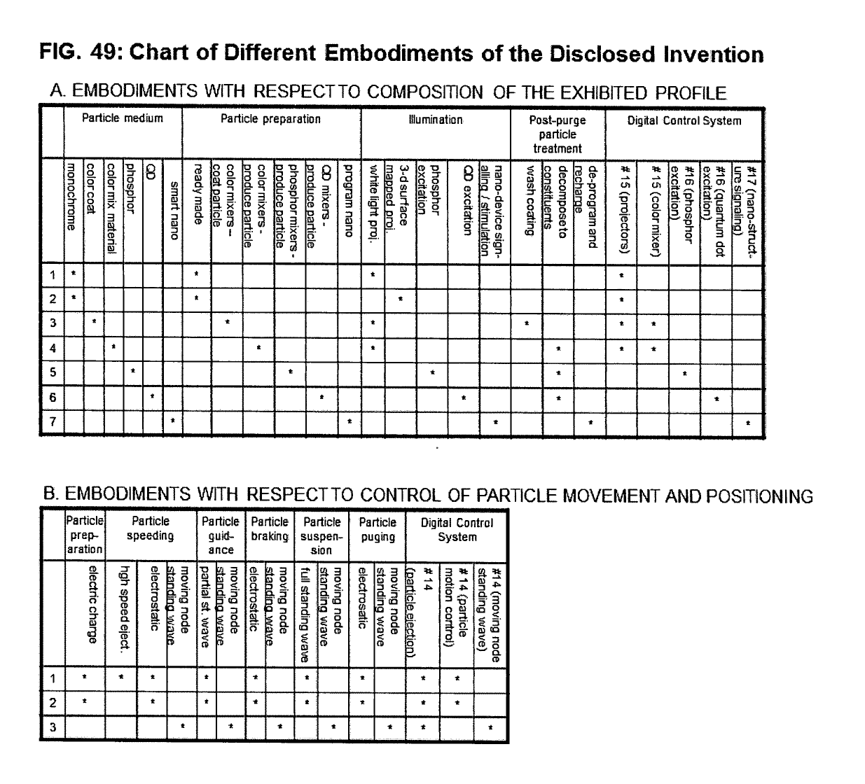

FIG. 49: Chart of different embodiments of the disclosed invention

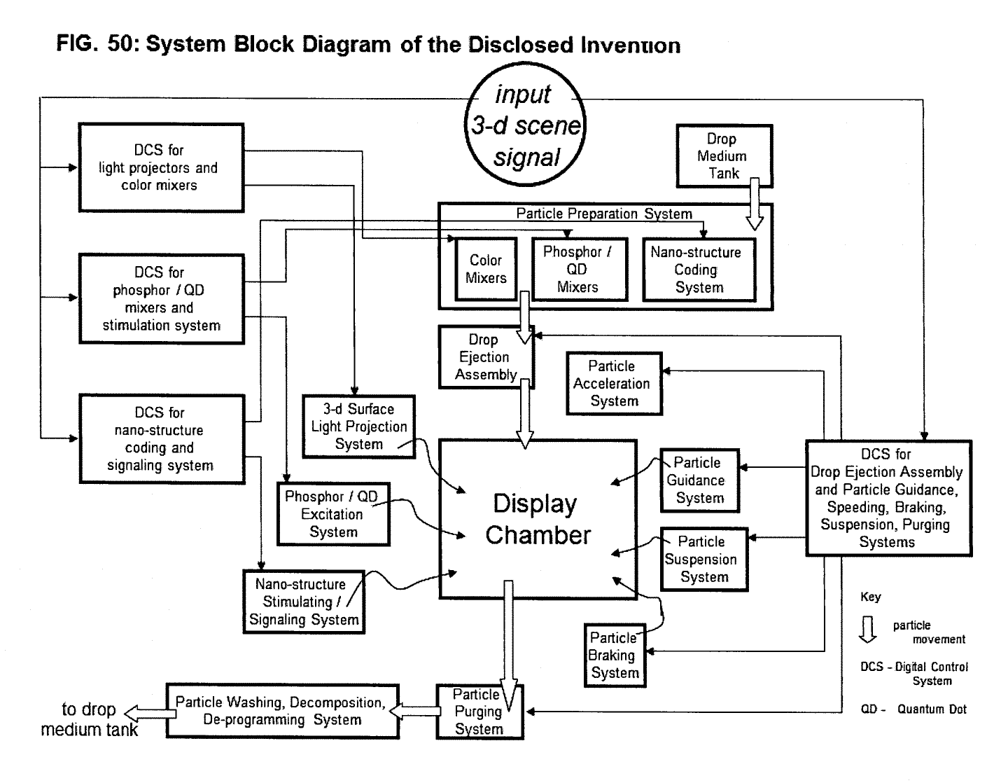

FIG. 50: System Block Diagram

### DETAILED DESCRIPTION OF THE PREFERRED EMBODIMENT

### I. Glossary of Terms Associated With the Disclosed Method and Apparatus

“drop ejection assembly”
   the array of micro-nozzles that eject particles into the display chamber
   preferably 2—dimensional array, moving or stationary
“particle”
   the unit of material that is ejected from a micro-nozzle in one ejection
   sized to occupy one voxel in the display chamber
   also called “drop” interchangeably
“profile”
   all the 3d surfaces that constitute a still 3-d scene and the objects in it
   is constituted of the plurality of drops ejected from the drop ejection assembly, and the gaps between them.
“shower”
   all the streams of drops ejected from the array of micro-nozzles to form one complete profile
   is the counterpart of “frame” in 2d displays
“shower size”
   the maximum number of drops ejected from one micro-nozzle in a shower
   equals number of horizontal planes defined in the 3d display
   denoted by ‘s’
“shower rate”
   the number of profiles constructed per second
   equals display refresh rate (e.g. 30 showers per second)
“plane”
   all the drops ejected at the same instant into the display chamber
   a horizontal cross-section of a shower, one drop in thickness
   is the counterpart of “line” in 2d displays
   the three dimensional display space consists of ‘s’ horizontal planes, where ‘s’ is the shower size, with each plane identified by a serial number in increasing order from bottom to top
   each plane is defined to consist of ‘x’ lines in the horizontal x-direction, and ‘y’ lines in the horizontal y-direction
“slot”
   the intersection point of a line in the horizontal x-direction, and a line in the horizontal y-direction,
   a plurality of slots numbering ‘x’ times ‘y’ exists on each plane
   a plurality of slots numbering ‘s’ times ‘x’ times ‘y’ exists in the display chamber
“column”
   The slots in the same x-y positions in all the planes constitute a column, whereby a column has a plurality of ‘s’ slots, and a plurality of columns numbering ‘x’ times ‘y’ exists in the display chamber
“null plane”—
   a plane containing no drops
   occurs when no drops are ejected from the drop ejection assembly in an ejection cycle; the 3-d scene has no objects or surfaces, or parts thereof, present in such a plane
“ejection rate”
   number of particles that can be ejected from one micro-nozzle in one second
“shower interval”
   time taken to eject all the droplets of a shower in seconds
“profile interval”
   the duration for which a complete profile exists in the display chamber in seconds
“shower start”
   instant when first plane of shower drops enter the display chamber
   denoted by t₁
“braking start”
   instant at which the electrostatic field is switched on for braking the velocity of the ejected particles
   denoted by t_{bstart}
“braking interval”
   interval during which the braking electrostatic field is active
“suspension start”
   instant at which the grid of full standing waves is established in the display chamber to suspend the particles
   instant at which the partial standing waves in the display chamber are turned into full standing waves, by equalizing the amplitudes of the top and bottom ultrasonic transducer arrays
“braking stop”
   instant at which the braking electrostatic field is switched off
   denoted by t_{bstop}
“shower dead center”
   instant when all planes of the shower are in the display chamber
   the profile is complete at this instant
   the display chamber illumination begins at this instant
   denoted by t_{dc}
“suspension interval”
   interval during which the drops in the display chamber are suspended in the ultrasonic standing wave grid in the display chamber
   begins with shower dead center
   duration determined by the application
“illumination interval”
   interval during which the profile in the display chamber is illuminated
   begins with shower dead center, may be less than or equal to suspension interval
“suspension stop”
   instant at which the grid of full standing waves suspending the particles in the display chamber is removed
   instant at which the standing waves in the display chamber are converted to partial standing waves by making unequal the amplitudes of the top and bottom ultrasonic transducer arrays
“purge start”
   instant at which the electrostatic field is switched on for collecting the drops in the display chamber
“display faces”
   the faces of the display chamber through which the constructed 3-d scene inside may be viewed from outside. In the preferred embodiment, the top face of the display chamber is covered by the drop ejection array and the bottom face is covered by the drop purging system, which leaves the four vertical sides open for viewing; these are the display faces

### II. List of Individually Identifiable Items or Parts That Constitute the Disclosed Invention (List Is Indicative Only)

01. 3d display chamber
02. Drop ejection assembly
03. Drop medium (particle medium)
04. Drop medium tank
05. Particle preparation system
06. Particle speeding system
07. Particle guidance system
08. Particle braking system
09. Particle suspension system
10. Drop purge and recirculation system
11. 3d surface light projection system
12. 3d surface phosphor/quantum dot stimulation system
13. 3d surface nano-structure signaling system
14. Digital control system or software/computer system for controlling the drop ejection assembly (item #2) and particle movement in the chamber
15. Digital control system or software/computer system for the light projectors (item #10)
16. Digital control system or software/computer system for the phosphor/quantum dot mixers and stimulation system
17. Digital control system or software/computer system for the nano-structure programming and stimulation/signaling system
18. Interface between digital control system (item #13) and the drop ejection assembly (item #2)
19. Interface between digital control system (item #14) and the light projectors (item #10)
20. Interface between digital control system (item #15) and the phosphor stimulation system (item #11)
21. Interface between digital control system (item #16) and the nano-structure signaling system (item #12)

### III. Item-Wise Description of the Configuration and Working of the Disclosed Apparatus

### 01. 3d Display Chamber

dimensions commensurate with existing 2-d displays/TV sets
glass/plastic/acrylic or any suitable transparent material
can have the aspect ratio required by the application; the preferred aspect ratio is 9:16:16, affording a 2-d aspect ratio 9:16 on all four sides of the display; alternate preferred aspect ratio is 9:16:9
filled with suitable liquid or gas, or any combination of solid, liquid and gas, for establishing standing waves of requisite frequency and wavelength (e.g. air, Xenon gas)
see FIG. 1/50

### 02. Drop Ejection Assembly

an array (of 1, 2, 3 or 4 dimensions) of individually controlled devices that eject material particles or drops (generically referred to as ‘micro-nozzles’ in this disclosure)
may be stationary or moving (for example, can have reciprocating motion up and down the display chamber to eject droplets plane by plane as they are reached)
each micro-nozzle ejects into the display chamber voxel-size drops of a medium described below (at item #3), by individually timed ejection of the drops
mounted on any one side of the display chamber, depending on individual display requirements; in this description, mounting on top surface is assumed throughout
the ejection of the drops is controlled by signals from the digital/computer system described below (at item #14)
each micro-nozzle ejects streams of drops that form the strands of 3d surfaces, having gaps where there are gaps between the surfaces; all the nozzles together produce all the 3d surfaces of the scene, with gaps where there are gaps between surfaces in the scene
the drops are accelerated in, at or beyond the nozzles by electro-static, electro-magnetic, pneumatic, hydraulic, optical or mechanical means, or a combination of them, to impart them the requisite transit velocity in the display chamber
the drops are imparted controlled/variable static electric charge in or at the nozzles to enable them to be accelerated by a speeding electrostatic field and slowed by a braking electrostatic field in the chamber
see FIG. 2/50, 3/50

### 03. Drop Medium

a) where monochromic 3-d surfaces are required in the chamber, any solid, liquid, or vaporous materials, or combination of these, formed into identical particles either beforehand or at the point of ejection, that constitute 3-d material surfaces in the chamber that are illuminated by white light
b) where 3-d surfaces with full color reproduction are required, any solid, liquid, or vaporous materials, or combination of these, formed into identical particles either beforehand or at the point of ejection, that constitute 3-d material surfaces in the chamber and are capable of displaying by reflection a scene projected in full color onto them by external projection devices
c) where 3-d surfaces with full color reproduction are required, any solid, liquid, or vaporous materials, or combination of these, formed into identical particles either beforehand or at the point of ejection, with each particle coated at the point of ejection, i.e. on the fly, by a material having a color mix corresponding to the color and brightness required at the position designated for that particle in the chamber, and with the plurality of particles constituting 3-d material surfaces in full color in the chamber that are illuminated by white light
d) where 3-d surfaces with full color reproduction are required, any solid, liquid, or vaporous materials, or combination of these, that are mixed at the point of ejection, i.e. on the fly, to form a particle having the color and shade corresponding to the color and brightness required at the position designated for that particle in the chamber, with the plurality of ejected particles constituting 3-d material surfaces in full color in the chamber that are illuminated by white light
e) where luminescent 3-d surfaces are required in the chamber, any solid, liquid, or vaporous materials, or combination of these, that are mixed at the point of ejection, i.e. on the fly, to form a free moving, unbound phosphor (luminescent particle) having the color and density corresponding to the color and brightness required at the position designated for that particle in the chamber, with the plurality of ejected particles constituting 3-d material surfaces in the chamber that emit light of different colors and brightness when excited by external sources
f) where luminescent 3-d surfaces are required in the chamber, any nano-structures or material (quantum dot), or combination of these, that are mixed at the point of ejection, i.e. on the fly, to form a free moving, unbound quantum dot (luminescent particle) having the color and density corresponding to the color and brightness required at the position designated for that particle in the chamber, with the plurality of ejected particles constituting 3-d material surfaces in the chamber that emit light of different colors and brightness when excited by external sources
g) where luminescent 3-d surfaces are required in the chamber, uniform ‘smart’ light-emitting nano-structures that contain light-emitting material of primary colors, and may carry a rechargeable energy source, and that can be programmed on the fly (i.e. provided with a variable binary string) to emit light of specified color and intensity when stimulated or signaled wirelessly; the plurality of ejected particles constitute 3-d material surfaces in the chamber that emit light of different colors and brightness when required
h) any combination of the above as required
i) if using phosphors or quantum dots to mix into customized particles, they can be grouped in suspension in liquid drops in an aqueous or non-aqueous solution, or otherwise made to coalesce into a drop of requisite size

### 04. Drop Medium Tank

container(s) that hold the drop medium in adequate quantity, and
make it available for drawing by the drop ejection assembly, or by the mixing/assembling facilities, as the case may be
having requisite compartments to segregate different materials used for coating/mixing/assembling, in case the drop medium is prepared on the fly
having requisite ingress system for supply of drop medium into the tank, and egress system to the drop ejection assembly, or the mixing/assembling apparatus, as the case may be
and having apparatus for regulating the ingress and egress systems

### 05. Particle Preparation System

a) where 3-d surfaces with full color reproduction are required, a color mixing apparatus associated with each micro-nozzle in the drop ejection array, that mixes materials of different colors to produce on the fly a color mix corresponding to the color and brightness required at the position designated for each particle in the chamber, and makes it available for coating each particle on the fly
b) where 3-d surfaces with full color reproduction are required, a color mixing apparatus associated with each micro-nozzle in the drop ejection array, that mixes materials of different colors on the fly to produce a particle having a color mix corresponding to the color and brightness required at the position designated for each particle in the chamber, and makes the particle available for ejection
c) where luminescent 3-d surfaces are required in the chamber, a combining apparatus associated with each micro-nozzle in the drop ejection array, that combines phosphor materials of different colors on the fly to produce a composite, free moving, unbound phosphor (luminescent particle) having the color and density corresponding to the color and brightness required at the position designated for that particle in the chamber
d) where luminescent 3-d surfaces are required in the chamber, a combining apparatus associated with each micro-nozzle in the drop ejection array, that combines nano-materials (quantum dots) of different colors on the fly to produce a composite free moving, unbound quantum dot (luminescent particle) having the color and density corresponding to the color and brightness required at the position designated for that particle in the chamber
e) where luminescent 3-d surfaces are required in the chamber, a programming apparatus associated with each micro-nozzle in the drop ejection array, that writes a code or program (i.e. binary string) on the fly to ‘smart’ nano-structures to emit light of specified color and intensity when stimulated or signaled wirelessly

### 06. Particle Speeding System

for speeding up the ejected particles, in, at or beyond the micro-nozzles, to impart to them the requisite transit velocity to reach their designated positions within the chamber
the particles are accelerated by electro-static, electro-magnetic, pneumatic, hydraulic, optical or mechanical means, or a combination of them, in the display chamber
the primary mobility of the particle comes from the ejection; high speed ejection may provide a part or all of the required velocity
the preferred embodiment has an electrostatic field controlled for intensity and/or gradient, which is
preferably produced by an electrified plate provided at the bottom face, and
an electrified plate provided at the top face of the display chamber,
where both plates are activated during the shower interval to set up electric fields attracting the charged particles in the chamber
so that the particles exist between an attracting electric field originating from the bottom face, and an attracting field originating from the top face, with the balance and gradient of the net force on them being variable, and regulates their velocity and position
simplifies the micro-nozzle design, size and cost
aids in overcoming aerodynamic or hydrodynamic resistance, as the case may be, to the movement of the particle
see FIG. 48/50

### 07. Particle Guidance System

guides the particles after ejection, through the chamber, to their designated positions
prevents the particles from deviating on account of mutual interaction of their electric charge, or any other interfering force
includes a grid of partial standing waves having “pea-pod” pattern
nominal node width =width of 1 column =nominal anti-node width
partial standing waves are vertically aligned, i.e. travel top to bottom, assuming drop ejection from top and drop collection at bottom
the partial standing waves form chutes to guide the ejected particles down the display chamber
created by ultrasonic transducer arrays at the top and bottom of the display chamber, top array emitting with amplitude different from bottom array, to form partial standing waves
top array of ultrasonic transducers may be integrated with micro-nozzle array
in one embodiment, there is one partial standing wave for every micro-nozzle, i.e. one partial standing wave to guide every column of particles
electrostatic interaction between neighboring particles in the vertical direction is offset by controlling the ejection timing, velocity and electric charge of the particles, and also the electric field applied in the chamber, as required
an electrified plate is provided at the top face of the display chamber to provide an electrostatic field, as an additional control in the particle speeding, guidance, braking, suspension and purging systems see FIG. 5/50, 7/50, 8/50

### 08. Particle Braking System

for braking the moving particles within the chamber, prior to suspension at their designated positions
an electrostatic field controlled for intensity and/or gradient
preferably produced by an electrified plate mounted at the bottom face (see FIG. 4/50), assuming drop ejection assembly is mounted on top face, and
augmented by an electrified plate provided at the top face of the display chamber to provide an electrostatic field, as an additional control in the particle speeding, guidance, braking, suspension and purging systems
activated when the particles are at or near their designated positions
see FIG. 6/50

### 09. Particle Suspension System

suspends the particles at or near their designated positions
engaged when the particles are at or near their designated positions, and slowed by braking,
in one embodiment, which has one partial standing wave for every column of particles, the partial standing waves serving as chutes (item #7) are converted to conventional (full) standing waves by equalizing the amplitudes of the top and bottom ultrasonic transducer arrays
the plurality of standing waves form a grid consisting of nodes, antinodes and interstices between nodes (see FIG. 9/50)
nominal node width is zero, nominal anti-node width=width of 1 columns
the standing wave grid keeps the particles suspended
given that particle dimensions are of the order of 1 mm for a display having a vertical dimension of 720 mm, and the particle medium is not necessarily of high density, the intensity of the acoustic wave required to suspend the particles against gravity may be practically achievable
see FIG. 10/50
when the particles require to be purged, the standing waves are converted back to partial standing waves having pea-pod pattern, to allow purging
serve as chutes for the next shower of particles
in another embodiment, an electrified plate is provided at the top face of the display chamber, in addition to the electrified plate mounted at bottom face for braking
to suspend the particles, the electrified plate provided at the top face is activated, and sets up an electric field opposing the charged particles in the chamber
with this, the particles exist between an opposing electric field originating from the bottom face (i.e. the braking field), and an opposing field originating from the top face, which controls their velocity and position even more finely, and they are then suspended using standing waves

### 09A. Alternative Particle Suspension System

suspends the particles at their designated positions
standing waves are horizontally aligned i.e. travel side to side, assuming drop ejection from top and drop collection at bottom
one standing wave on every alternate plane and every alternate column, nominal antinode height=height of 1 plane, nominal width=width of 1 column
the nodes, antinodes and interstices between nodes of the alternating standing waves form a grid of low and high pressure pockets
the standing wave grid keeps the particles suspended; one plane of particles inside the antinodes, next plane inside the interstices between antinodes of two adjacent standing waves, and so on
one ultrasonic transducer array for creating standing wave grid within the chamber, mounted on one vertical face of the display chamber
ultrasonic waves reflected from opposite vertical face
activated when the particles are at or near their designated positions, and are slowed by braking
de-activated after particle suspension interval to allow purging of particles
in the embodiment that uses this particle suspension system, the display has only three sides open
see FIG. 47/50

### 10. Drop Purge and Recirculation System

mounted on one face of the display chamber, opposite to the drop ejection assembly; in this description, mounting at bottom face is assumed
purges the drop medium from the chamber by employing electrostatic fields, air pressure or vacuum, or any combination of these
returns the drop medium to the tank (item #4) for re-use
in case the drop medium is a composite phosphor or quantum dot, breaks it down and segregates the individual phosphor/quantum dot material before returning to the tank/compartments in the tank
in case drop medium is a smart nano-structure, erases the existing program for emitting light of a specified color and intensity, and recharges the power supply, if any, before returning the material to the tank/compartments in the tank
see FIG. 11/50

Note: the electrostatic fields used in the particle speeding, guidance, braking, suspension and purging systems may be an integrated system that is controlled at different times to perform different functions

### 11. 3d Surface Light Projection System

a) provides white light illumination that is required when the selected drop medium forms 3d surfaces in monochrome or full color (items #3a, 3c, 3d in the item list)
   one or more white light projectors, arranged in one or more directions, in or around the display chamber, above and/or below the planes of view, that in combination achieve requisite illumination of the 3d scene with minimum appearance of unwanted shadows in the display chamber
b) provides 3-d mapped surface projection in full color that is required when the selected drop medium forms 3d material surfaces for displaying a projected scene by reflection, within the display chamber (item #3b)
   one or more projectors, arranged in one or more directions, in or around the display chamber, above and/or below the plane of view, that in combination achieve 3-d surface projection of a scene into the display chamber, and
   illuminate the 3d surfaces in the chamber in a manner consistent with the illumination information in the 3d scene signal received by the apparatus, with minimum appearance of unwanted shadows in the display chamber
   the term “projector” is used in a generic sense and may consist of high resolution SLM (spatial light modulator), collimated image beams, arrays of discrete light or laser source, high resolution DLP (digital light projector), etc. or any combination of these
   stationary or moving projection device

### 12. 3d Surface Phosphor/Nano-Structure Stimulation System

required when the selected drop medium consists of phosphors/nano-structures that form self-luminescent 3d material surfaces in the chamber, and emit light when excited or stimulated by radiation or other wireless means, for displaying a 3d scene within the display chamber (items #3e, 3f)
one or more excitation or stimulation emitting devices (e.g. radiation emitting devices), arranged in one or more directions, in or around the display chamber, above and/or below the plane of view, that in combination achieve excitation or stimulation of the self-luminescent 3d surface by emitting into the display chamber

### 13. 3d Surface ‘Smart’ Nano-Structure Signaling System

required when the selected drop medium consists of smart nano-structures that form self-luminescent 3d material surfaces and emit light when stimulated or signaled by wireless means, for displaying a 3d scene within the display chamber (item #3g)
one or more stimulation/signal emitting devices, arranged in one or more directions, in or around the display chamber, above and/or below the plane of view, that in combination achieve stimulation/signaling of the self-luminescent 3d surface by emitting stimulation/signals into the display chamber

Where suitable, an embodiment may have illumination achieved by any combination of items #11, 12, 13.

### 14. Digital Control System or Software/Computer System for Controlling the Drop Ejection System and Particle Guidance, Speeding, Braking, Suspension and Purging Systems

a digital control system, or alternatively software or instructions in any form executed on a computer system, that transforms the input 3d scene signal into
a) control signals for the drop-ejection assembly (item #2)
   for timing the ejection of each drop from the individual micro-nozzles
   and for controlling the ejection velocity of each drop, and its electric charge, so as to create 3d surfaces consisting of drops, in the display chamber
   these 3d surfaces correspond to the required 3d scene conveyed by the 3d scene signal
b) control signals for the particle speeding, guidance, braking, suspension and purging systems (items #6, 7, 8, 9 and 10)
   for controlling the velocity and position of the ejected drops as they travel down the display chamber,
   for suspending the ejected particles at their designated positions in the display chamber, so that they form 3d surfaces corresponding to the required 3d scene conveyed by the 3d scene signal,
   and for removing the particles from the display chamber as and when required

### 15. Digital Control System or Software/Computer System for The Light Projectors and Color Mixers

a) in the embodiment where the selected drop medium forms 3d surfaces monochromatic or full color that are illuminated by white light
   a digital control system, or alternatively software or instructions in any form executed on a computer system, that transforms the input 3d scene signal into
   control signals to control the timing of the projection of white light from white light projectors (item #11a) to match the suspension interval in which the drops form the complete 3d surface in the display chamber, and
   control signals to control the projected white light by collimation, focus, intensity regulation etc.
   in the embodiment where the selected drop medium consists of each particle being coated at the point of ejection, i.e. on the fly, by a material having a color mix corresponding to the color and brightness required at the position designated for that particle in the chamber (item #3c), or
   in the embodiment where the selected drop medium consists of different colors being mixed at the point of ejection, i.e. on the fly, to form a particle having the color and shade corresponding to the color and brightness required at the position designated for that particle in the chamber (item #3d),
   the control system issues signals to the color mixers (items #5a, 5b) in the drop ejection assembly for mixing the color required
   after mixing, the color may be used to coat a uniform particle before ejection, or to constitute a particle that is ejected (items #5a, 5b)
b) in the embodiment where the selected drop medium forms reflective 3-d surfaces within the display chamber for displaying a 3-d scene projected in full color by 3-d surface projection mapping (item #3b)
   a digital control system, or alternatively software or instructions in any form executed on a computer system, that transforms the input 3d scene signal into
   video signals for the light projectors (item #11b),
   one or more video signals, as required, for one or more light projectors as used, with
   the video signals individually tailored to the light projectors, according to their number, position and direction, and
   control signals to time the projection to match the suspension interval in which the drops form the complete 3d surface in the display chamber

### 16. Digital Control System or Software/Computer System for the Phosphor/Quantum Dot Mixers and Stimulation System

required when the selected drop medium consists of free moving, unbound phosphors or quantum dots, which are ejected into the display chamber and stimulated to emit visible light of different colors and intensity (items #3e, 3f)
transforms the input 3d scene signal into control signals for the phosphor mixers/quantum dot mixers that are associated with the micro-nozzles (items #5c, 5d)
produces individually tailored phosphors/quantum dots that emit visible light of the requisite color and intensity corresponding to their designated positions in the 3d scene
issue signals to trigger the phosphor/quantum dot stimulation system (item #12), during the suspension interval in which the drops form the complete 3d surface in the display chamber, to produce self-luminescent 3d surfaces corresponding to the required 3d scene conveyed by the 3d scene signal

### 17. Digital Control System or Software/Computer System for the Nano-Structure Coding and Signaling System

required when the selected drop medium consists of programmable nano-structures, which are ejected into the display chamber and signaled to emit visible light of different colors and intensity (item #3g)
transforms the input 3d scene signal into control signals for the program (or code) transmitters associated with the micro-nozzles (item #5e)
to individually program the nano-structures to emit visible light of the requisite color and intensity corresponding to their designated positions in the 3d scene, and
issues signals to trigger the nano-structure stimulation/signaling system (item #13), during the suspension interval in which the drops form the complete 3d surface in the display chamber, to produce self-luminescent 3d surfaces corresponding to required 3d scene conveyed by the 3d scene signal

### 18. Interface Between Digital Control System (Item #14) and the Drop Ejection Assembly (Item #2)

a piezo, or electro-mechanical, or electro-pneumatic, or electro-hydraulic actuation system that takes the control signals from the digital control system (item # 14) and opens/closes the individual micro-nozzles in the drop ejection assembly accordingly
in general, any actuation system operated by electrical, optical or other impulses that opens/closes the individual micro-nozzles in the drop ejection assembly according to control signals from the digital control system (item #14)

### 19. Interface Between Digital Control System (Item #15) and the Light Projectors (Item #11)

an electrical or optical or electro-optical or wireless system that takes the control signals from the digital control system for the light projectors and regulates the light projector emission accordingly
projectors emit the illumination during the suspension interval in which the drops form the complete 3d surface in the display chamber, to produce the required 3d scene conveyed by the 3d scene signal

### 20. Interface Between Digital Control System (Item #16) and the Phosphor/Quantum Dot Stimulation System (Item #12)

an electrical or optical or electro-optical or wireless system that takes the control signals from the digital control system for the phosphor/quantum dot stimulation system and regulates the emission from the phosphor/quantum dot stimulation system accordingly
phosphor/quantum dot stimulation system emits the stimulation during the suspension interval in which the phosphor drops form the complete 3d surface in the display chamber, to produce the required 3d scene conveyed by the 3d scene signal

### 21. Interface Between Digital Control System (Item #17) and the Nano-Structure Signaling System (Item #13)

an electrical or optical or electro-optical or wireless system that takes the control signals from the digital control system for the nano-structure signaling (or stimulation) system and regulates the signal from the nano-structure signaling system accordingly
nano-structure signaling (or stimulation) system emits the signals during the suspension interval in which the phosphor drops form the complete 3d surface in the display chamber, to produce the required 3d scene conveyed by the 3d scene signal

A system block diagram comprised of the items described above is given in FIG. 50/50

Assumed items—

### 1. 3d Scene Signal, Input To The Digital Control Systems (Items #14 Thru 17)

3D display is only one of the elements in the entire chain of the 3D imaging process, which includes 3D image data acquisition, processing, transmission, storage, receiving or retrieving 3-d data, processing, and display.
In this disclosure it is assumed that 3D information is available for the device to process and display 3D scenes, including upstream 3D image acquisition, processing and transmission/storage of 3D signals.
As with existing 2d displays, the disclosed 3d display is envisaged to receive the 3d scene information by means of a signal or signals. It is assumed that a standardized 3d scene signal specification exists or will exist, which is used to bring 3d scene information to the disclosed display device.
As with existing 2d image information, the 3d scene information may be stored in any media, and a ‘player’ device reads this information and generates corresponding 3d scene signals. Alternatively, 3d scene information may be streamed live, as in the case of sports broadcasts and computer displays, in which case the receiving side converts the streamed signals and generates corresponding 3d scene signals. In all cases, the disclosed 3d display device receives standardized 3d scene signals, much as existing 2d display devices receive standardized 2d image signals (e.g. HDMI) from different sources
There already exist range imaging cameras such as LiDar systems that achieve full spatial awareness. Such a camera can sense the time that it takes light to return from any surrounding objects, combines it with video data and generates real time 3D scene information, which can be recorded or transmitted
The 3d scene signal input is assumed to include audio signal tracks associated with the 3d scene

### 2. Audio Playback System

For playing audio tracks associated with the displayed 3d scene. It is assumed that the disclosed device has an audio system capable of playing the audio content associated with the displayed 3-d scene
the audio content is conveyed by the 3-d scene signal that is input to the system
   3. A Data Input Device, a Pointing Device and/or any User Interface
For situations in which the disclosed apparatus is deployed as a display device for a computer system, as part of Human Machine Interface, or
Any situation in which the disclosed device is interactive and responds to signals from a user, by whatever means they are conveyed
4. An Apparatus or Arrangements for Containing or Counteracting any Harmful or Unwanted Emissions or Discharge that may be Cast Into the Surroundings by the Disclosed Apparatus in the Process of its Working
5. IV. Alternative Particle Positioning System

In one embodiment, the disclosed invention uses the system described below to position the ejected particles at their designated points in the display chamber. This system is an alternative to the particle speeding, guidance, braking, suspension and purging systems described above in part III (#6, 7, 8, 9 and 10 in the item list).

The system may be identified as a “Moving Node Standing Wave System” or “Standing Wave Archimedean Screw System”.

A “moving node” standing wave is a standing wave in which the nodes (and anti-nodes) move along the axis of the wave. It is achieved by forming a full standing wave between two active transducers, having same frequency and amplitude, and to begin with, same phase. Vertical orientation of the standing wave is assumed.

The full standing wave formed between the two transducers has the usual nodes and anti-nodes. When the phase of one (or both transducers) is varied such that they are out of phase by 90 degrees, the nodes and anti-nodes of the standing wave are shifted vertically by a distance corresponding to 90 degrees of the wavelength, i.e. (90/360) or ¼^{th} of the wavelength. Therefore a particle suspended inside any anti-node of the standing wave is carried vertically by ¼^{th} of the wavelength.

As the phase difference is increased to 180, 270 and 360 degrees, the nodes move vertically by distance corresponding to 180, 270 and 360 degrees, and thereby the particle is carried vertically by ½, ¾^{th} and 1-full of the wavelength.

When the phase difference is increased beyond 360 degrees, i.e. further increased in the same direction, the nodes continue to move vertically in the same direction, in proportion to the increased phase difference. By continuously varying the phase difference in the same direction, the particle can be carried up or down the standing wave to any extent required.

This phenomenon was reported in [25], and it is applied in the disclosed invention by arranging a plurality of controlled moving-node standing waves to position a plurality of particles at specified locations in a chamber. The process is described at #11 in part V, “Process-Wise Description of the Working of the Disclosed Apparatus”.

Analysis of the reported moving node phenomenon shows that the amplitude of the standing wave does not remain constant but varies over the phase difference cycle from 0 to 360 degrees. Whereas the amplitude is at the normal level at 0 and 360 degree phase difference, it is lower than normal at all other points. The amplitude minimum occurs at 180 degrees phase difference.

The reduction in amplitude brings about a reduction in suspension force on the particle suspended in the anti-node. If the reduced suspension force is not sufficient to overcome gravitational attraction on the particle, the process of carrying/positioning the particles is disrupted. To compensate for the reduced standing wave amplitude, the amplitude of the two ultrasonic transducers is increased in a controlled fashion, throughout the 0 to 180 degree phase shift, to boost the standing wave amplitude to a level sufficient to carry/suspend the particle. When the amplitude of the standing wave starts increasing back towards normal, during the 180 to 360 degree phase shift, the amplitude of the two ultrasonic transducers is decreased in a controlled fashion, throughout the 180 to 360 degree phase shift, to keep the standing wave amplitude within the normal level.

The moving node standing wave is illustrated in FIG. 46/50

The positioning of particles at designated locations in the display chamber is achieved by providing ultrasonic transducer arrays at the top face and bottom face of the display chamber, such that a standing wave of specified frequency and wavelength is established in the vertical direction at every micro-nozzle in the drop ejection assembly. Each micro-nozzle ejects particles into the top-most layer of anti-nodes. The nodes are moved downwards by phase variation, and thereby the particles also move down. The new layers anti-nodes formed successively at the top-most level are populated with particles as required by the 3-d scene to be displayed.

The whole ensemble of particles is carried downwards as it is constructed, and by the time the first plane of particles reaches the bottom, the last plane of particles is populated at the top, and the required 3-d profile is complete.

The vertical movement of the nodes is now stopped, by holding the phase difference between the two transducer arrays constant, and the particles become suspended in place. The 3-d objects and surfaces formed by the particles may be illuminated and given for exhibition.

Purging of particles is achieved by resuming the vertical movement of the nodes. The particles of the next shower are ejected into the new anti-nodes as they arise. At the same time, the particles of the previous shower are withdrawn from the bottom of the display chamber, as they arrive plane by plane. By the time the profile of the next shower is complete in the chamber, all the particles of the previous shower are removed from the chamber.

In this method of positioning the particles in the chamber, the particles are not imparted with any electric charge when ejected, and no electric fields are required in the chamber to control the movement and position of the particles. This simplifies the design and working of the disclosed apparatus.

Accordingly, the control system item #14 in the item list controls the movement and positioning of the particles by controlling the phase shift and intensity of the two ultrasonic transducer arrays. However, all other members in the list of items are required according to the different embodiments possible, including (but not limited to), item # 1 thru 5, and 11 thru 21.

### V. Numerical Considerations

### 1. Display Resolution (Assuming 9:16:16 Aspect Ratio)

to attain HD resolution of 1080 horizontal planes, an array of 1920×1920 micro-nozzles is required in the drop ejection assembly; this is about 3.7 million micro-nozzles
to attain HD resolution of 720 horizontal planes, an array of 1280×1280 micro-nozzles is required in the drop ejection assembly; this is about 1.6 million nozzles
to attain SD resolution of 525 horizontal planes, an array of 933×933 micro-nozzles is required in the drop ejection assembly; this is about 0.87 million nozzles
Assuming an embodiment of the disclosed device having display faces of dimensions 9×16 in, a single row in the drop ejection assembly requires 1920 micro-nozzles to occupy 16 inches. The required micro-nozzle density is thus 1920/16 per inch =120 per inch
For comparison, the commercially available HP 841 PageWide XL Printhead is 5.08 inches in length and has 1200 nozzles per inch and per color (4 colors
   cyan, magenta, yellow, black).
The density of micro-nozzles in the above is one magnitude higher in order than the density required for the disclosed apparatus
A large working inkjet print head having a 2-dimensional nozzle array of 120 mm×120 mm area having 396 nozzles per inch has been reported in [26].
Again the density of micro-nozzles reported in the above is much higher than the density required for high definition display
With the 2-d array density reported above, an embodiment of the disclosed apparatus of the dimensions 3×5.33 in of the display faces may be constructed, which provides HD resolution of 1080 planes
Noting that 2-d displays in wide use today are about 17″ diagonal in size (computer monitors) or larger, the useful size of the display faces of an embodiment of the disclosed apparatus may be larger than 9×16 in, which requires a lower density of micro-nozzles in the drop ejection array

### 2. Standing Wave System

a) In one embodiment of the disclosed device, suspension of the particles at their designated positions in the chamber is achieved by establishing a grid of standing waves that extend horizontally in the chamber
   An array of ultrasonic point sources is fitted on one side of the display chamber that emits a grid of sound waves into the chamber
   The sound waves are reflected from the opposite face of the chamber to form a grid of standing waves in the chamber. See FIG. 47
   There is one standing wave for every alternate plane and every alternate slice, and one plane (or slice) has standing waves at even numbered points in the row, whereas the next plane (or slice) has standing waves at odd numbered points in the row; thereby the interstitial spaces between the standing waves form suspension layers of their own
   For a display chamber of display face dimensions 18 in×32 in and a resolution of 720 planes, there are 40 designated positions per inch and therefore 20 ultrasound point sources per inch
   For the above embodiment, the voxel size is 18 in/720 =0.635 mm per side, and this is the upper limit of the particle size
   The standing wave anti-node size needs to be at least equal to the particle size, which is 0.635 mm
   As the anti-node size is half the wavelength size in a standing wave, the required wavelength=2×anti-node size=2×0.635 mm =1.27 mm
   The speed of sound in Xenon gas is 178 m/s and so the frequency of sound for a wavelength of 1.27 mm is 178 m/s/1.27 mm=140 kHz approx. This is well within the capability of commercially available ultrasound transducers. See [27].
   At a sound velocity of 178 m/s, the time taken to establish standing waves in the horizontal direction in an embodiment having display face dimensions of 18 in×32 in, is about 9 ms
   As all the standing waves need be of the same frequency and wavelength, more than one ultrasound point sources in the grid may be driven by a single transducer, which reduces the number of active transducers required
b) In one embodiment of the disclosed device, suspension of the particles at their designated positions in the chamber is achieved by establishing a grid of standing waves that extend vertically in the chamber
   The wavelength and frequency parameters remain the same as in the case of horizontal orientation i.e. 1.27 mm at 140 kHz approx. in Xenon gas
   At a sound velocity of 178 m/s, the time taken to establish standing waves in the vertical direction in an embodiment having display face dimensions of 18 in×32 in, is about 5 ms if one array of ultrasonic transducers is used, and about 2.5 ms if two arrays of ultrasonic transducers are used
   Vertical orientation of the standing waves allows them to be used as guides for the ejected particles when they are moving down through the chamber, by converting the standing waves to partial standing waves that have “peapod” pattern
   Vertical orientation of the standing waves requires one standing wave for every ejection point to achieve particle suspension
   Establishing partial waves in the display chamber requires an array of ultrasonic point sources both at the top and bottom faces of the chamber, because unequal amplitudes are required for the mutual opposing waves
   The ultrasonic point sources at the top face are integrated with the drop ejection assembly
   The ultrasonic point sources at the bottom face are integrated with the drop purging mechanism
c) In one embodiment of the disclosed device, the positioning and suspension of the particles at their designated positions in the chamber is achieved by establishing a grid of “moving node” standing waves that extend vertically in the chamber
   at a sound velocity of 178 m/s, the time taken to establish standing waves in the vertical direction in an embodiment having display face dimensions of 18 in×32 in, is about 2.5 ms, given that two arrays of ultrasonic transducers are used in this embodiment
   once established, the standing waves exist in the chamber indefinitely, whether the nodes be moving or stationary, shower after shower
   the speed of sound in the medium sets a limit to the speed of vertical movement of the nodes, because the nodes cannot move faster than the speed of each change of phase through the medium
   assuming that every 360 degrees change of phase requires 2.5 ms to propagate through the medium, the time taken by the nodes to move vertically down the chamber by one wavelength is 2.5 ms
   a resolution of 720p requires 720 anti-nodes in the vertical direction in the chamber, and there are two anti-nodes per wavelength, so the number of wavelengths required in the vertical direction is 360
   at 2.5 ms per wavelength, it takes 360×2.5 ms=900 ms for one anti-node to move from top to bottom of the display chamber

### 3. Display Refresh Rate

In one embodiment of the disclosed device, the sequence of particle ejection, acceleration, braking, suspension, illumination and purging is repeated with sufficient rapidity to exhibit moving objects to viewers by persistence of vision.
For a display refresh rate of 30 Hz, a time period of 1/30=33.33 ms is available for one round of particle ejection, acceleration, braking, suspension, illumination and purging
Out of the 33.33 ms, a minimum of 20 ms is required for the suspension-illumination interval, to ensure an adequate level of illumination using moderately powered light projectors (or excitation/radiation sources in the case of self-luminescent particles)
As purging and particle acceleration require the same polarity of electrostatic field in the chamber, particle ejection of the next round may begin almost simultaneously with purging of the previous round, after a nominal gap of say 1.33 ms
The remaining 12 ms is available to complete particle acceleration, braking and suspension start
As there is overlapping in the three processes, 10 ms may be considered taken by the first plane of ejected particles to reach the bottom face of the display, where they are suspended for exhibition. Therefore particle acceleration and braking phases take 10 ms together. (Purging of the previous round of particles is completed in the same time period.)
The partial standing waves having pea-pod pattern are converted to full standing waves in about 2.5 ms if using two arrays of ultrasonic transducers, and about 5 ms if using a single array, this being the time taken for sound to propagate in the medium
For display face (vertical face) dimensions of 18 in×32 in, the average speed of the first plane of particles is 18 in/10 ms=44 m/s approx
This is within the ejection speed capability of existing high-end inkjet printers, enhanced by acceleration due to the electrostatic field in the disclosed device
Each micro-nozzle in the drop ejection assembly is required to eject up to 720 particles in 10 ms. Therefore the ejection frequency required of the micro-nozzles is (1000/10)×720=72 kHz.
This is within the ejection frequency capability of existing high-end inkjet printers.

### VI. Process-Wise Description of the Working of the Disclosed Apparatus

The disclosed apparatus works as a 3-d display device by
A. Constructing material three dimensional objects and surfaces, which are essentially temporary (‘soft’), by assembling unit particles in an enclosed working space containing a fluid
B. Pre-treating the unit particles before assembling them, to enable them to exhibit or emit colors, for meeting the color and luminance reproduction requirements of the display
C. Illuminating or exciting the assembled particles after the construction of the 3-d objects and surfaces is complete, to meet the color and luminance reproduction requirements of the display
D. Removing the particles from the display chamber after exhibition
E. Post-treating the particles to make them or their constituents available for use again
F. Repeating the particle pre-treatment, 3-d object and surface formation, illumination, and particle removal with sufficient rapidity that, by persistence of vision, three dimensional action scenes appear in the display chamber to viewers.

### A.

The methods of constructing material three dimensional objects and surfaces, which are essentially temporary (‘soft’), in an enclosed working space containing a fluid, are described in the following sections. The size of the three dimensional objects and surfaces to be constructed may be scaled down or scaled up, in comparison to the originals that they represent, so as to exhibit them completely within the display chamber, or to use the display chamber completely to exhibit them.

### Method I

### Step 1:

Defining the three dimensional working space to consist of ‘z’ horizontal planes, where ‘z’ is any integer number, with each plane identified by a serial number in increasing order from bottom to top
Defining each plane to consist of ‘x’ lines in the horizontal x-direction, and ‘y’ lines in the horizontal y-direction, whereby a plurality of slots numbering ‘x’ times ‘y’ is defined on each plane
Defining the slots in the same x-y positions in all the planes to constitute a working column, whereby a plurality of working columns numbering ‘x’ times ‘y’ is defined in the working space

### Step 2:

Processing an input signal, that is assumed to be available, and that conveys information about the three dimensional objects and surfaces to be constructed, to determine for each slot in each plane, whether an object or surface, or part thereof, occurs in it

Step 3:
Arranging the availability and supply of material particles, howsoever composed, having dimensions commensurate with the thickness of a plane and the sides of a slot, to serve as elements for constructing the required three dimensional objects and surfaces

Step 4:
Designating one material particle to populate one slot in a plane, according to the occurrence of objects and surfaces, or parts thereof, in that slot (as determined in step 2 above)
Leaving empty those slots where objects and surfaces, or parts thereof, do not occur; and also leaving empty those slots in the plane that are fully enclosed by surfaces when all the requisite objects and surfaces have been formed, and thereby have no visibility in the working space
Likewise designating particles to populate every plane of the working space according to the occurrence of objects and surfaces, or parts thereof, in its slots
From the designated distribution of particles in all the planes, determining a sequence of particles and gaps for each working column in the working space

### Step 5:

Arranging the availability and supply of material particles, and/or materials to form or treat particles, in and from a designated tank
To designated particle preparation facilities, as required
And then to a designated drop ejection array

### Step 6:

Systematically introducing a plurality of particles into the working columns of working space, which is devoid of any particles to begin with, to form three dimensional objects and surfaces plane by plane; the particles may be introduced using any ejection technology; for example, micro-nozzles, micro-channels, polymer pens.

### Step 7:

Controlling the time-instant of the ejection of each individual particle and/or the velocity at ejection of each individual particle, for the purpose of positioning the particles at their designated slots in the display space

### Step 8:

Controlling the motion of the plurality of particles for the purpose of positioning them at their designated slots, using electrostatic fields and static electric charge, whether existing on the particles and/or other parts of the apparatus, and whether fixed or variable/controllable in magnitude and direction

### Step 9:

Establishing a plurality of acoustic partial standing waves in the fluid of the working space, and using them as chutes to guide the motion of particles to their designated slots, and to counteract the undesired effects of any forces on the desired motion of the particles, whether of the apparatus or outside

### Step 10:

Suspending the particles at their designated slots in the working space for variable and controllable time periods, by converting the partial standing waves serving as chutes to full standing waves having well-defined nodes and anti-nodes, and the requisite sound pressure to support the particles against gravity

### Step 11:

Systematically removing particles from the working space, using electrostatic fields and static electric charge, whether existing on the particles and/or other parts of the apparatus, and whether fixed or variable/controllable in magnitude and direction, so as to allow introduction of a new lot of particles for constructing a different set of objects and surfaces

### Method II

### Steps 1-6 as in Method I.

### Step 7:

Establishing a “Moving Node Standing Wave System” in the working space, as described in part IV above, with one full standing wave at each micro-nozzle of the drop ejection assembly, having downward motion of the nodes and anti-nodes

### Step 8:

Ejecting a particle from each micro-nozzle into the first anti-node of the standing wave under it, or to hold off ejection, as required by the 3-d scene to be constructed. All the particles of one plane are ejected simultaneously, and thereby the first layer of anti-nodes of the standing wave grid is populated with the particles of the first plane of the 3-d scene.
Varying the phase of one or both the arrays of the transducers provided at the top and bottom faces of the display chamber, such that the first anti-node of the standing wave shifts downwards by half a wavelength, carrying the contained particle with it, and at the same time forming a new anti-node is formed under each micro-nozzle.
Ejecting simultaneously all the particles of the second plane from the micro-nozzles into the new layer of anti-nodes.
Continuing the process of varying the phase and ejecting particles into newly formed anti-nodes of the standing wave repeatedly, till all the planes of the working space are populated with particles. At the end, the first layer of antinodes to be populated reaches the bottom layer of the display containing the particles of the first plane, and the second layer of anti-nodes to be populated reaches the bottom-plus-one layer of the display, and so on, such that the last layer of anti-nodes to be populated is at the very top and forms the last plane of the working space.

### Step 9:

Stopping the downward movement of the nodes of the standing wave when the shower is complete,
The anti-nodes of the standing waves are now populated with particles at all the positions as required by the input 3-d signal.
The particles now form the requisite 3-d objects and surfaces in the working space

### Step 10:

Suspending the particles at their designated slots in the working space for variable and controllable time periods, for the duration required by the application, by maintaining the standing waves with stationary nodes

### Step 11:

Resuming the vertical movement of the nodes of the standing waves, to begin the next shower
The particles of the next shower are ejected into the new anti-nodes as they arise.
At the same time, the particles of the previous shower are withdrawn from the bottom of the working space, where they arrive plane by plane. By the time the profile of the next shower is complete in the chamber, all the particles of the previous shower are removed from the chamber.

### B.

The methods of pre-treating the unit particles to enable them to exhibit or emit colors, are described in the following sections. The color and luminance information is obtained by processing the input signal, that is assumed to be available, that conveys information about the three dimensional objects and surfaces to be displayed, and determining for each slot in each plane, the color and/or the brightness and contrast to be exhibited there.

### Method I (for Monochrome Display)

### Step 1:

Using uniform monochromatic particles, without any pre-treatment, to form the 3-d objects and surfaces

### Method II

### Step 1:

Using uniform monochromatic particles, suitable for reflecting light, to form the 3-d objects and surfaces

### Method III

Using the particle preparation facilities of part ‘A’, step 6 in the following manner:

### Step 1:

Arranging the availability and supply of primary color materials, howsoever composed, and an aqueous or non-aqueous solvent or suspension fluid, to color mixers provided for every micro-nozzle in the drop ejection array

### Step 2:

Mixing primary colors and solvent/suspension fluid on the fly to produce for each populated slot in each plane, a composite color, in suspension or in a solution, that exhibits light of the color and intensity required at that slot when illuminated
the relative proportions of the primary colors in the solution or suspension determine the color, and the density of the color mix in the solvent or suspension fluid determines the shade (brightness)

### Step 3:

Arranging to draw uniform particles from the drop medium tank, and passing them to or near the color mixers so as to coat each particle with the composite color produced in step 2

### Step 4:

Providing the particles thus prepared to the drop ejection array for introducing into the display chamber

### Method IV

Using the particle preparation facilities of part ‘A’, step 6 in the following manner:

### Step 1:

Arranging the availability and supply of primary color materials, howsoever composed, and an aqueous or non-aqueous solvent or suspension fluid, to color mixers provided for every micro-nozzle in the drop ejection array

### Step 2:

Mixing primary colors and solvent/suspension fluid or binder, on the fly, to produce for each populated slot in each plane, a drop or particle of a composite color, that is a liquid, emulsion or solid, and exhibits light of the color and intensity required at that slot when illuminated
the relative proportions of the primary colors in the solution or suspension determine the color, and the density of the color mix in the solvent or suspension fluid determines the shade (brightness)

### Step 3:

Providing the particles thus prepared to the drop ejection array for introducing into the display chamber

### Method V

Using the particle preparation facilities of part ‘A’, step 6 in the following manner:

### Step 1:

Arranging the availability and supply of phosphors of primary colors (e.g. red, green and blue), and an aqueous or non-aqueous solvent or suspension fluid, to phosphor mixers provided for every micro-nozzle in the drop ejection array

### Step 2:

Mixing phosphors of primary colors and any additive on the fly to obtain for each populated slot in each plane, a composite phosphor drop, that is a liquid, emulsion or solid, that emits light of the color and intensity required at that slot when excited
the relative proportions of the primary color phosphors determine the color, and the density of the color mix in the solvent or suspension fluid determines the shade (brightness)

### Step 3:

Arranging to draw uniform particles from the drop medium tank, and passing them to or near the phosphor mixers so as to coat each particle with a composite phosphor material of a particular color and shade

### Step 4:

Providing the particles thus prepared to the drop ejection array for introducing into the display chamber

### Method VI

Using the particle preparation facilities of part ‘A’, step 6 in the following manner:

### Step 1:

Arranging the availability and supply of phosphors of primary colors (e.g. red, green and blue), and an aqueous or non-aqueous binder fluid, to phosphor mixers provided for every micro-nozzle in the drop ejection array

### Step 2:

Mixing phosphors of primary colors and any binder on the fly to obtain for each populated slot in each plane, a composite phosphor drop or particle, that is a liquid, emulsion or solid, that emits light of the color and intensity required at that slot when excited
the relative proportions of the primary color phosphors determine the color, and the density of the color mix in the drop or particle determines the shade (brightness)

### Step 3:

Providing the composite phosphor particles thus prepared to the drop ejection array for introducing into the display chamber

### Method VII

Using the particle preparation facilities of part ‘A’, step 6 in the following manner:

### Step 1:

Arranging the availability and supply of quantum dots of primary colors, and an aqueous or non-aqueous suspension fluid, to quantum dot mixers provided for every micro-nozzle in the drop ejection array

### Step 2:

Mixing quantum dots of primary colors and any suspension fluid on the fly to obtain for each populated slot in each plane, a composite quantum dot drop, that is a liquid, emulsion or solid, that emits light of the color and intensity required at that slot when excited
the relative proportions of the primary color quantum dots determine the color, and the density of the quantum dots mix in the drop determines the shade (brightness)

### Step 3:

Arranging to draw uniform particles from the drop medium tank, and passing them to or near the quantum dot mixers so as to coat each particle with a composite quantum dot material of a particular color and shade

### Step 4:

Providing the particles thus prepared to the drop ejection array for introducing into the display chamber

### Method VIII

Using the particle preparation facilities of part ‘A’, step 6 in the following manner:

### Step 1:

Arranging the availability and supply of quantum dots of primary colors, and an aqueous or non-aqueous binder fluid, to color mixers provided for every micro-nozzle in the drop ejection array

### Step 2:

Mixing quantum dots of primary colors and any binder on the fly to obtain for each populated slot in each plane, a composite quantum dot drop or particle, that is a liquid, emulsion or solid, that emits light of the color and intensity required at that slot when excited
the relative proportions of the primary color quantum dots determine the color, and the density of the quantum dot mix in the drop or particle determine the shade (brightness)

### Step 3:

Providing the composite quantum dot particles thus prepared to the drop ejection array for introducing into the display chamber

### Method IX

Using the particle preparation facilities of part ‘A’, step 6 in the following manner:

### Step 1:

Arranging the availability and supply of smart nano-structures, described below, to programming devices provided for every micro-nozzle in the drop ejection array
The smart nano-structure described here is an object having a size corresponding to the particle size defined for the display, and containing (i) phosphors or quantum dots of primary colors in equal quantities, (ii) a program register for containing a code (i.e. binary string), (iii) an apparatus that, when signaled, excites the different primary colors with internally generated radiations or beams, with different intensities as defined in the code, (iv) using an on-board re-chargeable power source, or power derived from radiations or beams cast into the display chamber from outside, (v) so as to emit light of a specific color and intensity for a specific duration of time

### Step 2:

Programming the smart nano-structures on the fly to obtain for each populated slot in each plane, a particle that is coded to emit light of the color and intensity required at that slot when excited or signaled
The code determines the absolute and relative intensity of excitation of the primary color areas on the surface of the nano-structure, and this determines the color, and the brightness of the light emitted by the smart nano-structure

### Step 3:

Providing the smart nano-structure thus programmed to the drop ejection array for introducing into the display chamber

### C.

The methods of illuminating or exciting the assembled particles to emit light, after the construction of the 3-d objects and surfaces is complete, are described in the following sections. The methods described here correspond one-to-one to the methods of pre-treating the unit particles, described in Section B above.

The color and luminance information is obtained by processing the input signal, that is assumed to be available, that conveys information about the three dimensional objects and surfaces to be displayed, and determining the color and/or the brightness and contrast of the 3-d objects and surfaces to be displayed.

### Method I (for Monochrome Display)

### Step 1:

Illuminating the 3-d objects and surfaces with one or more white light projectors, arranged in one or more directions, in or around the display chamber, above and/or below the plane of view, that in combination achieve adequate illumination of the 3d scene with minimum appearance of unwanted shadows in the display chamber

### OR

Illuminating the 3-d objects and surfaces with 3-d surface mapped white light projection cast into the display chamber from outside, from one or more sources, and controlled such that each particle in the display chamber exhibits the brightness and contrast required of it (i.e. grayscale light projection), for variable and controllable periods of time
Such that the plurality of particles reflecting light of different shades, present the requisite 3-d scene in monochrome in the display chamber to viewers

### Method II (for Color Display over Monochrome Surfaces)

### Step 1:

Illuminating the 3-d objects and surfaces with 3-d mapped surface projection in full color, using one or more projectors, arranged in one or more directions, in or around the display chamber, above and/or below the plane of view, that in combination achieve 3-d surface projection of a scene into the display chamber
and controlled such that 3-d objects and surfaces in the display chamber exhibit the color, brightness and contrast required of them, with minimum appearance of unwanted shadows in the display chamber

### Method III

### Step 1:

Illuminating the display chamber with one or more white light projectors, arranged in one or more directions, in or around the display chamber, above and/or below the plane of view, that in combination achieve adequate illumination of the 3d scene with minimum appearance of unwanted shadows in the display chamber
Such that the color-coated particles constituting the 3-d objects and surfaces exhibit their various colors and intensities to achieve a full color display

### Method IV

### Step 1:

Illuminating the display chamber with one or more white light projectors, arranged in one or more directions, in or around the display chamber, above and/or below the plane of view, that in combination achieve adequate illumination of the 3d scene with minimum appearance of unwanted shadows in the display chamber
Such that the custom-color particles constituting the 3-d objects and surfaces exhibit their various colors and intensities to achieve a full color display

### Method V

### Step 1:

Casting stimulation or excitation into the display chamber using one or more radiation or beam emitting devices, arranged in one or more directions, in or around the display chamber, above and/or below the planes of view, in combination
Such that the phosphor-coated particles constituting the 3-d objects and surfaces emit light their various colors and intensities to achieve a full color display

### Method VI

### Step 1:

Casting stimulation or excitation into the display chamber using one or more radiation or beam emitting devices, arranged in one or more directions, in or around the display chamber, above and/or below the planes of view, in combination
Such that the custom-phosphor particles constituting the 3-d objects and surfaces emit light in their various colors and intensities to achieve a full color display

### Method VII

### Step 1:

Casting stimulation or excitation into the display chamber using one or more radiation or beam emitting devices, arranged in one or more directions, in or around the display chamber, above and/or below the planes of view, in combination
Such that the quantum dot-coated particles constituting the 3-d objects and surfaces emit light in their various colors and intensities to achieve a full color display

### Method VIII

### Step 1:

Casting stimulation or excitation into the display chamber using one or more radiation or beam emitting devices, arranged in one or more directions, in or around the display chamber, above and/or below the planes of view, in combination
Such that the custom quantum dot particles constituting the 3-d objects and surfaces emit light in their various colors and intensities to achieve a full color display

### Method IX

### Step 1:

Casting signals or stimulation into the display chamber, using one or more stimulation/signal emitting devices, arranged in one or more directions, in or around the display chamber, above and/or below the planes of view, in combination
Such that the smart nano-structure particles constituting the 3-d objects and surfaces activated to emit light in their various colors and intensities to achieve a full color display

### D.

The methods of removing the particles from the display chamber, after the exhibition of the 3-d objects and surfaces is complete, are described in the following sections. The methods described here correspond one-to-one to the methods of assembling the unit particles, described in Section A above.

### Method I

### Step 1:

Removing the suspension provided to the assembled particles by ultrasonic standing waves, by de-activating the ultrasonic transducer array(s)

### Step 2:

Activating the electrified plates provided at the bottom and top of the display chamber, either singly or together, to establish an electric field that drives the charged particles towards the bottom of the chamber

### Step 3:

Collecting and channeling the particles arriving at the bottom of the display chamber towards the post-treatment facilities of the disclosed device

### Method II

### Step 1:

Varying the phase of one or both the ultrasonic transducer array(s) at the top and bottom of the display chamber, so that the resulting phase difference between the sources moves the nodes and anti-nodes of the standing waves towards the bottom of the display chamber

### Step 2:

Collecting the particles arriving at the bottom of the display chamber plane by plane, and channeling towards the post-treatment facilities of the disclosed device

### E.

The methods of post-treating the particles to make them or their constituents available for use again, are described in the following sections.

In all the methods, the electric charge on the purged particles is neutralized.

### Method I (Corresponding to Methods I and II in Section B Above)

### Step 1:

Channel the monochrome particles to the drop medium tank for re-use

### Method II (Corresponding to Methods III, V and VII in Section B Above)

### Step 1:

Wash off the coating on the uniform particles

### Step 2

Channel the uncoated particles to the drop medium tank for re-use

### Step 3

Collect the washed off color coating and separate the constituent primary color material (color dyes OR phosphors OR quantum dots)

Step 4

Channel the primary color material to the color supply compartments associated with the color mixers in the drop ejection assembly, for re-use

### Method III (Corresponding to Methods IV, VI and VIII in Section B Above)

### Step 1:

Separate the composite color particles into the constituent primary color material (color dyes OR phosphors OR quantum dots)

### Step 2

Channel the primary color material to the color supply compartments associated with the drop ejection assembly, for re-use

### Method IV (Corresponding to Methods XI in Section B Above)

### Step 1:

Erase the code from the program register in the smart nano-device

### Step 2:

Recharge the on-board power source in the smart nano-device, if any

### Step 3:

Channel the smart nano-devices to the drop medium tank for re-use

### F.

Repeating the particle pre-treatment, 3-d object and surface formation, illumination, and particle removal with sufficient rapidity that, by persistence of vision, three dimensional action scenes appear in the display chamber to viewers.

This process is similar to the displaying of a rapid succession of ‘frames’ in 2-d displays. In the disclosed invention, a rapid succession of ‘showers’ is displayed.

Older 2-d displays constructed in the earlier stages of the art employ the technique of interlacing, to achieve an optimum between constancy of display brightness and smoothness of motion on the one hand, and moderate consumption of transmission bandwidth on the other hand. Interlacing of frames is aided by the persistence of luminosity in excited phosphors for some time after excitation is removed. Owing to the persistence, the phosphors excited in one frame still glow (albeit with less intensity) while the phosphors of the next frame are excited.

In the disclosed invention, interlacing of showers is possible and can be done in three Ways—
(i) in the vertical direction, by ejecting every alternate particle from a micro-nozzle in one shower (say the odd-plane particles), and ejecting the missed particles of the first shower, in the next shower, in their sequence (the even-plane particles)
(ii) in the horizontal x-direction, by ejecting particles from alternate micro-nozzles in the x-direction of the drop ejection array during one shower, and from the interposing alternate micro-nozzles in the x-direction, in the second shower
(iii) in the horizontal y-direction, similar to (ii)

Interlacing by employing any combination of the above is also possible.

However, the absence of permanent phosphors in fixed places that continue to emit light after excitation, in the disclosed invention, means that the aid to interlacing that is available to 2-d displays is not available to it.

A systematic chart of the various embodiments and their features described above is given in FIG. 49/50 for convenient reference.

### VII. Control System-Wise Description of the Working of the Disclosed Apparatus

### 01. Input 3-d Signal Processing

for each shower, the control systems #14, 15, 16 and 17 in the item list decode the incoming 3-d scene signal and
issue signals to the systems comprising the disclosed apparatus to achieve the outcomes as detailed below

### 02. Particle Allocation

the control system #14 in the item list decodes the incoming 3-d scene signal to determine for each shower, which voxels in the display are to be populated by particles and which are to go empty, and
issues signals to each micro-nozzle in the drop ejection assembly, # 2 in the item list, to regulate the sequence of ejection of particles, to achieve the requisite distribution of particles in the display chamber
all voxels that are enclosed by surfaces go empty, even if they fall within what is a solid object in the original scene; thus for example, for constructing a bowling ball, only the outermost layer of voxels is populated with particles, and the interiors go empty or hollow

### 03. Particle Preparation

the control system #15 (in the item list) decodes the incoming 3-d scene signal to determine for each particle the color and intensity required at its designated voxel position, and
issues control signals to each color mixer in the drop ejection assembly, #3c, 3d in the item list, to produce for each particle the color mix having the color and brightness required at its designated voxel in the display
and either coat a uniform particle with the color mix, or form a custom color particle

### OR

the control system item #16 (in the item list) decodes the incoming 3-d scene signal to determine for each particle, the color and intensity required at its designated position, and
issues signals to each phosphor mixer (or quantum dot mixer) in the drop ejection assembly, #3e, 3f in the item list, for forming the composite phosphor (or quantum dot) mix having the color and brightness required at its designated voxel in the display
and either coating a uniform particle with the mix, or forming a custom phosphor (or quantum dot) particle

### OR

the control system item #17 (in the item list) decodes the incoming 3-d scene signal to determine for each particle, the color and intensity required at its designated position, and
issues signals to each programming device in the drop ejection assembly, item #3g in the item list, to program each ‘smart’ nano-structure to emit light of the color and brightness required at its designated voxel in the display, when signaled or stimulated wirelessly

### 04. Particle Charging and Ejection

the control system #14 (in the item list) signals each micro-nozzle in the drop ejection assembly, #2 in the item list, to eject particles (or prepared particles, as the case may be) into the display chamber, according to a sequence given by the input 3-d signals
and to the electrode associated with each micro-nozzle nozzle in the drop ejection assembly, #2 in the item list, to impart to the ejected particle a variable and controlled electric charge according to the designated position of the particle
the ejection of particles from each micro-nozzle is intermittent; that is, between individual particles in the ejection sequence of every micro-nozzle, there may be gaps of variable length, which go to form gaps between objects or surfaces in the constructed 3-d scene
the plurality of particles ejected from all the micro-nozzles, along with the plurality of gaps in the vertical and horizontal directions, constitute the objects and surfaces of the required 3-d scene along with gaps between them

### 05. Particle Guidance

at the beginning of the shower, the control system item #14 (in the item list) signals the ultrasonic transducer arrays at the top and bottom face of the display chamber, #7 in the item list, to emit sound so as to set up at every micro-nozzle in the drop ejection assembly, a partial standing wave having pea-pod pattern, and extending to the bottom face of the display chamber
the particles ejected from the micro-nozzles enter the low-pressure chutes created by the partial standing waves and are guided downwards
the high-pressure walls counteract the mutual electrostatic forces that may arise between the particles, which carry electric charge, and keep the particles on course

### 06. Particle Speeding and Braking

the control system item #14 signals each micro-nozzle in the drop ejection assembly, #2 in the item list, to eject each particle with a velocity given according to its place in the sequence and the distance to its designated position, in the embodiment where particles are produced on the fly by mixing materials of different colors to form a composite particle having specified color and density, the acceleration may be achieved, at least in part, by processes similar to those employed in inkjet printing technologies
the above system may increase the design complexity, size and cost of the control system item #14, as well as the micro-nozzles
at the beginning of the shower, the control system item #14 signals the particle speeding system, #6 in the item list, to produce from an electrified plate mounted at the bottom face, an electrostatic field of given polarity and intensity
for each ejected particle, the control system item #14 signals the associated micro-nozzle to impart to it an electric charge having polarity opposite to the electrified plate at the bottom, and a variable magnitude given according to its place in the sequence and the distance to its designated position
after ejection, the charged particles are accelerated towards the bottom face by electrostatic forces
at some time in the shower interval, the control system item #14 signals an electrified plate mounted at the top face, #6 in the item list, to produce an electrostatic field of given polarity and intensity
this provides additional control over the movement and positioning of the charged particles in the display chamber
in the preferred embodiments, the movement of the particles in the display chamber is controlled by using static electric charge and electrostatic fields
when the particles are at or near their designated positions in the chamber, the control system item #14 signals the particle braking system (#7 in the item list) to produce from electrified plate mounted at the bottom face, an electrostatic field of given intensity, and polarity opposite to the acceleration field
the particles are slowed by the opposing electrostatic field as they come very near and almost to their designated positions
the control system item #14 optionally signals an electrified plate mounted at the top face to produce an electrostatic field of given polarity and intensity
this provides additional control over the braking and positioning of the charged particles in the display chamber

### 07. Particle Suspension

in one embodiment, the control system item #14 issues signals to the ultrasonic transducer arrays at the top and bottom face of the display chamber, #7 in the item list, which up to this juncture together produce a partial standing wave having pea-pod pattern, to convert the partial standing waves to full standing waves (by equalizing the amplitude of sound emitted by the two arrays)
the full standing waves capture the particles at their designated positions, and hold them in place within the low pressure antinodes, surrounded by high pressure walls; thereby the particles become suspended at their designated positions in the display chamber
in this embodiment, there is one partial standing wave for every column of particles
in another embodiment, the control system item #14 issues signals to the electrified plate at the top of the display chamber, to activate an electrostatic field having a direction opposing the suspended particles
with this the charged particles exist between an opposing electric field originating from the bottom face (i.e. the braking field till this juncture), and an opposing electric field originating from the top face, which provides additional control over the positioning of the charged particles in the display chamber
the particles are then suspended using full standing waves as above

### 08. Illumination

the control system item #15 (in the item list) issues signals to activate white light projectors, #11 in the item list, and regulates them to achieve optimal illumination of the 3d scene with minimum appearance of unwanted shadows in the display chamber
in the embodiment having the 3-d objects and surfaces in monochrome, and the display in monochrome

### OR

the control system item #15 in the item list issues signals to activate white light projectors, #11a in the item list, and regulates them to achieve optimal illumination of the full color 3d scene with minimum appearance of unwanted shadows in the display chamber
in the embodiment having the 3-d objects and surfaces in full color

### OR

the control system item #15 in the item list issues signals to activate the 3-d mapped surface projection system, #11b in the item list, and regulates it to achieve optimal illumination of the 3d scene in full color, with minimum appearance of unwanted shadows in the display chamber
in the embodiment having the 3-d objects and surfaces in monochrome, and the display in full color

### OR

the control system item #16 in the item list issues signals to activate the phosphor/quantum dot stimulation system, #12 in the item list, and regulates it to achieve optimal illumination of the 3d scene with minimum appearance of unwanted shadows in the display chamber
in the embodiment having the 3-d objects and surfaces formed by self-luminescent particles (composite phosphors or composite quantum dots), and the display in full color

### OR

the control system item #17 in the item list issues signals to activate the nano-structure signaling system, #13 in the item list, and regulates it to achieve optimal illumination of the 3d scene with minimum appearance of unwanted shadows in the display chamber
in the embodiment having the 3-d objects and surfaces formed by self-luminescent ‘smart’ nano-structures, and the display in full color

### 09. Particle Purging and Re-Circulation

the control system item #14 in the item list issues signals to deactivate the ultrasound transducer array(s), #7 in the item list, or to change the amplitude of one ultrasound array, such that the full standing waves are removed, or converted into partial standing waves
in the embodiment where the particles are suspended by full standing waves,
the control system item #14 in the item list issues signals to change the polarity of the electric field of the electrified plate at the bottom face of the display chamber, #10 in the item list, to attract the charged particles in the display chamber
now the charged particles exist between an attracting electric field originating from the bottom face (i.e. the purging field), and optionally an opposing electric field originating from the top face, and as a result are accelerated towards the bottom face of the display chamber

### 10. Display Refresh

After purging the chamber of particles of one shower, the processes #1 to 7 are repeated for the next shower
The rate of refreshing the display depends on the application
In the embodiment used to display moving 3-d objects/real world action, the refresh rate is 30 per second (though this number is non-limiting)
In this embodiment, the 20 ms suspension interval of one shower gives the control systems of the apparatus 20 ms of time to carry out the particle allocation and particle preparation processes of the next shower
When the purging of the particles of the first shower begins, the ejection of the particles in the next shower also begins, for which the particle allocation and particle preparation processes are already complete

### 11. Alternative “Moving Node” Standing Wave Process Of Positioning Particles at Their Designated Places

If the alternative Moving Node Standing Wave system described in part IV above is used, the following process of positioning the ejected particles replaces the processes #5, 6 and 7 described above.

A full standing wave exists at each micro-nozzle of the drop ejection assembly, and the control system item #14 in the item list signals each micro-nozzle to eject a particle into the first anti-node of the standing wave under it, or to hold off, as required by the 3-d scene to be constructed. All the particles of one plane are ejected simultaneously, and thereby the first layer of anti-nodes of the standing wave grid is populated with the particles of the first plane of the 3-d scene.

Now the phase is varied of one or both the arrays of the transducers provided at the top and bottom faces of the display chamber, such that the first anti-node of the standing wave shifts downwards by half a wavelength, carrying the contained particle with it. At the same time a new anti-node is formed under each micro-nozzle. The control system item #14 in the item list signals the micro-nozzles to eject simultaneously the second plane of particles into the new layer of anti-nodes. When the downward movement of the first anti-node is complete, the formation of the new anti-node is complete, and the second plane of particles is suspended in it, above the first plane.

The process is repeated till all the planes of the display are populated with particles. At the end, the first layer of antinodes to be populated reaches the bottom layer of the display containing the particles of the first plane, and the second layer of anti-nodes to be populated reaches the bottom-plus-one layer of the display, and so on, such that the last layer of anti-nodes to be populated is at the very top and forms the last plane of the display.

The shower is now complete, and the anti-nodes of the standing waves are populated with particles at all the positions as required by the input 3-d signal. Thereby they form the requisite 3-d objects and surfaces in the display chamber, and may be suspended by the same standing waves for the duration required by the application.

After illumination as required is complete, the next shower may begin by resuming the vertical movement of the nodes. The particles of the next shower are ejected into the new anti-nodes as they arise. At the same time, the particles of the previous shower are withdrawn from the bottom of the display chamber, where they arrive plane by plane. By the time the profile of the next shower is complete in the chamber, all the particles of the previous shower are removed from the chamber.

A sequential illustration of the formation of 3-d patterns in the display chamber by the methods disclosed here is given in FIGS. 12/50 to 33/50 in front elevation view, and in FIGS. 34/50 to 45/50 in perspective view.

### PATENT CITATIONS AND REFERENCES

[1] Three-dimensional display technologies, Jason Geng, Adv Opt Photonics. 2013; 5(4): 456-535. doi: 10.1364/AOP.5.000456
[2] U.S. Pat. No. 6,720,961 B2 Method and apparatus for displaying an image in three dimensions
[1] U.S. Pat. No. 5,764,317 A 3-D volume visualization display;
   U.S. Pat. No. 6,806,849 B2 Multi-planar volumetric display system and method of operation using multi-planar interlacing
   3 Deep: new displays render images you can almost reach out and touch. Sullivan A. IEEE Spectrum. 2005;42(4):30-35.
   U.S. Pat. No. 6,806,849 B2 Multi-planar volumetric display system and method of operation using multi-planar interlacing
   U.S. Pat. No. 5,745,197 A Three-dimensional real-image volumetric display system and method
   US patent application 2007/0009222 A1 Volumetric three-dimensional (3D) display system using transparent flexible display panels.
[4] U.S. Pat. No. 5,684,621 Method and system for three-dimensional display of information based on two photon upconversion.
   A true three-dimensional display. Lewis J D, Verber C M, McGhee R B. IEEE Trans Electron Devices. 1971;18:724-732.
   Solid Felix: a static volume 3D-laser display. Langhans K, Guill C, Rieper E, Oltmann K, Bahr D. IS&T Reporter. 2003;18(1):1-9.
   U.S. Pat. No. 4,881,068 Three dimensional display apparatus.
   Laser produced 3D display in the air. Kimura H, Uchiyama T, Yoshikawa H. ACM SIGGRAPH; 2006. p. 20.
   U.S. Pat. No. 7,533,995 Device for forming visible image in air.
[5] 3D display using passive optical scatterers. Nayar S K, Anand V N. Computer. 2007;40(7):54-63.
   Volumetric 3D display system with static screen; Geng J. NASA Tech Briefs. Vol. 35. NASA; 2011. p. 40.
   http://www.techbriefs.com/component/content/article/9432.
[6] Wyatt D. A volumetric 3D LED display. MIT; 2005. http://web.mit.edu/6.111/www/f2005/projects/wyatt_Project_Design_Presentation.pdf.
[7] Volumetric three dimensional display. MacFarlane D. Applied Optics. 1994;33 :7453-7457.
[8] U.S. Pat. No. 6,302,542 B1 Moving screen projection technique for volumetric three-dimensional display
[9] 3D Display from ITT Labs. Aviation Week. Oct. 31, 1960; pp. 66-67.
[10] U.S. Pat. No. 6,937,348 B2 Method and apparatus for generating structural pattern illumination
[11] U.S. Pat. No. 3,097,261 Three-dimensional display
   U.S. Pat. No. 4,160,973 Three-dimensional display
[12] U.S. Pat. No. 6,441,946 B1 Swollen gyricon displays and method of making same
[13] U.S. Pat. No. 8,941,583 B2 Dual particle electrophoretic display and method of manufacturing same
[14] Fundamentals of Photonics. Saleh, Bahaa E. A.; Teich, Malvin Carl. Wiley. ISBN 978-1-118-58581-8.
[15] Fundamentals of Inkjet Printing: The Science of Inkjet and Droplets By Stephen D. Hoath
[16] U.S. Pat. No. 7,281,778 B2 High frequency droplet ejection device and method
[17] http://global.kyocera.com/news/2009/0903_kdos.html
[18] U.S. Pat. No. 4,472,722 A Ink jet printing method
[19] U.S. Pat. No. 4,395,716 A Bipolar ink jet method and apparatus
[20] Holographic acoustic elements for manipulation of levitated objects. Marzo, A. et al. Nat. Commun. 6:8661 doi: 10.1038/ncomms9661 (2015).
[21] http://www.phosphor-technology.com/products/pdp.htm
[22] http://www.sigmaaldrich.com/materials-science/material-science-products.html?TablePage=112202336
[23] Quantum Dots and Their Multimodal Applications: A Review. D. Bera, et al. Materials, 2010. 3: p. 2260-2345.
[24] Optical Properties of CdSe/ZnS Nanocrystals, Adolfas K. Gaigalas, Paul DeRose, Lili Wang, and Yu-Zhong Zhang. Journal of Research of the National Institute of Standards and Technology, 610. Volume 119 (2014). http://dx.doi org/10.6028/j res. 119.026
[25] [“Lively Standing Wave”, §2.08, Rhythmodynamics, Second edition, revised and extended, By Yuri N. Ivanov, 2007, Rhythmodynamics.—M: ISBN 978-5-98420-018-9

[26] 2D segmented large inkjet print head for high speed 3D printers; Moshe Einat, Elkana Bar-Levav; Journal of Micromechanics and Microengineering 25(5):055012 April 2015 DOI: 10.1088/0960-1317/25/5/055012

[27] http://www.digikey.com/products/en/sensors-transducers/ultrasonic-receivers-transmitters/

1. A method of assembling material three dimensional objects and surfaces, which are essentially ad hoc (‘soft’), from particles of unit size, comprising in any combination:
a) arranging an enclosed three dimensional working space which is devoid of any particles in the quiescent condition;
b) defining the said three dimensional working space to consist of ‘z’ horizontal planes, where ‘z’ is any integer number, with each said plane identified by a serial number in increasing order from bottom to top
c) defining each said plane to consist of ‘x’ lines in the horizontal x-direction, and ‘y’ lines in the horizontal y-direction, whereby a plurality of slots numbering ‘x’ times ‘y’ is defined on each plane
d) defining the said slots in the same x-y positions in all the said planes to constitute a working column, whereby a plurality of working columns numbering ‘x’ times ‘y’ is defined in the said working space
e) arranging an availability and supply of a plurality of particles to serve as elements for constructing the said three dimensional objects and surfaces, all said particles having dimensions commensurate with the thickness of a said plane and the sides of a said slot, where ‘particle’ may be a solid, liquid or vaporous material, or a combination thereof, whether self-luminescent or otherwise, or a fabricated or manufactured micro-, nano- or quantum-technology device, whether self-luminescent or otherwise;
f) determining for each said slot in each said plane of the said enclosed working space, whether it contains an object or surface, or part thereof, by processing an input signal, that is assumed to be available, and that conveys information about the said three dimensional objects and surfaces to be assembled, such as size, location, color and luminosity;
g) assigning a particle from the plurality of said particles for the purpose of populating each slot in each plane of the said working space that is determined to contain an object or surface, or part thereof;
h) determining a sequence of populating the said assigned particles in each said working column in the said working space, by mapping the said slots to be populated to specific time-instants of ejecting the said assigned particles into the working space from one side, in a pre-defined time sequence format;
i) ejecting the said assigned particles into each said working column of the said working space from one side, such that the plurality of particles assigned for one plane are ejected at one instant simultaneously, from x-y positions distributed according to the sequence determined for each working column;
j) repeating the said ejection of the plurality of particles for every plane of the said working space over successive time instants of the said pre-defined time sequence, such that the said 3-d objects and surfaces are assembled sequentially in the said working space;
k) controlling the movement of the said ejected particles through the said working space to ensure their proper positioning in the respective slots simultaneously, at the time instant at which the said sequence is complete;
l) suspending the said ejected particles in their assigned slots in the said working space for variable and controllable periods of time;
m) evacuating the said suspended particles from the said working space;
n) re-circulating the said evacuated particles to the said supply of a plurality of particles to serve as elements for constructing the said three dimensional objects and surfaces.,

2. A method of controlling the movement and positioning of particles in a pre-defined working space containing a fluid, pressurized or otherwise, comprising in any combination:
a) ejecting one or more particles into the said working space from outside, through a nozzle/nozzles, or micro-nozzle/micro-nozzles;
b) ejecting each said particle into the said working space with variable and controllable timing;
c) ejecting each said particle into the said working space with variable and controllable velocity;
d) imparting to each said particle a variable and controllable electric charge before, during or after ejecting from said nozzle(s) or micro-nozzle(s);
e) guiding each said ejected particle in its movement through the said working space to its intended position by using a partial standing acoustic wave, such that the said particle is constrained to move inside the relatively lower pressure “pea-pod” space within the said partial standing wave, by the relatively higher pressure envelope of the said partial standing wave;
f) accelerating and decelerating the said electrically charged particle(s) after ejection into the said working space, by means of a variable and controllable electric field applied in or to the said working space, from one or more directions;
g) suspending the said ejected particle(s) in the intended position(s) in the said working chamber for a given period of time, against gravity and/or other forces, by converting the said partial standing wave(s) into fully formed standing wave(s), such that the said ejected particle(s) is/are restricted inside the relatively lower pressure anti-nodes by the relatively higher pressure envelope of the said full standing wave, with or without the aid of electric field applied in or to the said working space;
h) suspending the said ejected particle(s) in the intended position(s) in the said working space for a given period of time, by establishing full standing waves at each said working column in the said working chamber, using transducer arrays at or near the top and/or bottom faces of the said working chamber, or horizontal full standing waves using transducer arrays arranged at or near one vertical side of the working chamber, so as to contain the said ejected particles in the anti-nodes of the said full standing waves and suspend them against gravity and/or electrical forces;
i) converting the said full standing wave(s) to partial standing wave(s), or abating the said standing wave(s) altogether, such that the suspension is withdrawn from the said particles;
j) removing the said particle(s) from the said working space by means of electric field(s) applied in or to the said working space, or by means of fluid evacuation, or both;
k) arranging a moving-node standing wave at each said nozzle/micro-nozzle, with the nodes of the said moving-node standing wave moving in the same direction as the said particle(s) ejected from the said nozzle/micro-nozzle;
l) ejecting each said particle into an anti-node of the said moving-node standing wave, by synchronizing the formation of the anti-node at the said nozzle/micro-nozzle with the particle ejection;
m) using the said moving-node standing wave(s) to transport the said ejected particle(s) to their intended position(s) in the said working space;
n) converting the said moving-node standing wave(s) to regular standing wave(s) (i.e. non-moving-node standing waves) in order to suspend the said particle(s) carried by it/them at the intended position(s), for a given period of time;
o) re-converting the said standing wave(s) to moving-node standing wave(s) to resume the movement of the said particle(s) and carry it/them out of the said working space, in any direction;

3. A method of displaying color and luminosity in 3-d objects and surfaces constituted of particles, comprising in any combination:
a) determining for each particle intended to constitute the said 3-d objects and surfaces, the color and luminosity required to be displayed at its location, by processing an input signal, that is assumed to be available, and that conveys information about the said three dimensional objects and surfaces to be exhibited, such as size, location, color and luminosity;
b) using particles made of a material capable of reflecting projected light with high efficiency, to constitute the said 3-d objects and surfaces;
c) coating each particle intended to constitute the said 3-d objects and surfaces with a dye mixed from materials of primary colors, and solvent/suspender/binders if any, to make it capable of exhibiting the said color and luminosity required to be displayed at its location, before deploying the said particle to constitute the said 3-d objects and surfaces;
d) forming each particle intended to constitute the said 3-d objects and surfaces, by mixing materials or dyes of the primary colors, and binders if any, to obtain a material capable of exhibiting the said color and luminosity required to be displayed at its location, before deploying the said particle to constitute the said 3-d objects and surfaces;
e) using 3-d surface mapped light projection from one or more sources arranged at or around the said 3-d objects and surfaces, above and/or below the planes of view, emitting white light or colored light from one or more directions, that in combination illuminate the said 3-d objects and surfaces on all sides and in all angles, in a manner consistent with the color and luminosity information in the said input 3d scene signal, with minimum appearance of unwanted shadows in the display chamber, where the sources may comprise high resolution SLMs (spatial light modulators), collimated image beams, arrays of discrete light or laser sources, high resolution DLPs (digital light projectors), and such like, or any combination of these, that may be stationary or moving;
f) coating each particle intended to constitute the said 3-d objects and surfaces with a phosphor dye mixed from phosphors of primary colors, and solvent/suspender/binders if any, to make it capable of exhibiting the said color and luminosity required to be displayed at its location, before deploying the said particle to constitute the said 3-d objects and surfaces;
g) coating each particle intended to constitute the said 3-d objects and surfaces with a quantum dot dye mixed from quantum dots of primary colors, and solvent/suspender/binders if any, to make it capable of exhibiting the said color and luminosity required to be displayed at its location, before deploying the said particle to constitute the said 3-d objects and surfaces;
h) forming each particle intended to constitute the said 3-d objects and surfaces, by mixing phosphors of the primary colors, and solvent/suspender/binders if any, to obtain a composite particle capable of exhibiting the said color and luminosity required to be displayed at its location, before deploying the said particle to constitute the said 3-d objects and surfaces;
i) forming each particle intended to constitute the said 3-d objects and surfaces., by mixing quantum dots of the primary colors, and solvent/suspender/binders if any, to obtain a composite particle capable of exhibiting the said color and luminosity required to be displayed at its location, before deploying the said particle to constitute the said 3-d objects and surfaces;
j) casting stimulation or excitation onto the said 3-d objects and surfaces using one or more radiation or beam emitting devices, arranged in one or more directions, in or around the 3-d objects and surfaces, above and/or below the planes of view, that in combination bring the plurality of particles constituting the said 3-d objects and surfaces to emit light in their various colors and luminosities specified in the said input 3-d scene signal, be the particles phosphor-coated, or composite phosphors, or quantum-dot-coated, or composite quantum dots;
k) using as particles intended to constitute the said 3-d objects and surfaces, smart micro- or nano-structures that can be programmed to emit light of specified color and luminosity when signaled or stimulated by any wireless means, and coding each said smart micro- or nano-structure to emit light having the said color and luminosity required to be displayed at its location, before deploying the said particle to constitute the said 3-d objects and surfaces:
l) signaling or stimulating by any wireless means the plurality of smart micro- or nano-structures within the said 3-d objects and surfaces, such that each exhibits the color and luminosity required to be displayed at its location, and the said 3-d objects and surfaces constituted of the plurality of smart micro- or nano-structures exhibit the colors and luminosities specified in the said input 3-d scene signal;
p) washing the said color coating/phosphor coating/quantum dot coating from the said particles to separate the coating material from the particles, and/or breaking down the said composite particles into the constituent primary materials, and/or erasing the said program in the said smart nano-structures and recharging their power source;
q) segregating the said washed coating materials and/or constituent primary materials by kind;
r) re-circulating the said washed particles and the said segregated coating materials and/or constituent primary materials to the drop medium tank and/or compartments associated with the drop ejection array, to be available for the next round of coating particles, forming particles and/or programming particles;

4. A light-emitter apparatus of microscopic or nanoscopic dimensions comprising in any combination:
a) phosphors or quantum dots of primary colors in equal proportions, segregated by color, and arranged to emit light outwards from the said apparatus when excited or stimulated by radiation or beams generated within the said apparatus;
b) an excitation source within the said apparatus for the said phosphors or quantum dots, capable of emitting radiations or beams, with different intensities for different colors of phosphors or quantum dots;
c) a re-chargeable energy source to power the said excitation source;
d) an energy converter for converting radiations and/or beams impinging on the said apparatus, into excitation energy for the said phosphors or quantum dots;
e) a program register that contains an erasable/re-writable binary string, which defines the overall excitation intensity and relative excitation intensities of the said phosphors or quantum dots;
f) a signal receiver or activation sensor that detects wireless signals or the presence of excitation at or about the said apparatus, and triggers the excitation of the said phosphors or quantum dots;
g) unattached body that may carry an electric charge on the surface, such that the apparatus behaves as a charged particle, and may also carry a mechanism to vary the electric charge on the body for control purposes;
h) an on-board control system to control the internal processes of the said apparatus;

5. A particle assembler apparatus comprising in any combination:
a) a three dimensional chamber that defines a working space, and has high transparency walls on the four vertical faces, and contains a fluid that may or may not be pressurized;
b) an two dimensional array of particle/drop ejectors (nozzles or micro-nozzles) arranged at the top face of the said three dimensional chamber;
c) a medium or media to serve as the said drops or particles;
d) a storage facility for the said drop medium, from where the drop medium may be drawn for use;
e) a particle control apparatus, comprising small electrodes at or near each said nozzle/micro-nozzle to impart to the said particles a variable and controllable electric charge, and electrified plates at or near the top and/or bottom faces of the said chamber, and sources of electricity for charging the said plate(s), and switches and/or amplifiers for providing variable, reversible and controllable charge to the said plates(s), and timing circuits for charging the said plate(s) for variable and controllable periods of time;
f) a particle guidance apparatus, comprising transducer arrays at or near the top and bottom faces of the said chamber, which set up partial standing acoustic waves at each said nozzle/micro-nozzle in the fluid of the said chamber, having the same frequency at the top and bottom but different amplitudes;
g) a particle suspension apparatus, comprising transducer arrays at or near the top and bottom faces of the said chamber, which set up full standing acoustic waves at each said nozzle/micro-nozzle in the fluid of the chamber;
h) a particle suspension apparatus, comprising transducer arrays at or near one vertical face of the said chamber, which set up full standing acoustic waves in the horizontal direction in the said chamber;
i) a particle evacuation apparatus comprising a blower and/or vacuum pump and associated control system;
j) a particle post-treatment apparatus comprising a particle washer, de-compositor, segregator and/or de-programmer;
k) a particle and/or color material/phosphor/quantum dot re-circulation apparatus;
l) a particle control apparatus comprising transducer arrays at the top and bottom faces of the chamber, which set up moving-node standing acoustic waves at each said nozzle/micro-nozzle in the fluid of the chamber, having the same frequency and amplitude at the top and bottom, but a continuously variable phase difference, and having amplitude compensation to overcome variations in the standing wave amplitude with phase difference;
m) a compensation circuit to provide controlled amplitude compensation to the excitation applied to the said transducers of the said moving-node standing wave, to counteract variations in standing wave amplitude that arise with phase difference, and thereby maintaining constant amplitude of the moving-node standing wave in all stages of phase variation;
n) a digital control system or software/computer system for controlling the said drop ejection assembly of the said chamber, and interface for it to the said drop ejection assembly;
o) a digital control system or software/computer system for controlling the said particle movement in the chamber, and interface for it to the said particle movement control apparatus;
p) a digital control system or software/computer system for the said moving-node standing wave system in the said chamber, and interface for it;
q) an apparatus or arrangements for containing or counteracting any harmful or unwanted emissions or discharge that may be cast by the disclosed apparatus into the surroundings in the process of its working;

6. A color three dimensional display apparatus comprising in any combination:
a) color materials and/or phosphor materials and/or quantum dot materials of primary colors;
b) a storage facility for the said color materials and/or phosphor materials and/or quantum dot materials, from where they may be drawn for use;
c) a medium or media to serve as solvent/suspender/binder;
d) a storage facility for the said solvent/suspender/binder, from where they may be drawn for use;
e) a plurality of custom color mixer apparatus, comprising color material mixers and/or phosphor mixers and/or quantum dot mixers capable of mixing the said color materials and/or phosphor materials and/or quantum dot materials in specified proportions;
f) a plurality of particle coating apparatus;
g) a plurality of particles drawn from the said drop medium, and each coated in the said particle coating apparatus with a dye of specified color mixed in the said custom color mixer along with the said solvent/suspender/binder;
h) a plurality of particle formation apparatus;
i) a plurality of particles, each formed by combining in the said particle formation apparatus a dye of specified color mixed in the said custom color mixer, and the said solvent/suspender/binder;
j) a plurality of smart light emitter micro- or nano-devices;
k) a plurality of smart micro- or nano-device programming facilities for programming the said smart light emitter micro- or nano-devices;
l) a plurality of smart light emitter micro- or nano-devices programmed to emit light of a specified color and intensity;
m) a particle assembly apparatus for assembling the said color-coated particles and/or formed color particles into three dimensional objects and surfaces;
n) a projector apparatus for projecting white light and/or 3-d surface mapped color illumination from all sides onto the said constructed 3-d objects and surfaces in the said chamber, to achieve the color and luminosity requirements of the display;
o) a radiation and/or beam emitter apparatus for emitting radiations or beams from all sides onto the said constructed 3-d objects and surfaces in the said chamber, to stimulate the phosphors/quantum dots in or on the said particles to emit light of specified colors and intensities;
p) a transmitter apparatus for transmitting wireless signals or other radiations or beams, from all sides onto the said constructed 3-d objects and surfaces in the chamber, to activate the said smart micro- or nano-structure particles to emit light of specified colors and intensities;
q) a digital control system or software/computer system for controlling the light projectors according to a 3-d input signal that conveys information about the said three dimensional objects and surfaces to be assembled, such as size, location, color and luminosity, and interface between the said digital control system or software/computer system and the said light projectors;
r) a digital control system or software/computer system for controlling the phosphor/quantum dot mixers and stimulation system according to the said 3-d input signal, and interface between the said digital control system or software/computer system and the said phosphor/quantum dot mixers and stimulation system;
s) a digital control system or software/computer system for controlling the nano-structure programming and stimulation/signaling system according to the said 3-d input signal, and interface between the said digital control system or software/computer system and the said nano-structure programming and stimulation/signaling system;

7-39. (canceled)
